(19) United States
(12) Patent Application Publication
(10) Pub. No.: US 2024/0390865 A1
(43) Pub. Date: Nov. 28, 2024

(54) THERMALLY CROSSLINKED POLYTRIAZOLE SEPARATION MEMBRANES

(71) Applicant: King Abdullah University of Science and Technology, Thuwal (SA)

(72) Inventors: Stefan CHISCA, Thuwal (SA); Srivatsa Bettahalli NARASIMHA, Thuwal (SA); Valentina Elena MUSTEATA, Thuwal (SA); Suzana Pereira NUNES, Thuwal (SA)

(21) Appl. No.: 18/266,315

(22) PCT Filed: Dec. 9, 2021
(86) PCT No.: PCT/IB2021/061533

§ 371 Date: Jun. 9, 2023

Related U.S. Application Data
(60) Provisional application No. 63/123,189, filed on Dec. 9, 2020.
(60) Provisional application No. 63/174,376, filed on Apr. 13, 2021.

(51) Int. Cl. B01D 71/62; B01D 53/22; B01D 67/00; B01D 69/02; B01D 69/12; B01D 71/82

(52) U.S. Cl. CPC B01D 71/62; B01D 53/228; B01D 67/0006; B01D 69/02; B01D 69/1251; B01D 71/82; B01D 2256/245; B01D 2257/504; B01D 2323/081; B01D 2323/082; B01D 2323/30; B01D 2325/022; B01D 2325/04; B01D 2325/20; B01D 2325/30

(57) ABSTRACT

A thermally-crosslinked membrane comprising a poly(1,2,4-triazole)-polymer that includes recurring hydroxyl-functionalized triazole units is described. The polymer has the structure of formula I: (I) wherein Ar describes an aromatic or heteroaromatic group, particularly with substituents and/or a multi-ring system, X describes a N group of the formula OR², wherein R² is a hydrogen atom or a group with 1 to up to 20 carbon atoms; Y describes a bond or a group with 1 to up to 20 carbon atoms, Z describes a group of the common formula —SO₃R¹ or —PO(OR¹)₂, wherein R¹ is a hydrogen atom or an alkali metal, and q is a whole number between 0 and 4, wherein n is a natural number ≥10, wherein at least one crosslink is present between two of the hydroxyl-functionalized Ar moieties of the polymer. Methods of making the thermally-crosslinked membranes and separation methods using the thermally-crosslinked membranes are provided.

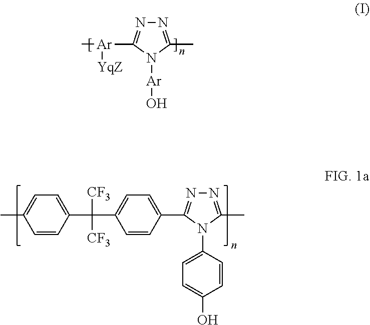

### BACKGROUND

Membrane-based separation technology is an energy-efficient and environmentally friendly process compared to the conventional separation technologies. To increase the membrane technology potential, more permeable and selective materials, which show high stability and robustness under the industrial gas and liquid separation conditions have to be developed.

In the past decades, different membrane materials have been developed for selected CO₂ removal applications, such as polymeric membranes, graphene oxide (GO), zeolites (ZIF), and metal-organic frameworks (MOFs). However, under high feed pressures, CO₂ tend to plasticize or swell the membranes, thus reducing the separation efficiency of the membranes determining the loss in selectivity. To overcome this drawback, more semi-rigid polymers, such as polymer with intrinsic microporosity and thermal rearrange polymers, were developed, or interpenetrating networks and crosslinked systems were created. For example, polyimides crosslinked with diols that form ester bonds, and decarboxylation-induced thermal crosslinking was found that decrease the plasticization effect of CO₂ and other highly sorbing components.

Additionally, the carbon molecular sieve (CMS) membranes have been reported to exhibit high separation performance, especially for H₂/CO₂ and CO₂/CH₄, but also are attractive for olefin/paraffin separation. The CMS show hierarchical structure, consisting of larger micropores (7-20 Å), which are correlated with the high gas permeability, and smaller ultramicropores (<7 Å), which give the sharp selectivity. The transport in the CMS membranes is mainly based on diffusion selectivities, while sorption selectivities are generally lower. However, van der Waals forces are the predominantly interactions between CMS membranes and the penetrant molecules. In general, the CMS membranes lose most of the functionalities during the pyrolysis compared with the starting precursor. Thus, an important aspect that has to be considered for preparing high-performance carbon membranes, besides carbonization conditions, is the selection of polymer precursors. However, the most polymeric precursors that have been used to prepare carbon membranes are cellulose and cellulose derivatives, and polyimide and polyimide derivatives. There is a need for alternatives to cellulose and polyimides derivatives to obtain higher dope nitrogen carbon materials.

### SUMMARY

Embodiments of the present disclosure include thermally-crosslinked membranes of hydroxyl-functionalized polytriazole (PTA-OH), methods of obtaining the membranes and methods of using the membranes. The PTA-OH membranes of the present disclosure are useful for membrane-based gas and liquid separations, including organic solvent nanofiltration (OSN). The tunable selectivity and permeances of thermally treated polytriazole make these membranes suitable for integration into industrial scale separation systems, including hybrid membrane configurations for energy-efficient crude oil fractionation. In addition, the stability of the crosslinked polytriazole membranes in a wide range of solvents, concentrated acids, and bases will expand applications for chemical separations using membranes.

Accordingly, in one aspect, the present disclosure describes a thermally-crosslinked membrane comprising a poly(1,2,4-triazole)-polymer that includes recurring hydroxyl-functionalized triazole units, of formula I:

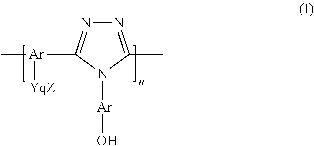

wherein Ar describes an aromatic or heteroaromatic group, particularly with substituents and/or a multi ring system, optionally with —O—, —CO—, —C(CH₃)—, —C(CF₃)—, and/or —SO₂— as compounds between the aromatic rings;
X describes a group of the formula OR², wherein R² is a hydrogen atom or a group with 1 to up to 20 carbon atoms;
Y describes a bond or a group with 1 to up to 20 carbon atoms,
Z describes a group of the common formula —SO₃R¹ or —PO(OR¹)₂, wherein R¹ is a hydrogen atom or an alkali metal, and
q is a whole number between 0 and 4,
wherein n is a natural number ≥10;
   wherein at least one crosslink is present between two of the hydroxyl-functionalized Ar moieties of the polymer.

The membrane can include recurring hydroxyl-functionalized triazole units of Formula II:

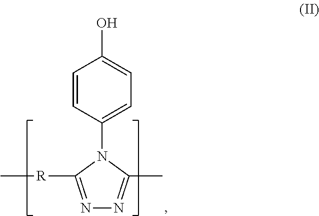

wherein R is

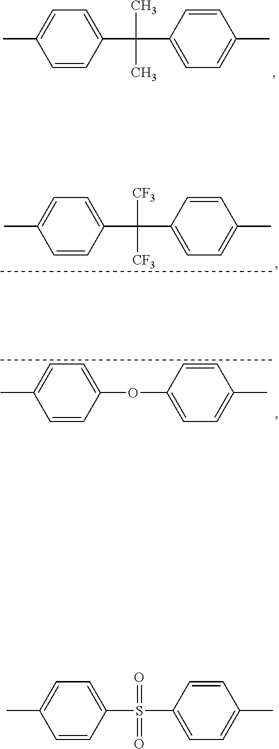

or a mixture thereof. In some cases, the membrane is a dense film, porous membrane, asymmetric membrane, or integrally-skinned asymmetric membrane. The membrane can be an asymmetric membrane having an integral selective layer, a nanometer thick selective layer, or a 10 nm thick selective layer. The membrane exhibits low plasticization and/or deformability in harsh conditions.

In another aspect, the present disclosure describes a method of preparing a thermally cross-linked membrane according to the first aspect, the method comprising thermally-treating a membrane comprising the poly(1,2,4-triazole)-polymer of formula I to a temperature sufficient to form at least one cross-link between the two hydroxyl-functionalized aromatic moieties of the polymer. The thermally-treating can include exposing the membrane to a temperature within the range of about 200-550° C., about 350 to 500° C., about 375° C. to 475° C., about 475° C., about 200° C. to 350° C., or about 300 to about 325° C. The O₂ concentration can be within a range of from about 0-100 vol %, about 0 to about 500 ppm, about 20 to about 200 ppm, or about 50-100 ppm. Thermally-treating can include exposing the membrane to the temperature for about 1 to 24 hours, about 30 mins to about 3 hours, or about 1 or 2 hours, or about 2 to 12 hours. The method can further include preparing the membrane. For example, preparing includes casting, evaporation, phase inversion, spin coating, or dip coating a polymer solution containing dissolved chains of the poly(1,2,4-triazole)-polymer of formula I. Preparing the membrane can include dissolving the poly(1,2,4-triazole)-polymer of formula I in a solvent selected from the group consisting of dimethyl sulfoxide (DMSO), N-Methyl-2-pyrrolidone (NMP), dimethylformamide (DMF), dimethylacetamide (DMA or DMAc), acetonitrile (MeCN) and mixtures thereof. Preparing the membrane can include non-solvent induced phase separation (NIPS).

In other aspect, the present disclosure describes a method of separating chemical species in a mixture, comprising contacting a thermally-crosslinked membrane according to claim 1 with a fluid feed stream comprising at least two chemical species. Separating can includes recovery and recycling of homogenous catalysts from organic solvents; oil refining; solvent and oil exchange, recovery, and purification; solute purification and enrichment; impurity removal; membrane-assisted crystallization and evaporation; carbon dioxide separation from natural gas, natural gas separation, liquid hydrocarbon separation olefin/paraffin separation, carbon dioxide separation from flue gas; organic solvent nanofiltration, ultrafiltration and microfiltration under harsh conditions, water and wastewater treatment; air separation for nitrogen enrichment, hydrogen recovery (H₂/N₂, H₂/CH₄ and H₂/CO₂), or acid gas (CO₂/H₂S) removal and hydrocarbon recovery from natural gas streams.

### BRIEF DESCRIPTION OF THE DRAWINGS

Reference is made to illustrative embodiments that are depicted in the figures, in which:

FIGS. 1a-b show a structural formula of a polytriazole functionalized with free hydroxyl groups (PTA-OH) (a) or without hydroxyl groups (b), according to one or more embodiments of the invention.

FIGS. 2a-d show (a) FTIR spectra for a pristine membrane and for membranes according to one or more embodiments of the invention treated at 400° C. and 425° C.; (b)¹³C solid state NMR for a pristine membrane and for membranes according to one or more embodiments of the invention treated at 400° C., 425° C., 450° C., and 475° C. (CP MAS); (c) ¹³C CP MAS for a pristine membrane for a membrane according to one or more embodiments of the invention treated at 425° C.; and (d) 2D ¹H-¹³C HETCOR NMR for the pristine membrane and for the membrane treated at 425° C., according to one or more embodiments of the invention.

FIGS. 3a-b show TGA curves for the polytriazole membranes (a) with OH groups and (b) without OH groups, according to one or more embodiments of the invention.

FIG. 4 shows TGA curves of samples treated at 400° C., 425° C., 450° C., 475° C. and 550° C. in a nitrogen atmosphere for 2 h, and the TGA curve of the PTA-OH with a heating rate 5° C. min-1, according to one or more embodiments of the invention.

FIG. 5 shows XRD spectra of the pristine and treated membranes, according to one or more embodiments of the invention.

FIGS. 6a-f show SEM images of (a) pristine and treated membranes according to one or more embodiments of the invention at (b) 450° C., (c) 475° C., (d) 550° C.; and (e)-(f) show TEM image for the membrane treated at 475° C.

FIGS. 7a-d show TEM images for (a) pristine and (b)-(c) thermally-treated membranes; and (d) a high-resolution TEM image of a lamella and the Fourier transform of the high-resolution image, according to one or more embodiments of the invention.

FIGS. 8a-b show (a) Raman spectra collected of prepared PTA-OH after pyrolysis at 25, 400, 425, 450 and 550° C.; and (b) in situ temperature dependent Raman spectra collected for the thin film of PTA-OH at different temperatures from 25° C. to 550° C. in dry N₂ atmosphere, according to one or more embodiments of the invention.

FIGS. 9a-f show Raman spectra collected of PTA-OH after the thermal treatment using 473 nm laser 0.35 mW at (a) 25° C., (b) 400° C., (c) 425° C., (d) 450° C., (e) 475° C., and (f) 550° C., according to one or more embodiments of the invention.

FIG. 10 shows in situ Raman spectra collected during the pyrolysis of PTA-OH at temperatures ranging from 25° C. to 550° C.

FIGS. 11a-b show (a) in situ Raman spectra collected during the pyrolysis of PTA-OH at temperatures ranging from 25° C. to 550° C.; and (b) Raman spectra collected of prepared polytriazole without OH groups after pyrolysis at 800° C.

FIGS. 12a-b show (a) a graphical view of the single and mixed gas separation performance of polytriazole membranes for CO₂/CH₄ mixture; and (b) a graphical view of the gas separation performances of polytriazole membranes according to one or more embodiments of the invention, compared with commercial and previously reported polymeric membranes.

FIG. 13 is a schematic illustration of the chance in in polytriazole membrane structure and performance following thermal treatment, according to one or more embodiments of the invention.

FIGS. 14a-b show (a) Repeat unit of hydroxyl functionalized polytriazole (PTA-OH) with hexafluoroisopropylidene and (b) its energy-minimized structure (ChemDraw).

FIGS. 15a-c show spectroscopic analysis of: (a) FTIR spectra of PTA-OH films treated at 150 and 400° C.; (b) NMR spectra of PTA-OH films (¹³C solid-state NMR (CP MAS) for samples treated from 150 to 475° C.); (c)¹³C CP MAS and 2D ¹H-¹³C HETCOR NMR treated at 150 (left) and 425° C. (right).

FIG. 16 shows XPS analysis of PTA-OH films treated from 150 to 550° C. C1s, O1s and N1s spectra.

FIG. 17 shows a survey of XPS spectra of PTA-OH films treated at various temperatures, according to one or more embodiments of the present disclosure.

FIGS. 18a-d show TGA curves for a polytriazole film with (a) and without (b) the —OH functionality; (c) TGA curves of PTA-OH film samples treated at 150, 400, 425, 450, 475, and 550° C. under nitrogen atmosphere for 2 h (ramp rate of 5° C. min⁻¹); (d) Variation of the weight loss after 2 h treatment vs. treatment temperature, with data retrieved from the TGA analysis shown in (c).

FIG. 19 shows wide-angle XRD spectra of PTA-OH films treated at 150, 400, 425, 450, 475° C. All peaks were modeled using Bragg's law and summarized in Table 2.5 (FIG. 34).

FIGS. 20a-c show (a) High-resolution TEM image for the films treated at 450° C. and the corresponding Fourier transform image; (b) Raman spectra of PTA-OH films pretreated at 150, 400, 425, 450, and 550° C. (normalized values). (c) In situ temperature-dependent Raman spectra of PTA-OH films treated in a dry N₂ atmosphere at increasing temperatures in the range 25-550° C.

FIGS. 21a-b show plots of (a) Single-gas permeability and (b) permselectivity of PTA-OH vs. treatment temperature (find data listed in Table 2.7 (FIG. 36). CO₂/CH₄ permselectivity data previously reported in the art are included in (b) for comparison.

FIGS. 22a-b show: (a) CO₂ permeability and (b) CO₂/CH₄ permeability selectivity vs. treatment temperature for PTA-OH, according to one or more embodiments of the present disclosure and other polymer films described in the published literature (6FDA-DAT/DATCA (8:2), the 6FDA-CADA1, 6FDA-CADA2, and BTDA-CADA1 series, 6FDA-DURENE/-DABA (7:3), 6FDA-DAM/DABA (3:2), 6FDA-PP and 6FDA-MPP, 6FDA-DURE-NE/MPP (3:2) and 6FDA-DABA. The case of the thermal treatment of 6FDA-DURENE, which cannot undergo crosslinking, is also reported as a reference. The PTA-OH value at 175° C. is the average of the samples treated at 150 and 200° C., respectively.

FIG. 23a-b show: (a) Trade-off plot reporting PTA-OH data at increasing thermal treatment temperatures, together with the entries of CMS film prepared from 6FDA-based polyimide precursors, which were reviewed in the art; and (b) Separation behavior variation when passing from pure to equimolar mixed gas permeation environment (the analysis was done with the best performing samples of the series of temperature treatment of 475 and 550° C.). In (a) and (b), upper-bound curves proposed in 2008, 2018, and 2019 are plotted for reference.

FIG. 24 shows Table 2.1 summarizing elemental composition of membranes of one or more embodiments of the present disclosure treated at different temperature.

FIG. 25 shows Table 2.2 providing a collection of gas permeabilities and permselectivities of polyoxadiazoles (PODs) and polytriazoles (PTAs). Chemical structures are given in FIGS. 14a and 28.

FIG. 26 shows Table 2.3 comparing CO₂/CH₄ single-gas permeability and permselectivity data of PTA-OH films, according to one or more embodiments of the present disclosure with selected relevant polymers (for tests at 35° C.), i.e., —COOH functionalized (thermally cross-linkable), hydroxyl-functionalized, and of amide chemistry, previously reported in the literature.

FIG. 27 shows Table 2.4 comparing CO₂—CH₄ single-gas diffusion and solubility coefficients of PTA-OH (except noted all tests were conducted at 35° C. and 2 atm feed pressure) with selected relevant polymers, i.e., thermally cross-linkable (e.g., —COOH functionalized), hydroxyl functionalized, and of amide-chemistry, previously reported in the literature.

FIG. 28 shows the repeat chain unit of the unfunctionalized polytriazole structure discussed in this work (PTA) and polytriazoles and polyoxadiazoles previously reported in the literature.

FIG. 29 shows XPS (C1s, N1s, O1s, and F1s) spectra of PTA-OH films treated at various temperatures, according to one or more embodiments of the present disclosure.

FIGS. 30a-d show SEM images of membranes according to one or more embodiments of the present disclosure treated at (a) 150° C. (b) 450° C., (c) 475° C., (d) 550° C.

FIGS. 31a-f show Raman spectra (0.35 mW laser at 473 nm) collected of PTA-OH films thermally treated at various temperatures: (a) 150° C. (b) 400° C., (c) 425° C., (d) 450° C., (e) 475° C., (f) 550° C.

FIGS. 32a-b show: (a) In situ Raman spectra collected during the pyrolysis of a PTA film; (b) Raman spectrum of unfunctionalized polytriazole (FIG. 28) after pyrolysis at 800° C.

FIGS. 33a-b show: (a) Normalized CO₂ permeability vs. treatment temperature. (b) Normalized CO₂/CH₄ permselectivity vs. treatment temperature. The normalization was pursued by dividing (a) permeability and (b) selectivity values by those of the untreated films (or treated below 200° C.) (referred here as pristine). Previously reported data are also plotted for comparison.

FIG. 34 shows Table 2.5 summarizing the PTA-OH film d spacing calculated via Bragg's law from the wide angle XRD spectra shown in FIG. 19.

FIG. 35 shows Table 2.6 summarizing Raman spectra assignment of a PTA-OH film treated at 150° C. characterized at 25° C.

FIG. 36 shows Table 2.7 summarizing averaged data (original entries comprised 20 datapoints) of single-gas permeation for H₂, N₂, O₂, CH₄, and CO₂. In this table, the estimation was pursued as follows: (i) for datasets made of a single entry the error was obtained from the uncertainty of the experiment, (ii) for double entries the standard deviation was estimated applying the propagation of error theory, (iii) for datasets comprising >2 samples, the error was obtained from the standard deviation of the average. Bracketed values presenting an uncertain error value. All entries are listed with 4 significant digits.

FIGS. 37a-d describes the structure and characterization of thermally crosslinking membranes according to one or more embodiments of the present disclosure. a Structure of the polytriazole and the stability and flexibility of the membranes cast from solutions in DMF and treated at 300° C. for 3 h, immersed in acids, base, and piranha solutions for 3 months. b Solid-state NMR for the pristine and thermally treated membranes at 325° C. for 2 h. The peaks indicated by letters are assigned to carbon atoms in the structures depicted in (a). c Derivative weight as a function of temperature for the polytriazole with (PTA-OH) and without OH (PTA) membranes after thermal treatments. d Creep-recovery curves for the pristine and the thermal treated membranes.

FIGS. 38a-g describe the morphology of pristine and thermally-crosslinked polytriazole membranes, according to one or more embodiments of the present disclosure. a, b, and c show cross-section SEM images of PTA-OH membranes cast from solutions in DMF and treated for 3 h at 300° C. d-g TEM cross-section images. (d) Untreated PTA-OH membrane. (e) PTA-OH membranes treated at 325° C. for 1 h (inset: higher magnification of the selective layer area). (f and g) High magnification of the selective layer obtained by treating the membranes at 325° C. for 2 h.

FIGS. 39a-e show the separation performance of polytriazole membranes with ultrathin selective layers, according to one or more embodiments of the present disclosure. (a) Permeances of different solvents as a function of the inverse of their viscosities of PTA-OH membranes cast from solution in DMF and treated at 300° C. for 3 h. (b) DMF flux as a function of pressure for the same membrane. (c) DMF permeances as a function of time for membranes cast from solutions in DMF and treated for 1 h at 325° C. (d) Longer term DMF permeance as a function of time for membranes cast from PTA-OH solutions in DMF and treated at 325° C. for 1 h. (e) MO rejection in DMF of membranes cast from PTA-OH solutions in DMF, treated at 300 or 325° C. for 1 h to 3 h. (f) Methyl orange (MO) and acid fuchsin (AF) rejection using feed solutions in DMF for membranes cast from PTA-OH solutions in NMP, treated at 300 or 325° C. for 1 h to 3 h.

FIGS. 40a-f describe crude-oil separation using polytriazole membranes. a, b, c FT-ICR MS spectra of the feed and permeant in experiments conducted at 30° C. with 1:40 (volume ratio) Arabian light crude oil to toluene mixtures, using membranes cast from PTA-OH solutions in NMP, treated at 300° C. for 1 and 3 h or at 325° C. for 1 h. d Photographs of permeant, feed, and retentate for filtrations at 65° C. e Double bond equivalent vs. carbon number for the feed and the permeate using the membrane treated at 325° C. for 1 h. f Crude oil permeance at 30° C. and 65° C. using the membrane treated at 300° C. for 3 h.

FIGS. 41a-d describe performance of ultrathin polytriazole membranes according to one or more embodiments of the present disclosure using Arabian superlight crude oil. a FT-ICR MS spectra for the Arabian superlight crude oil. b, c GC/MS chromatographs of standardized C₇-C₄₀ saturated alkanes solution in hexane and of different crude oil fractions, collected after filtration. d Photograph of the feed (left) and permeance (right) of a 90° C. filtration.

FIGS. 42a-d show characterization of polytriazole with OH groups (PTA-OH) according to one or more embodiments of the present disclosure: (a) 1H NMR, (b) 13C NMR, (c) 19F NMR, and (d) EPR for the PTA-OH and for the membranes treated at 300° C. for 1 and 3 h, and at 325° C. for 2 h.

FIG. 43 shows Table 4.1: G value and width for the polytriazole membranes with OH groups, according to one or more embodiments of the present disclosure, and for the membranes treated at 300° C. for 1 h, 300° C. for 3 h and 325° C. for 2 h, according to one or more embodiments of the present disclosure.

FIGS. 44a-d show characterization of polytriazole without OH groups (PTA). (a) 1H NMR, (b) 13C NMR, and inset is the structure of the PTA, (c) 19F NMR, and (d) EPR for the PTA polymer.

FIG. 45 depicts photographs of PTA-OH membranes according to one or more embodiments of the present disclosure treated under different conditions and immersed in DMF for more than 3 months as a solvent stability test.

FIGS. 46a-d shows (a) the thermal stability of untreated PTA membranes and PTA-OH membranes before and after thermal treatments; (b) Fourier-transform infrared spectroscopy (FTIR); (c) DSC curves for the PTA-OH; and (d) X-ray powder diffraction (XRD).

FIGS. 47a-e describe the mechanical properties of the pristine and crosslinked membranes, according to one or more embodiments of the present disclosure: (a) Young modulus, (b) Yield stress, (c) Ultimate stress, (d) Ultimate strain, and (e) Toughness.

FIGS. 48a-b are SEM images of the surface of PTA-OH membranes, according to one or more embodiments of the present disclosure. Membranes cast from solutions in (a) DMF and (b) NMP before and after thermal treatment at 300 or 325° C. during 1 or 2 h.

FIGS. 49a-c describe permeances of different solvents through membranes cast from PTA-OH solution in DMF and treated at 300° C. for 3 h, according to one or more embodiments of the present disclosure, as a function of inverse of their viscosity, multiplied by the inverse of the molecular diameters and Hansen solubility parameters: (a) total (δ), (b) polar (δ_{P}) and (c) H-bonding (δ_{H}) contributions. Units for δ, MPa^{1/2}, η, mPa s, and d, nm.

FIGS. 50a-b shows UV-Vis spectra of feed, retentate, and permeate after filtration of (a) acid fuchsin and (b) methyl orange solutions in DMF through membranes (a) cast from solutions in NMP, treated at 300° C. for 3 h and (b) cast from solutions in DMF, treated at 325° C. for one hour.

FIGS. 51a-d show DMF permeances during filtration of MO solutions through membranes cast from PTA-OH solutions in NMP or DMF treated under different conditions: (a) 300° C. for 2 h and (b) 3 h, and at 325° C. for (c) 1 h and (d) 2 h.

FIGS. 52a-b show membrane separation performance using binary mixtures and multicomponent hydrocarbons: (a) UV-Viz spectra for the hexaphenylbenzene rejection using the membrane treated at 300° C. for 3 h. (b) Rejection of multicomponent hydrocarbons in toluene of the membranes treated at 325° C. for 1 h.

FIGS. 53a-e show dilute crude-oil separation using ultrathin polytriazole membranes, according to one or more embodiments of the present disclosure. (a, b and c) FT-ICR MS spectra for the feed and permeances at 30° C. obtained using membranes cast from PTA-OH solutions in NMP, treated at 300 or 325° C. during 1 to 3 h. The feed consists of Arabian light crude oil:toluene=1:40 volume ratio. (d) TEM images for membranes cast from PTA-OH solutions in NMP, treated at 300 or 325° C. for 1 h. (e) Crude oil permeance at 30 and 65° C. using the membranes treated at 325° C. for 1 h.

FIG. 54 shows Table 4.2, which summarizes the performance of the ultrathin polytriazole membranes of the present disclosure and performances of the state-of-the-art membranes

FIG. 55a-f show the morphology of the pristine and crosslinked polytriazole membranes, according to one or more embodiments of the present disclosure. (A and B) Cross-section SEM images for the NMP-300-3 h membrane (A) and the DMF-300-3 h membrane (B). (C) TEM image for the pristine polytriazole membrane. (D) TEM image with the formation of the ultrathin polytriazole layer formation by treated the membranes at 300° C. for 1 h. The circles highlighted that the pores are not completed close at this condition. (E) TEM image of the DMF-325-1 h. At lower magnification is highlighted the formation of the “wormlike nanochannels”, while at high magnification highlights the ultrathin polytriazole layer undulatory morphology. (F) TEM image of the DMF-325-2 h showing the formation of the fusiform structure. High magnification image shows the assembly of the crosslinked network in the fusiform structure.

FIGS. 56a-i show the separation performance of ultrathin polytriazole membranes of the present disclosure. (A) Permeances of different solvents through DMF-300-3 h membrane. (B) Methyl orange (MO) and acid fuchsin (AF) rejection in DMF of the membranes treated at 300° C. for 2 h and 3 h. (C) UV-Viz spectra for the AF rejection using NMP-300-3 h membrane. (D) DMF permeances of the DMF-325-1 h membrane at different temperatures. (E) MO rejection in DMF of the membranes treated at 325° C. for 1 h and 2 h. (F) UV-Viz spectra for the MO rejection using DMF-325-1 h membrane. (G) Pure DMF permeance for 72 h. (H) Variation of DMF flux with pressure for DMF-325-1 h membrane. (I) DMF permeance during MO rejection in of the DMF-325-1 h membrane at 30° C. and 65° C. The inset images show the feed, permeate and retentate at 30° C. and 65° C. filtration.

FIGS. 57a-c characterize crude-oil separation performance using ultrathin polytriazole membranes, according to one or more embodiments of the present disclosure. (a) FT-ICR MS spectra for the feed and permeances at 30° C. and 65° C. obtained using NMP-300-3 h membrane. The feed consist of Arabian light crude oil:toluene=1:40 volume ratio. (b) Permeances of the membranes treated at 300° C. for 3 h and 325° C. for 1 h. (c) Permeances during crude oil fractionation of the membranes NMP-300-3 h and NMP-325-1 h membrane at 65° C.

FIGS. 58a-b describe results of solvent stability testing. (a) Image with the membranes immersed in DMF for more than 3 months. (b) Structure of the polytriazole without hydroxyl groups. Image with the tetrahydrofuran solution in which was tested the stability of the membrane obtained from this polymer after was heated to 325° C. for 2 h.

FIG. 59 shows solid state NMR for the pristine and for the membrane treated at 325° C. for 2 h. The presence of the new peaks compared with the pristine membrane is highlighted.

FIGS. 60a-d show the thermal stability (A and B), Fourier-transform infrared spectroscopy (FTIR) (C), and X-ray powder diffraction (XRD) (D) of a polytriazole membrane according to one or more embodiments of the present disclosure.

FIGS. 61a-c show the morphology and permeances of the pristine membrane. (a and b) SEM images of the pristine membranes obtained by using NMP and DMF. (c) Water permeances for the membranes.

FIGS. 62a-b show the surface morphology of the pristine and thermally treated membrane according to one or more embodiments of the present disclosure: (a) SEM images for the membranes obtained using DMF. (b) SEM images for the membranes obtained using NMP.

FIGS. 63a-b shows the cross-section morphology of a pristine and thermally treated membrane according to one or more embodiments of the present disclosure: (a) SEM images for the membranes obtained using DMF; (b) SEM images for the membranes obtained using DMF and thermally treated at 300° C. for 3 h.

### DETAILED DESCRIPTION

### A. Thermally Cross-Linked Hydroxyl-Functionalized Polytriazole (PTA-OH)

As used herein, the term “hydroxyl-functionalized polytriazole” refers to a poly(1,2,4-triazole)-polymer that includes recurring hydroxyl-functionalized triazole units, of formula I:

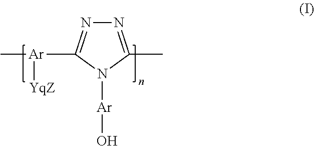

wherein Ar describes an aromatic or heteroaromatic group, particularly with substituents and/or a multi ring system, optionally with —O—, —CO—, —C(CH₃)—, —C(CF₃)—, and/or —SO₂— as compounds between the aromatic rings;
X describes a group of the formula OR², wherein R² is a hydrogen atom or a group with 1 to up to 20 carbon atoms;
Y describes a bond or a group with 1 to up to 20 carbon atoms,
Z describes a group of the common formula —SO₃R¹ or —PO(OR¹)₂, wherein R¹ is a hydrogen atom or an alkali metal, and
q is a whole number between 0 and 4, optionally 1.
wherein n is a natural number ≥10, preferably ≥100.

The properties of the thermally-treated PTA-OH membrane can be tuned by selection of the compounds between the aromatic rings. For example, thermal deterioration of these groups can enhance of permeability with the appearance of local defects.

In some cases, the polymer is a homopolymer or copolymer that includes recurring hydroxyl-functionalized triazole units of Formula II:

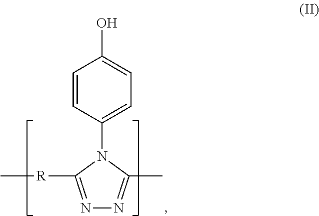

wherein R is

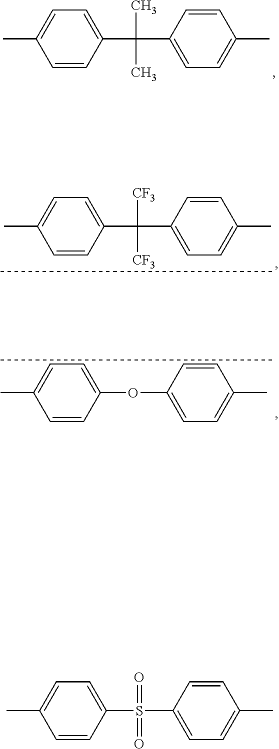

or a mixture thereof.

The polymers can be present in the form of homopolymers or copolymers, block copolymers (diblock or triblock), in the form of statistical copolymers, periodic copolymers, and/or alternating copolymers. These can be prepared according to known methods.

The cross-links form between the hydroxyl-functionalized aromatic groups. For example, a thermally crosslinked membrane comprising a polymer according to Formula II can have the following structure:

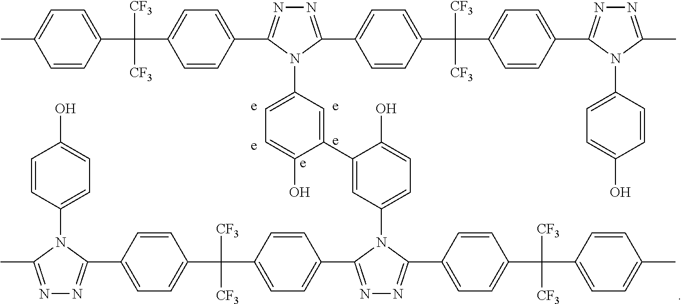

The polymer is thermally cross-linked in the form of membrane, film sheet, powder or granule, for use in the intended separation application. Membranes can be dense films, porous membranes, asymmetric membranes, or integrally-skinned. Dense films can have a thickness the range of 50 to 200 μm. The membranes can include an integral selective layer. In some cases, the selective layer has nanometer thickness, i.e., the selective layer is ultrathin (about 10 nm). The selective layer can include subnanometer channels, or other architecture (e.g., a hierarchical morphology including finger-like and/or wormlike channels). The selective layer can be a defect-free dense layer or a dense layer characterized by small defects. The thermally-treated membrane can include 2D carbon-like material (e.g., a multi-layered graphene-like 2D material). The thermally-treated membrane can be substantially amorphous.

The thermally crosslinked membranes exhibit similar stress-strain behavior, with higher values of stress and Young modulus as compared with pristine membranes. The crosslinked polytriazole membranes exhibit low plasticization or deformability in harsh conditions, such as temperature or organic solvents.

Membranes comprising thermally-treated PTA-OH can further include a filler, such as, e.g., nanoparticles made of silica, titanium oxide, and/or other inorganic materials. The filler can be porous or non-porous. Thermally cross-linked PTA-OH membranes do not require the presence of a crosslinker (i.e., the membrane can be free of exogenous crosslinkers).

### B. Methods of Preparing Thermally Cross-Linked PTA-OH Membranes

Generally, the crosslinked PTA-OH membrane is formed by crosslinking repeat units by thermally-treating a membrane or film to a desired temperature for the intended application (e.g., gas v. liquids separation). The thermal treatment results in linking of repeat units on different polymer chains or within the same chain.

The PTA-OH membrane to be crosslinked can be a pre-formed membrane prepared from a hydroxyl-functionalized polytriazole as described above. The form of the pre-formed membrane can be selected based on a desired application. The pre-formed membrane can be dense or porous, can have symmetric or asymmetric architecture, and can be supported or freestanding, in any combination. In some cases, the pre-formed membrane does not have a porous support layer or any support layer. The pre-formed membrane can be a spiral wound, hollow fiber, tubular or flat sheet membrane.

The membrane can be prepared by any suitable process for membrane fabrication of the selected PTA-OH polymer. For example, the membrane can be made by casting, evaporation, phase inversion, spin coating, dip coating, interfacial polymerization, or other membrane preparation techniques.

In some cases, the method of preparing a separation membrane includes one or more steps for fabricating the membrane. For example, the method can include casting a solution containing dissolved chains of PTA-OH and removing the solvent (e.g., by evaporation). The solution can optionally be coated on a substrate that is suitable for exposure to thermal treatment, to provide a thin-film composite, for example. A suitable substrate can be selected on the application of the membrane.

The method can include preparing the casting solution (also referred to as a dope solution) by dissolving the PTA-OH in a suitable solvent at a suitable temperature, and optionally agitating the mixture. In some cases, the polymer solution includes a solvent selected from the group consisting of dimethyl sulfoxide (DMSO), N-Methyl-2-pyrrolidone (NMP), dimethylformamide (DMF), dimethylacetamide (DMA or DMAc), acetonitrile (MeCN) and mixtures thereof. A suitable solvent can be selected based on the intended application of the membrane. For example, NMP can be used for obtaining a defect-free selective layer after thermal treatment. The polymer solution can include about 1% to about 99%, about 1% to about 50%, about 5% to about 45%, about 10% to about 40% or about 15% to about 35% by weight PTA-OH. The PTA-OH can be contacted with the solvent(s) and the mixture can be agitated and/or heated until a viscous solution is obtained. The solution can include one or more co-solvents, porogens, or other additives.

In some cases, non-solvent induced phase separation (NIPS) is performed via coagulation (or precipitation) of the PTA-OH in a suitable non-solvent for the polymer. PTA-OH membranes can be prepared from dope solutions with different concentrations (can vary from 1 to 99%). NMP (or other solvent) can be used as a solvent to prepare a dope solution of PTA-OH, and water (not limited to) as a non-solvent for the coagulation bath. The obtained membranes demonstrate good flexibility and mechanical stability, which allows their scale-up and the rolling of the flat sheet membranes into industrially applicable spiral-wound membrane modules (SWMM). Phase separation can be achieved by immersing the cast solution in a coagulation bath containing at least one non-solvent, such as water, methanol, ethanol and isopropanol. The resulting membrane can be an integrally skinned asymmetric membrane.

After polymeric film formation, the membrane can be dried (e.g., at room temperature and/or in a heated vacuum oven, or freeze-dried), stored an aqueous or aqueous organic solution; or immediately thermally-treated.

The PTA-OH membranes of the present disclosure are crosslinked by thermal treatment. Manipulation of the thermal treatment conditions, including the temperature, O₂ concentration, and exposure time allows the crosslinking of the polymer and transformation of the membrane architecture to be precisely tuned to optimize liquid or gas separation performance.

Heat treatment of PTA-OH membranes is carried out under controlled temperature and oxygen concentration. Temperature ranges from about 200-550° C., based on the specific application. For example, for gas separation, the temperature can be about 350 to 500° C., or from about 375° C. to 475° C., or about 475° C.; and for liquid separation, the temperature can be about 200° C. to 350° C., or about 300 to about 325° C. Starting material (PTA-OH polymer) can be pretreated at a temperature of below about 200° C. (e.g., about 120-200° C. for 1 hour to 24 hours). Heating rate can be below 10° C./min. The oxygen concentration can be adjusted within ranges from about 0-100 vol %, about 0 to about 500 ppm, about 20 to about 200 ppm, or about 50-100 ppm. Atmosphere can be adjusted based on the intended use. For example, for gas separation, the atmosphere can be low vacuum (e.g., below 1 mbar); or gas containing low concentration of O₂ balance in inert gas (argon, nitrogen, helium, etc.); for liquid separations the atmosphere can be air. The duration of thermal treatment is generally within the range of about 1 to 24 hours, and is adjustable based on the intended application of the membrane. For example an ultrathin membrane for liquid separations can be thermally treated for 30 mins to about 3 hours, such as about 1 or 2 hours; a dense membrane for gas separations can be thermally treated for 2 hours or more, such as about 2 to 12 hours.

### C. Methods of Using Crosslinked PTA-OH Membranes

The present disclosure includes methods of using a crosslinked PTA-OH membrane of the present disclosure for the recovery and recycling of homogenous catalysts from organic solvents; oil refining; solvent and oil exchange, recovery, and purification; solute (including pharma API) purification and enrichment; impurity removal; membrane-assisted crystallization and evaporation; and more. In some cases, the membrane is used for carbon dioxide separation from natural gas, natural gas separation, olefin/paraffin separation such as propylene/propane, carbon dioxide separation from flue gas.

The PTA-OH membranes can be used for organic solvent nanofiltration (also called as solvent-resistant nanofiltration, and organophilic nanofiltration), ultrafiltration and microfiltration under harsh conditions, water and wastewater treatment. These materials can also be used for liquid separation, including hydrocarbon separation. The crosslinked PTA-OH membranes can be used for membrane-based gas separation applications including air separation for nitrogen enrichment, hydrogen recovery (H₂/N₂, H₂/CH₄ and H₂/CO₂), and also acid gas (CO₂/H₂S) removal and hydrocarbon recovery from natural gas streams.

In one or more embodiments of the present disclosure, the crosslinked PTA-OH membrane can be used for separating one or more chemical species, e.g., separation and/or recovery of one or more chemical species present in a fluid feed stream. The fluid feed stream can include a liquid mixture such as an organic feed stream comprising hydrocarbons, solvents, dyes, catalyst, biofuels and/or active pharmaceutical agents or a gaseous mixture. The process includes contacting a crosslinked PTA-OH membrane with the fluid feed stream.

In some cases, the fluid feed stream comprises a liquid with first solute and a first solvent and method is performed to separate at least one chemical species from the fluid composition (e.g., the first solute or the first solvent from the fluid feed stream). The crosslinked PTA-OH membrane can be a membrane made by the fabrication methods described above. The separation can include ultrafiltration, nanofiltration, or microfiltration.

The separation method can be performed under an operating pressure of higher than 10 bar up to about 100 bar. Contacting can be performed at any suitable temperature (e.g., heated or cooled conditions). In some cases, the operating temperature is within the range of cooled conditions up to 100° C.

The fluid feed stream can be an aqueous liquid, an organic liquid, or a combination thereof. The fluid feed stream can be a complex mixture of hydrocarbons. The first solute can be selected from the group consisting of hydrocarbons (e.g., C₇-C₄₀ saturated alkanes), sugars, salts, amino acids, flavors, genotoxins, colorants, dyes, pigments, catalysts, peptides, antibiotics, proteins, enzymes, and active pharmaceutical ingredients. Separating can include dead end filtration or cross-flow filtration, and can further include concentrating the first solute, recovering the first solvent or a combination thereof. In some cases, fluid feed stream includes at least two solvents and the method includes solvent exchange. Additionally or alternatively, fluid feed stream includes at least two solutes, and the method further includes purifying the first solute of the at least two solutes. Fluid feed stream can include a first solvent selected from the group consisting of alcohols, methanol, ethanol, isopropanol, butanol, acetone, alkanes, pentane, n-hexane, n-heptane, cyclohexane, alkyl acetates, butyl acetate, ethyl acetate, ethers, methyl ethyl ketone, diethyl ether dichloroethane, chloroform, trichloroethane, methyl isobutyl ketone, formaldehyde, ethylene glycol, propylene oxide, methylene chloride, nitrobenzene, tetrahydrofuran, toluene, diethyl ether, acetonitrile, carbon tetrachloride, xylene, dioxane, dimethyl sulfoxide, dimethylformamide, N-methyl pyrrolidone, and dimethylacetamide. The separation method can include a subsequent step involving contacting at least one additional membrane with the filtered feed stream comprising the separated first solute or the separated first solvent.

In some cases, the fluid is in a gas phase. A gas phase can include both true gases, comprising materials that are gaseous under normal conditions, and also materials that are normally liquid or solid which are maintained in a vapor state for processing. The fluid composition may be a gas mixture, e.g., a mixture of hydrogen, helium, oxygen, nitrogen, carbon monoxide, carbon dioxide, hydrogen sulfide, ammonia, water vapor, a nitrogen oxide, a sulfur oxide, a C₁-C₈ hydrocarbon, natural gas, an organic vapor, a fluorocarbon, or a refrigerant gas, for example. The fluid stream can include air, flue gas, digester gas, fermentation gas, sewage gas, natural gas, coal gas, synthesis gas, or combinations thereof. The fluid stream can include hydrogen, carbon dioxide, carbon monoxide, sulfur dioxide, helium, hydrogen sulfide, nitrogen, oxygen, argon, hydrogen sulfide, nitronic oxide, nitrous oxide, nitric oxide, ammonia, a hydrocarbon of one to five carbon atoms, hydrogen chloride, or a combination thereof. For example, the fluid stream can include air, air and methane, air and carbon dioxide, air and carbon monoxide, methane and carbon dioxide, methane and H₂S, methane and carbon monoxide, hydrogen and carbon monoxide, or combination thereof. The crosslinked PTA-OH membrane may be configured in combination with one or more additional gas separation membranes, including but not limited to, in parallel, series, recycle, and cascade arrangements.

The method can include separating at least one chemical species from the gas phase fluid composition. For example, a portion of the fluid composition comprising at least one chemical species passes through the membrane and exits the membrane as a permeate, whereas another portion of the fluid composition does not pass through the membrane. Separating can provide preferential depletion or concentration of one or more of the chemical species in the fluid composition and provide a product having a different proportion of the one or more desired components to the at least one other component than that proportion in the mixture. The permeate can be oxygen-enriched or a nitrogen-enriched, for example, relative to the fluid composition. The portion of the fluid composition that does not permeate the membrane can be nitrogen-enriched, oxygen-enriched, carbon dioxide-enriched, nitrogen-depleted, oxygen-depleted, or carbon dioxide-depleted relative to the fluid composition. For example, if the fluid composition included hydrogen gas, the permeate can be hydrogen-enriched, and the portion that does not permeate can be hydrogen depleted relative to the fluid composition. In some cases, the method can be used to generate hydrogen sulfide-depleted methane, hydrogen-enriched syngas, or a combination thereof. The method can be used to an enriched nitrogen stream for inerting of flammable fluids, perishable foodstuffs, and metal treating processes; an enriched oxygen stream for medical or industrial uses, fermentation processes, enhanced combustion processes; or an enriched hydrogen stream for hydrocracking or hydrogenating aromatics, for example.

The operating temperature and pressure of the separating may vary depending upon the temperature of the fluid composition (e.g., fluid stream) and upon ambient temperature conditions, and/or the membrane flux. In some cases, the effective operating temperature of the membranes of the present invention can be within the range of about −50° to about 350° C.

### EXAMPLES

The Examples below describe the fabrication and characterization of separation membranes by thermally treating membranes of polytriazole with free OH groups.

### Example 1

Polyoxadiazoles (POD) and polytriazole (PTA) have not been much investigated for gas separation compared to polyimides. However, the mixed-gas performance of functionalized polyazoles with HF groups, as previously synthesized by our group has been investigated. This report showed a performance from the hydroxyl functionalized version with a CO₂/CH₄ permselectivity as high as 48.4 (and permeability of 86.5 Barrer) when permeating a mixture of CO₂—CH₄—H₂S and trace C2H₆ (for a total pressure of 6.8 atm).

Thermal treatment of hydroxyl-functionalized polytriazole films was investigated as a method for crosslinking and transformation to CMS. The gas separation performance of thermally treated polytriazole-based films is reported for the first time. The separation characteristics are clearly advantageous compared to freshly synthesized polytriazole.

### Membrane Preparation

N,N′-dimethylformamide (DMF) (99.8%), and all other reagents were procured from Aldrich. The polytriazole was synthesized by polycondensation reaction. All the chemicals were used as received.

The dense membranes were obtained by casting the polytriazole solution 14-16% in N, N′-dimethylformamide onto glass plates, and drying at 60° C. over 12 hours under vacuum to evaporate the solvent. The membranes were subsequently heated at 100, 125, and 150° C., consecutively (for 3 hours at each temperature) and at 175° C. for 5 hours resulted in the final polytriazole membrane. After the membranes were piled-out from the glass by immersing in water, there were heated initial to 120° C. to evaporate the adsorbed water, and then there were heated at 175° C. for 2 days to remove all the residual solvent. The final thickness of the polytriazole films was in the range of 70 to 100 μm. The obtained films were thermally treated in a Lindberg/Blue M™ 1200° C. Split-Hinge Tube Furnaces under nitrogen atmosphere at 150° C. for 30 min before continuing the treatment to the specific temperatures (375° C., 400° C., 425° C., 450° C., 475° C. and 550° C.). The furnace heating rate was set at 5° C. per minute, and the isothermal at the final temperature was 2 hours.

### Fourier Transform Infrared (FTIR) Spectroscopy

The chemical changes during thermal treated were evaluated by Fourier Transform Infrared (FTIR) spectroscopy using a Nicolet 6700 FT-IR System. The FTIR spectra were recorded by performing 16 scans with a spectral resolution of 4 cm⁻¹.

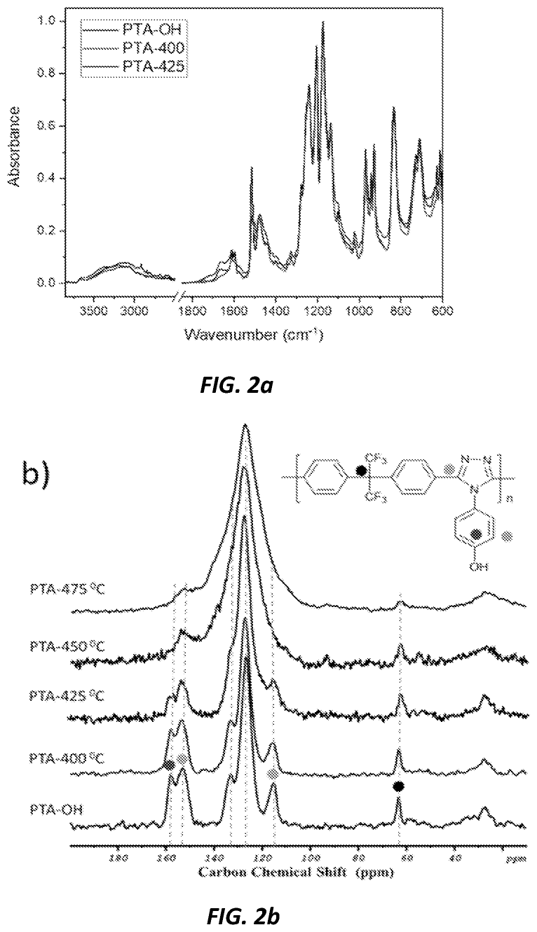

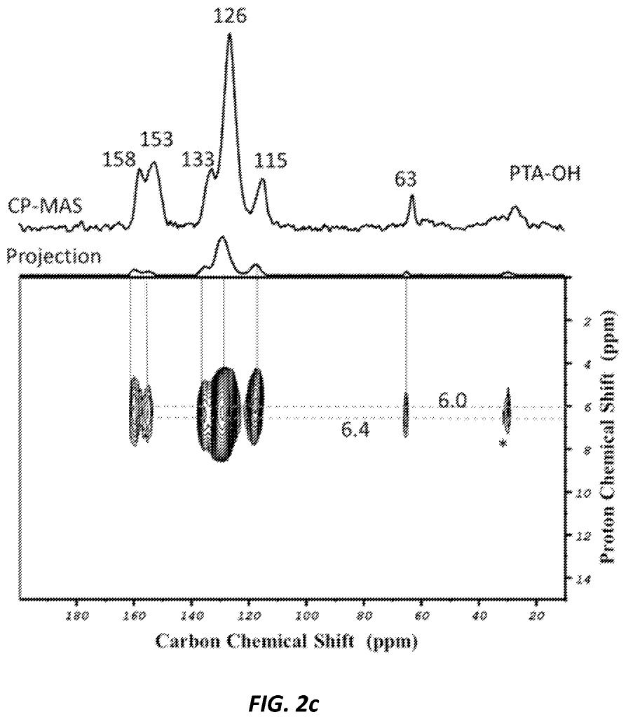

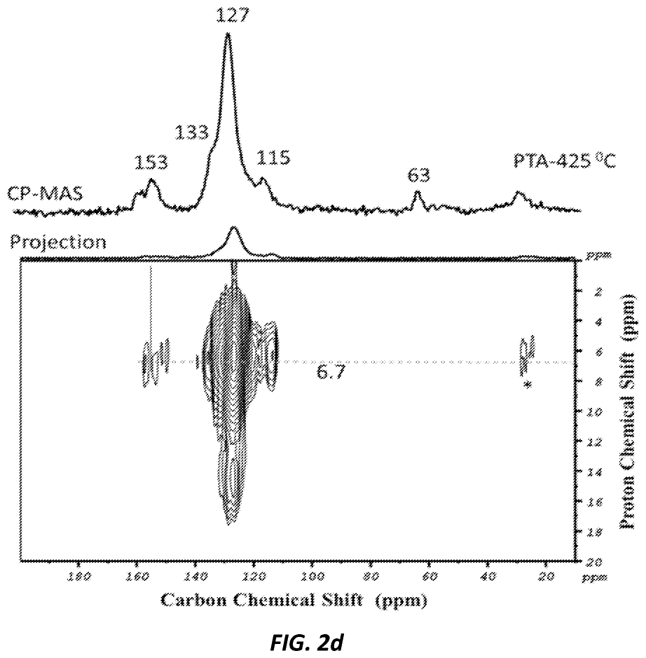

The gas separation performance for thermal treated polytriazole membranes with free hydroxyl groups (PTA-OH) was investigated. The changes in the chemical structure that occurred during the thermal treatment were initial investigated by FTIR. FIG. 2a shows the FTIR spectra for the pristine and for the membranes treated at 400° C. and 425° C. It is observed that the intensity of the characteristic peaks for OH groups (3000-3500 cm⁻¹), for the triazole rings (1518 cm⁻¹) and for the C═C linkages of aromatic rings (1496 cm⁻¹) are decreasing or there are slightly shifting by increasing the treated temperature. Simultaneously, the characteristic peaks for the hexafluoroisopropylidene unit (1260-1210 cm⁻¹) did not change by heating to 425° C., indicating that until this temperature, there is no critical scission of the polymer chains.

### Solid-State Nuclear Magnetic Resonance Spectroscopy

Solid-State Nuclear Magnetic Resonance Spectroscopy was used to investigate the chemistry of the membrane that occurred during thermal treatment. One-dimensional ¹H MAS and ¹³C CP/MAS solid-state NMR spectra were recorded on Bruker AVANCE III spectrometers operating at 400 and/or 600 MHz resonance frequencies for ¹H. The chemical shifts were calibrated using the external references TMS and adamantane. The 2D ¹H-¹³C heteronuclear correlation (HETCOR) solid-state NMR spectroscopy experiments were conducted on a Bruker AVANCE III spectrometer using a 2.5 mm MAS probe. Detailed information regarding the solid-state NMR experiments was reported previously.

Solid-state nuclear magnetic resonance was employed to gain more insights into the chemical structure that appeared during the thermal treated of polytriazole membranes (SS-NMR). FIG. 2b shows the ¹³C cross-polarization magic-angle spinning (CP MAS) for pristine PTA-OH membranes and the membranes treated at 400° C., 425° C., 450° C. and 475° C., respectively. FIG. 2c shows 2D ¹H-¹³C heteronuclear correlation spectroscopy (HETCOR) NMR for pristine and the membrane treated at 425° C. The peak characteristic to carbon in the C—O bond at 6=158 ppm decreased by increasing the temperature to 400° C. and 425° C., while at 450° C. the characteristic signal for this bond disappear entirely. Simultaneously, the signals at 6=115 and 133 ppm characteristics for carbons from the benzene ring attached to the triazole rings merge with the aromatic carbons signals in the backbone, resulting a broader aromatic chemical shift with increasing the thermal treatment (FIG. 2b). The 2D ¹H-¹³C HETCOR NMR (FIG. 2c-d) of the membranes treated at 425° C. shows the partial disappearance of the proton at 6.0 ppm attribute to OH groups, but also the merging of the aromatic protons associated to the aromatic carbons at 115 and 133 ppm. These results suggest that treating the PTA-OH membranes to 425° C. will result in a crosslinked network, which likely evolves through condensation of the two pendant benzene rings; since the intensity of the C—O decreased, the hydroxyl proton disappear, the aromaticity and the rigidity of the system increased, and no significant changes in the chemical shifts associated to triazole rings were observed. However, by increasing the thermal treatment temperature to 450° C. and 475° C., the signal at 6=153 ppm characteristic to the triazole rings significantly decreased, which can be correlated with the cleavage of the triazole rings at these temperatures.

### Thermogravimetric Analyses (TGA)

The membranes' thermal stability was investigated by thermogravimetric analyses (TGA) on a TGA Q50 by TA instruments in a nitrogen atmosphere from 25 to 800° C., with a heating rate of between 1 to 10° C. min⁻¹. TGA was also used for preparing the samples treated at 400° C., 425° C., 450° C., 475° C. and 550° C. in a nitrogen atmosphere for 2 h.

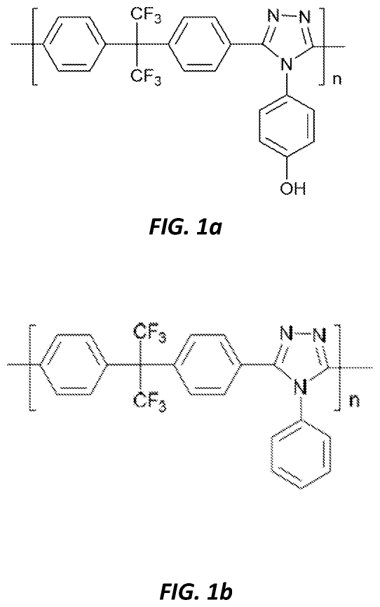

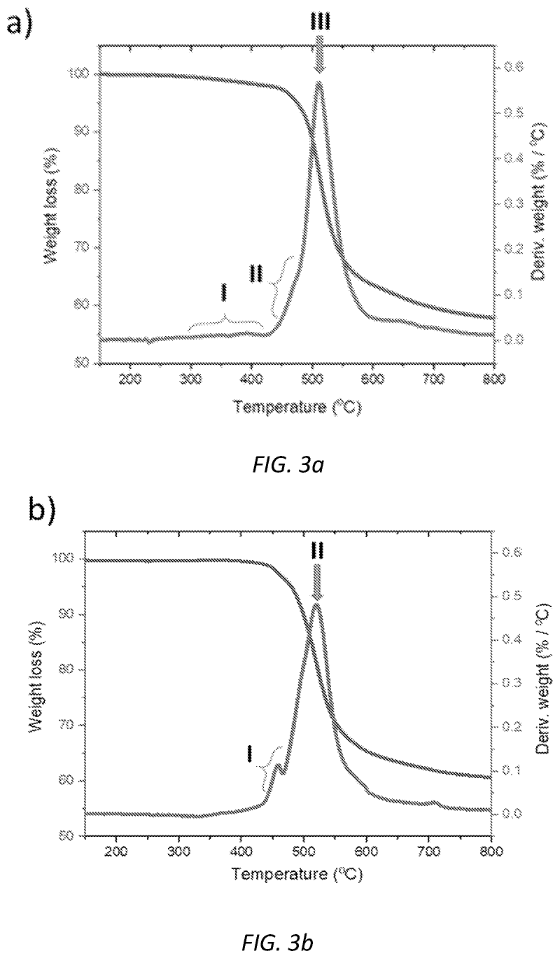

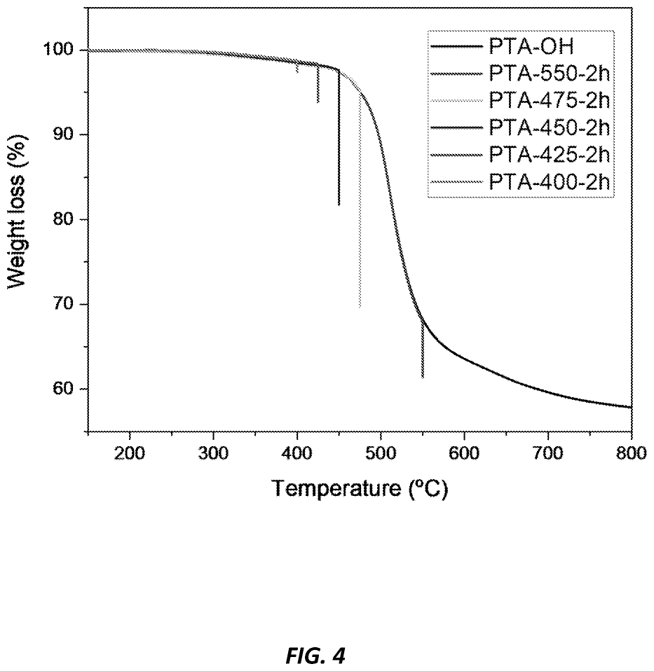

FIG. 3a shows the TGA curves for polytriazole with OH groups (FIG. 1a) and FIG. 3a shows the TGA curves for polytriazole without OH (FIG. 1b). The polymers were synthesized using methods known in the art. The TGA curve for the polytriazole with OH shows a slight decrease in weight, initiating around 300° C. For the polymer without OH, significant weight loss was not observed until the temperature was raised to 450° C. These results indicate that at temperatures below 450° C., a thermally crosslinked intermediate structure is formed, which involves OH groups. Therefore, the TGA data agrees with the FTIR and NMR findings. Above 450° C., a weight loss was observed for both polymers, which correlates to cleavage of the triazole rings. The thermally treated conditions of the membranes in the furnace were simulated using TGA. FIG. 4 shows the TGA curves for the sample treated at 400° C., 425° C., 450° C., 475° C. and 550° C. in a nitrogen atmosphere for 2 hours. The weight loss for samples treated at 400° C. and 425° C. is 2.7% and 6.2%, respectively, while increasing the temperature to while 450° C. resulted in a weight loss of 18.2%. In the samples treated to 475° C. and 550° C., the weight loss is 30.2% and 38.5%, indicating that the main loss is due to the degradation of the polymer backbone and the formation of the pre-carbonized materials.

### X-Ray Scattering Patterns

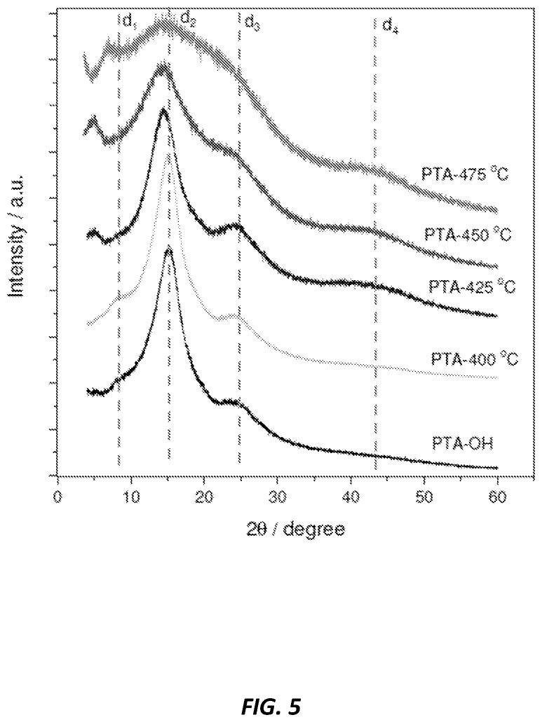

FIG. 5 shows the wide-angle X-ray scattering patterns of the pristine and treated membranes. All the membranes present characteristic amorphous patterns. The main peak at around 2θ˜15° is shifted towards lower scattering angles, and becomes broader with increasing temperature. Two more peaks are seen at around 2θ˜8° and 2θ˜24° for the pristine and for the treated membranes, which are also shifted to lower 2θ values, indicating more open structure with increasing temperature than compared with the pristine polytriazole membranes. For the membranes treated at 425° C., 450° C., and 475° C., an additional broad scattering pattern is observed at around 2θ˜42°, which correlates with the (110) plane of C—C spacing on graphitic planes. Although the thermal treatment temperature is significantly lower than the previously reported carbon materials from polytriazole precursor membranes, XRD results indicate that the bimodal ultramicroporous-microporous structure characteristic for this type of material is initiated at temperature of 450° C.

Crystallinity and d-Spacing

The crystallinity and the d-spacing of the membranes were investigated using a Bruker D8 Advance diffractometer with Cu-Kα radiation source at 40 kV and 40 mV. The diffraction data were measured in the range of 5°-60°. The d-spacing was calculated using Bragg's law.

The average interchain distances (d-spacing) values were calculated by Bragg's law (d=λ/2(sin θ)) and are reported in Table 1.1. The averaged d-spacing calculated for the main peak (d₂) for the pristine membrane is 5.86 Å. In contrast, the thermally treated membranes show a continuously increased d-spacing (d₂) to 5.90 Å (400° C.), 6.10 Å (425° C.), and 6.21 Å (450° C.) by increasing the temperature to 450° C., followed by a slightly decreased to 6.00 Å at 475° C. This behavior indicates that the average interchain distance increases due to the crosslinking network and the chemical changes until 450° C. At higher temperatures, pre-carbonize materials formation leads to a slightly more tight-packing, with ultramicropore-micropore structure.

TABLE 1.1
Calculated d-spacing for Membrane XRD spectra

| Membrane | d₁ (Å) | d₂ (Å) | d₃ (Å) | d₄ (Å) |
|---|---|---|---|---|
| PTA-OH | 10.63 | 5.85 | 3.65 | — |
| PTA-400° C. | 10.78 | 5.83 | 3.64 | — |
| PTA-425° C. | 17.57 | 6.15 | 3.67 | 2.13 |
| PTA-450° C. | 17.69 | 6.13 | 3.66 | 2.14 |
| PTA-475° C. | 12.99 | 5.94 | 3.87 | 2.11 |

### Scanning Electron Microscopy (SEM) and Transmission Electron Microscopy (TEM)

The morphologies of pristine and thermally-treated membranes were studied by scanning electron microscopy (SEM) on a Nova Nano microscope, using a 3-5 kV voltage and a working distance of 3-5 mm. The bulk morphology was also studied by transmission electron microscopy (TEM). Initially, the films were embedded in Epoxy resin at 60° C., and then ultrathin sections (70 nm) were cut using an ultramicrotome (Leica EM UC6). The films were imaged without staining with a Titan CT (FEI company) microscope operating at 300 kV.

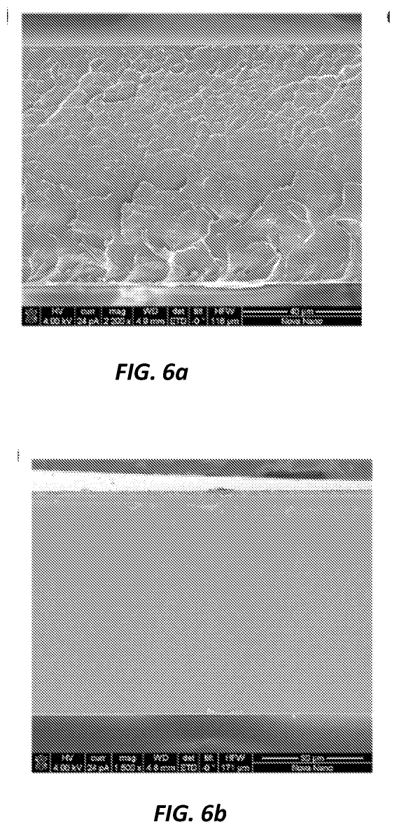

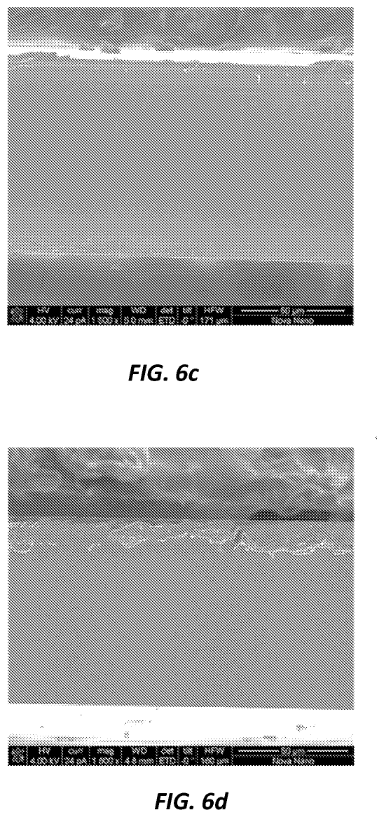

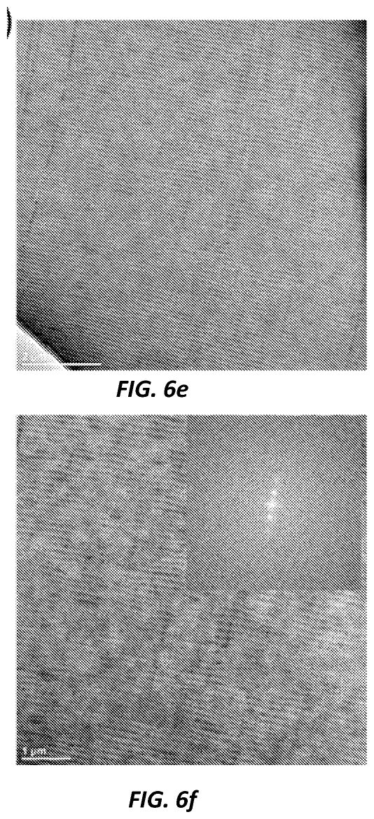

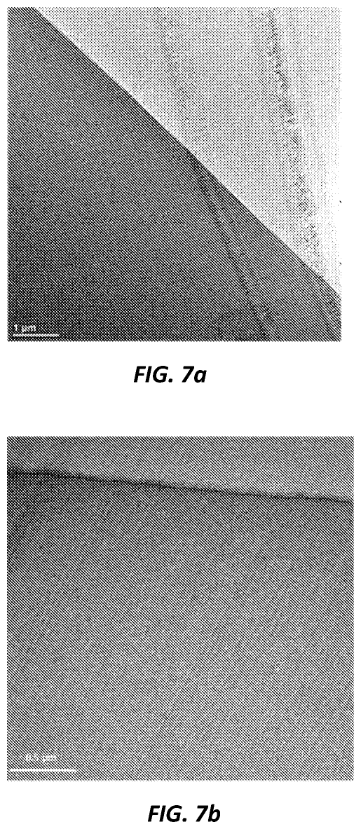

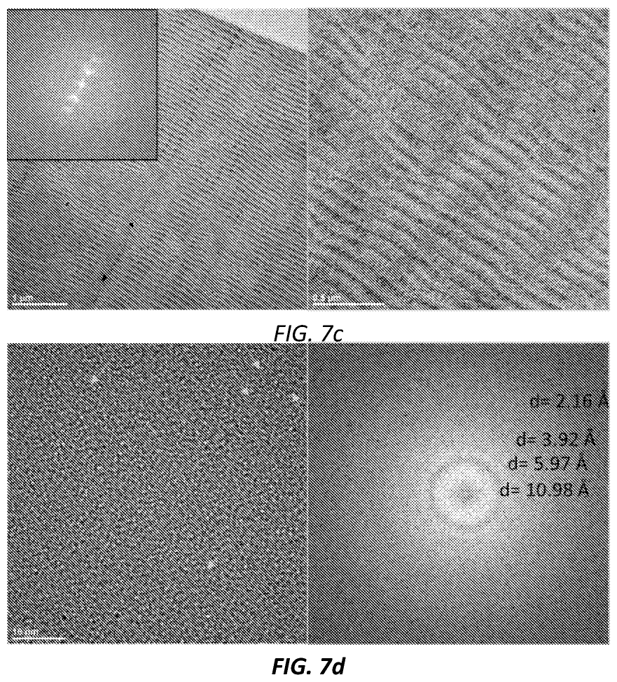

The pristine membrane exhibits a bulk wrinkled morphology (FIG. 6a)., while the thermally-treated membranes show a smoother and a tighter structure (FIG. 6b). Moreover, by increasing the thermal treatment, the membranes become thinner (FIGS. 6c-d). TEM reveals a surprising lamellar morphology in the entire bulk of the membranes treated above 450° C. (FIG. 7c and FIGS. 6e-f). Fourier transforms (FIG. 7c inset image and FIG. 6f inset image) indicate that the distances between the lamella are 120 nm for the membrane treated at 450° C. and 130 nm for the membrane treated at 475° C. A layered structure has also been reported for the thermally treated 1,2,4-triazole derivatives. The membranes treated below 450° C. show a dense structure similar to the untreated membrane (FIGS. 7a-b). Although the XRD data exhibit that the membranes are mostly amorphous, a high-resolution TEM image of the lamella structure shows the presence of some ‘ultrasmall’ crystallites made of 2-6 stacked layers in the structure (FIG. 7c). The crystallites formation probably can be correlated with the favorable orientation of a certain number of polytriazole chains relative to each other. Fourier transform of the high-resolution TEM image (FIG. 7d) is in good agreement with the d-spacing calculated from the XRD spectra, indicating an amorphous structure.

### Confocal Raman Measurements

Confocal Raman measurements were performed on a modular Witec Apyron microscopy system (Ulm, Germany). The samples were placed on microscopy coverslips and for the temperature dependant Raman sample measurements were obtained by using Linkam temperature controllable stage THMS600 from 25° C. to 550° C. at N₂ dried atmosphere purging. A diode pumped solid-state laser with excitation wavelength of 473 nm with 0.35 mW output power was used to collect the Raman signal to avoid samples overheating and heat related chemical transformations. Ultra-High-Throughput-Spectrometer UHTS600 containing gratings with 300 and 1800 grooves/mm were utilized to monitor the Raman signal resolution. A 50×NA 0.8 in air objective (Zeiss Epiplan-Neofluar DIC) was used for imaging and recording of spectra of PTA-OH. Due to the strong fluorescence background of PTA-OH of pyrolyzed samples, all Raman spectra collected were treated for the background correction using “Shape” correction function Project Five software (Ulm, Germany). The theoretical Raman bands of PTA-OH were calculated using Spartan 18 software using B3LYP method with 6-31G* basis set, geometry optimized, and the data were used to assign the Raman spectra of PTA-OH (Table 2).

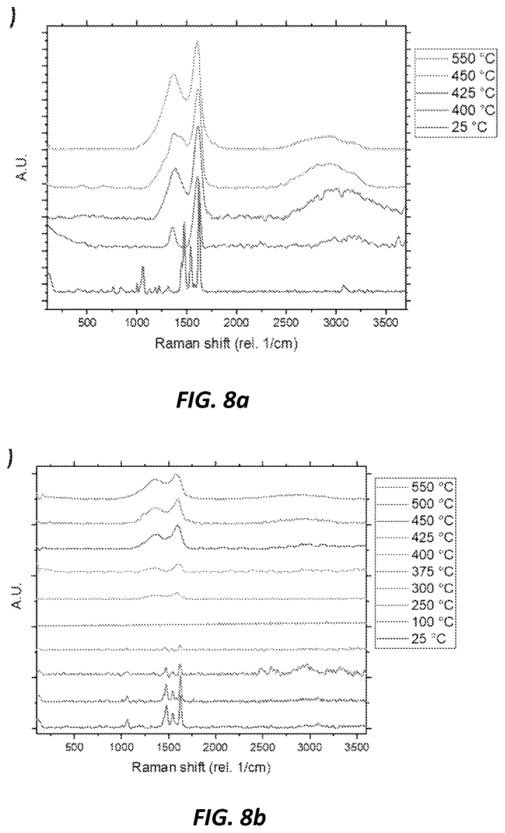

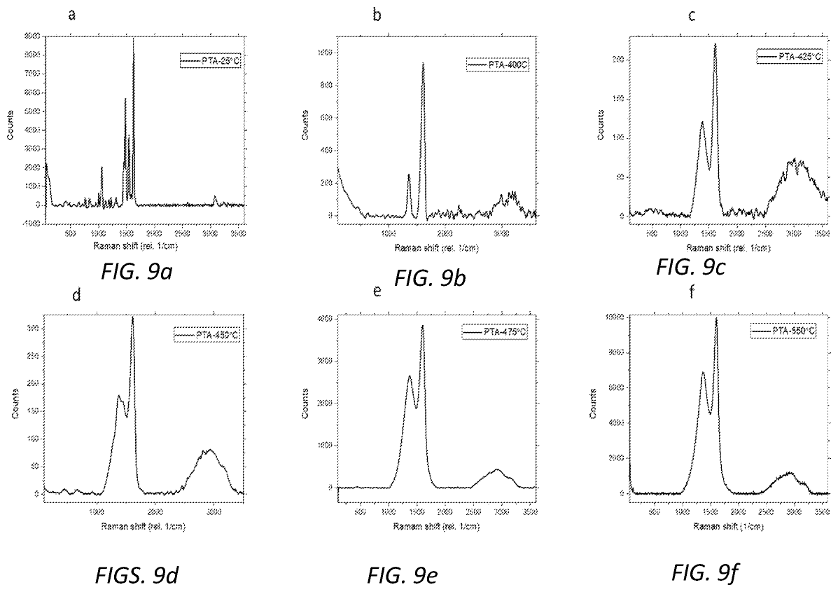

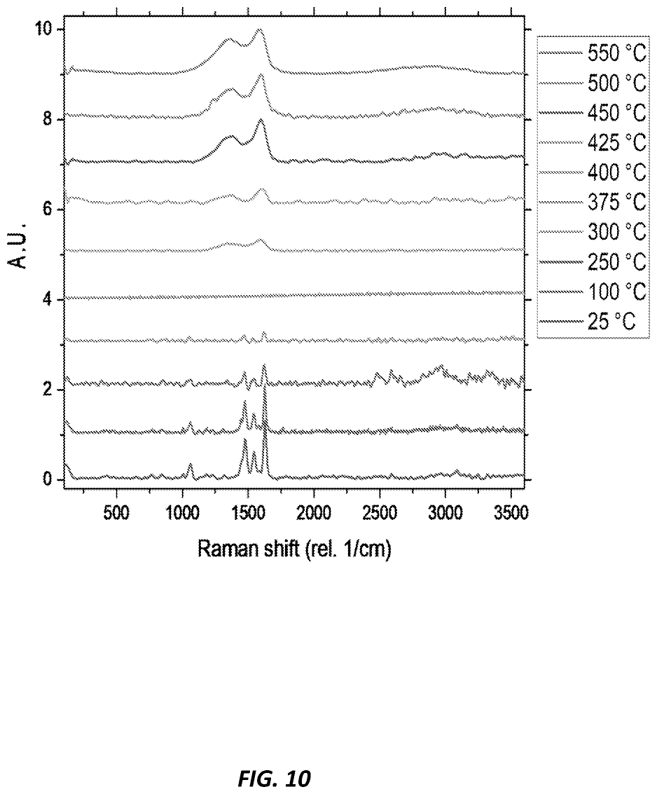

The Raman spectra collected for PTA-OH at 25° C. to 300° C. demonstrate in the range of 1620 cm⁻¹ strong in plane deformation vibrations of sp² aromatic protons from C6-rings of PTA-OH (FIGS. 8s and 9a-f, and Table 2). Weak symmetrical stretching vibration of O—H and C—H groups are observed at 25° C. sample of PTA-OH 3235 cm⁻¹ and 3070 cm⁻¹ respectively, signals of which are not observed in the pyrolyzed samples above the temperature 300° C. (FIG. 8b). In situ Raman measurement of PTA-OH sample at 375° C. shows a strong rise in fluorescence background in which no Raman signal was detected, this effect might be explained by undergoing chemical bond rearrangements of PTA-OH. Further heating above 400° C. shows a weakly defined formation of a multi-layered graphene-like compound with the strong corresponding phonon G-band at 1580 cm⁻¹ and the defect D-band at 1350 cm⁻¹. Intensity of these bands become more prominent with heating above 400° C., which evidences formation of a multi-layered graphene-like 2D material (FIG. 8b). The multi-layer character can be also seen by the presence of a 2D broad band in the region of 2800-3100 cm⁻¹. Interestingly that defects concentration in which is in the ratio of I_{D}/I_{G} very low at 400° C. (FIG. 8a) and equal I_{D}/I_{G} (400° C.)=0.25. This reveals a low-concentration of defects at the moment of formation of graphene-like compound PTA-OH at 400° C. However, heating to 450° C. shows that concentration of the defects is increasing more than triple I_{D}/I_{G} (450° C.)=0.81. This could be explained by further PTA-OH transformation which occurs in the range of 400-450° C. (FIGS. 8a, 9a-f and 10). After heating above 450° C., the spectrum reveals that the concentration of the defects does not change with increasing temperature and PTA-OH samples collected at 475° C. and 550° C. give similar I_{D}/I_{G} ratio that is equal 0.48. Thus, further heating above 475° C. does not change the material formed up to 550° C., based on the ratio of I_{D}/I_{G} estimated the average crystallinity size (Lₐ) (eq. 1) of the sp^{z} domains that are formed after the heating. Results show that Lₐ at 400° C. is 47.5 nm consistent with a large magnitude crystallinity of 2D material, while with further heating at 425-450° C. the Lₐ values drop to ˜15.4 nm. Thermal treatment above that temperature leads to a slight increase to 25.2 nm.

$${L}_{a} ( nm ) = ( 2.4 \cdot {10}^{- 10} ) {λ}^{4} {( \frac{{I}_{D}}{{I}_{G}} )}^{- 1} \qquad ( eq . 1 )$$

where Lₐ is average crystallinity, λ is laser wavelength in nm, and I_{D} and I_{G}—are integrated intensities of the D- and G-band, respectively.

TABLE 1.2
Raman spectra assignment of PTA-OH 25° C.

| Band position | Band position | | |
|---|---|---|---|
| cal. (1/cm) | observed (1/cm) | Assign | Characteristic |
| 3638 | 3235 | νₛ(O—H) | weak |
| 3132 | 3079 | νₛ(C—H)sp² | broad weak |
| 1625 | 1625 | νₛ(C═C) + δ(C—H) | strong |
| 1532 | 1535 | νₛ(C═N) + δ(O—H) | medium |
| 1468 | 1468 | νₐₛ(C═N) + δ(C—H) in plane | strong |
| 1310 | 1310 | C—CF₃ | weak |
| 1211 | 1230 | ν(C—F) stretching | weak |
| 1167 | 1194 | ν(C—F) stretching | weak |
| 1081 | 1090 | ν(C—C) | weak |
| 1036 | 1059 | ν(C—N) + ν(C—C) | medium |
| 990 | 995 | δ(C₆ ring) in plane | weak |
| 936 | 949 | δ(triazol) + δ(C—H) out of | weak |
| | | plane | |
| 822 | 839 | π(C₆ ring) out of plane | weak |
| 728 | 760 | ρ_{w}(C—F) | weak |
| 627 | 635 | δ(C—C—C) | weak |

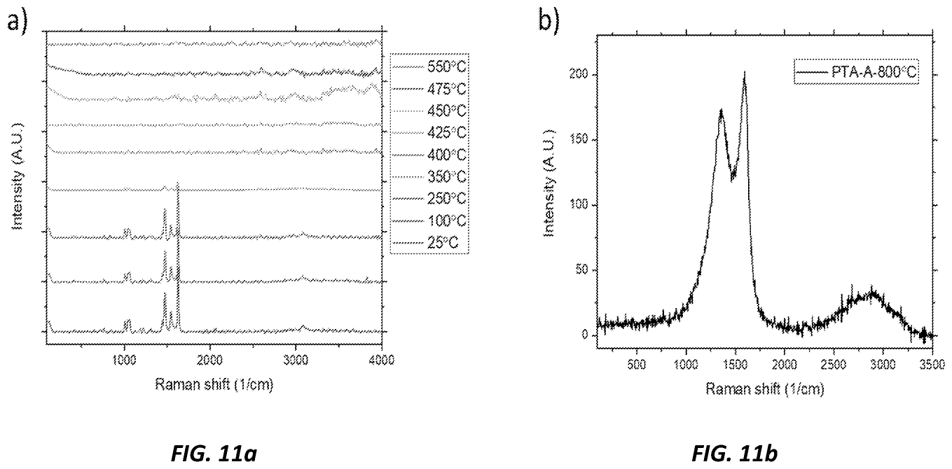

In comparison to PTA-OH, the polytriazole without OH groups shows no transformations to 2D carbon-like material with temperature heating in range of 400-550° C. (FIG. 11a). This indicates that the formation of the crosslinked network due to the presence of the OH groups induce the formation of the porous carbon-like membrane. However, pyrolysis over 800° C. shows the formation of 2D carbon-like materials similar to those formed at 400-550° C. for PTA-OH (FIG. 11b).

### Ideal Gas Selectivity

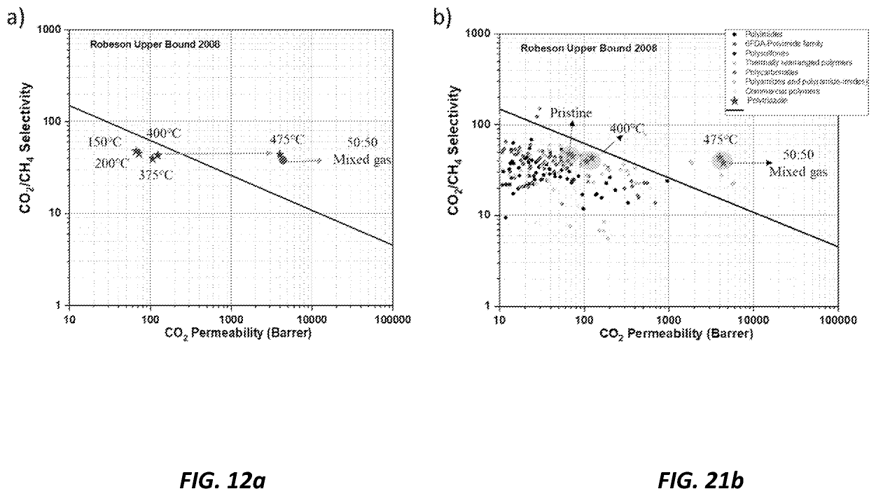

The ideal gas selectivity of the membranes for a CO₂/CH₄ mixture was investigated for pristine membranes aged for 24 hours at 150° C. and 200° C. (FIG. 12a stars) and membranes treated at 375° C., 400° C. and 475° C. (FIG. 12a the stars with dots). The pristine membranes showed a CO₂ permeability in the range of 66-73 barrer, with a CO₂/CH₄ selectivity in the range of 48-45, respectively. Gas permeability increased with increasing the thermal treatment temperature to 375° C. and 400° C., the interval where the thermally-crosslinked intermediate structure is formed. The gas performances are in good agreement with the XRD data, whereby increasing the temperature was associated with increasing d-spacing. This behavior was also observed for the thermally crosslinked polyimide (previous work). The CO₂/CH₄ selectivity is similar to the selectivity of the pristine membranes. The best performance was obtained for membranes treated at 475° C., demonstrated by an increase of the CO₂ permeability >50× compared with the pristine membranes, and >30× compared with the membranes treated below 400° C. At the same time, for membranes treated at 475° C., the CO₂/CH₄ selectivity is as high as pristine membranes. Moreover, the performances achieved for single gases are also maintained for mixed gases (FIG. 12a circle). Thus, the performances of thermally-treated polytriazole membranes are higher than the majority of the commercial membranes, polyimide, and 6FDA-family membranes, which are amongst the most commonly used classes of polymer for gas separation, and also higher or comparable with thermally rearranged polymers (FIG. 12b). Furthermore, most of the reported polymeric materials do not maintain the single gas performances also for mixed gases, as was exhibited by the thermally-treated polytriazole membranes. These results show that polytriazole is an excellent starting material for the preparation of membranes for gas separations, especially for CO₂/CH₄ mixtures.

### CONCLUSION

The TGA data indicated that below 450° C., a thermally crosslinked intermediate structure is formed, while above 450° C., the weight losses correlated with cleavage of the triazole rings and rearrangement of the polymer's chains. The membranes are mostly amorphous with a bimodal ultramicropore-micropore structure. Additionally, the formation of ultrasmall crystallites made of 2-6 stacked layers was observed in membranes treated above 450° C. Single and mixed gas selectivity of the CO₂/CH₄ mixture was also investigated. By increasing the thermal treatment temperature, the gas permeability increased, and the while maintaining selectivity. The best performance was obtained for the membranes treated at 475° C. The CO₂ permeability increased more than 50 times compared with the pristine membranes. The thermally treated membrane selectivity for 50:50 mixed CO₂/CH₄ was similar to the selectivity for single gases.

Here, we show the influence of thermal treatment of polytriazole with free OH groups membranes on gas separation applications. The chemical changes that appeared during the thermal treatment were investigated by FTIR, solid-state NMR, TGA, SEM, HR-TEM. We investigated the single and the mixed gas selectivity of the CO₂/CH₄ mixture.

Gas separation membranes were prepared by thermally treated polytriazole with OH groups at different temperatures (375° C., 400° C., 425° C., 450° C., 475° C., and 550° C.). The advantages of using this polymer are that it can easily be synthesized in large amounts, show good mechanical properties, excellent thermal and thermal-oxidative stability, and the free OH groups can be easily modified or crosslinked. The membranes were tested for gas separations, such as the CO₂/CH₄, showing higher performances than the most commercial and previously reported polymeric membranes for single and mixed gas. These membranes can be used for raw natural gas purification because CO₂ is the most common impurity with no value and causes corrosions in further separation processes.

### Example 2

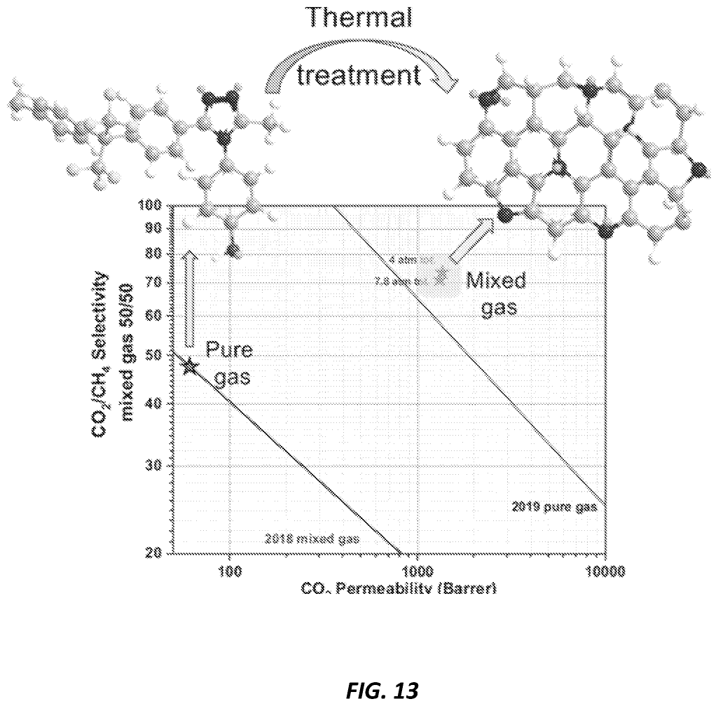

The thermal treatment of hydroxyl-functionalized polytriazole films (FIG. 13) as a successful method for their crosslinking and different steps of transformation up to carbon molecular sieves (CMS). Polytriazole is a highly aromatic polymer with elevated glass transition temperature. These characteristics favor the dimension and chemical stability until the conditions for a thermal crosslinking is reached. The gas separation performance of thermally treated polytriazole-based films is reported for the first time. The separation characteristics are clearly advantageous compared to freshly synthesized polytriazole.

The results presented demonstrate that hydroxyl-functionalized polytriazole can be used as a precursor for the preparation of highly crosslinked membranes and carbon molecular sieves (CMS) for gas separation. (FIG. 13) The effect of the treatment temperature on the chemical structure and gas separation properties is detailed. In particular, the results show a progressing crosslinking structure was formed when polytriazole films were treated in the range of 300-400° C. Above 425° C., CMSs with multi-layered nitrogen-graphene-like structures were obtained. The CO₂ permeability increased by increasing the temperature, while the CO₂/CH₄ selectivity was maintained. Permeability increases up to 37-fold compared to the untreated polymer film were obtained, aligned with a CO₂/CH₄ selectivity of 75. The single-gas CO₂ permeability vs. CO₂/CH₄ selectivity data obtained for films treated at 475 and 550° C. are among the highest reported in the literature. Moreover, the mixed gas performance of these membranes is far above previously reported CO₂/CH₄ data plotted as mixed-gas trade-off curves, demonstrating the potential of polytriazole materials for these applications.

There is an urgent need to find alternatives to traditional fossil fuels for more sustainable and cleaner energy conversion. Natural gas is a low-carbon-footprint energy source compared to liquid fossil fuels, explaining its considerable demand during the last years for electricity generation, heating, and vehicle fueling. Natural gas typically contains 50%-90% of methane together with (mainly) water vapor, N₂, CO₂, and H₂S (acid gases), and valuable hydrocarbons (C3+, which are generally recovered). It needs pre-treatments to reach the standards required by industrial applications. For instance, high concentrations of CO₂ and H₂S subject the pipeline system to corrosion (hydrogen sulfide is also an extremely toxic gas). Concentration specifications of CO₂ and H₂S are below 2% for the former and 4 ppm for the latter. Membrane systems can adjust natural gas concentrations to meet pipe-line specifications and, unlike traditional separation technologies (e.g., amine-based adsorption unit operations), are more energy-efficient and environmentally friendly.

Nowadays, more permeable and selective materials are being developed to increase the membrane technology potential for this application; membrane materials also need to be stable and robust under industrial gas separation conditions. In the past decades, different membrane materials have been developed for CO₂ removal applications (comprising natural gas sweetening), based on polymeric materials, carbon molecular sieve, graphene oxide (GO), zeolites and metal-organic frameworks (MOFs).

One of the main problems that many membrane materials (especially polymers) face when exposed to acid gases is plasticization. That is, at high feed pressures, CO₂ (or H₂S) tends to swell the selective diffusion sites inducing a critical selectivity loss. Recent reports showed how the rigidification of the repeat monomeric unit is ineffective in preventing plasticization—as demonstrated, for instance, by testing polymers of intrinsic microporosity (PIMs) for pure and multicomponent permeation and sorption. Instead, polymers with less free volume and stronger interchain interactions resist better to acid-gas-induced plasticization. Furthermore, swelling-induced plasticization also might depend on the film thickness. The effect on asymmetric membranes with thin selective layers might be more pronounced or at least more fastly visible than on isotropic thick films.

Thermal crosslinking of functionalized polyimides has been employed before as a strategy to minimize plasticization. One of the early cases of thermal crosslinking through which a linear polymer transforms into a network matrix via degradation of —COOH functionalities—referred to as ester or decarboxylation crosslinking. A certain resistance to CO₂-induced plasticization was noted after crosslinking. The decarboxylation crosslinking of various polyimides (including 6FDA- and BTDA-based polyimides) in the range 350-425° C. of thermal treatment under nitrogen gas has also been studied. Another route for thermal crosslinking is based on debromination. A polyimide is first brominated (via in-solution addition of n-bromosuccinimide) and then de-brominated at high temperatures, forming a crosslinked network. Precursors bearing lactone rings were also reported to undergo thermal crosslinking with excellent results in terms of plasticization resistance and improved permeability. However, when thermal treatments are conducted above T_{g} on porous membranes, there is a large risk of having a partial collapse of the porous structure, critically reducing the membrane permeance. Therefore, thermally crosslinked hollow-fibers employing polymers of T_{g} higher than the respective thermal crosslinking temperature, has been used to achieve strong plasticization resistance.

Thermal treatment has been applied for gas separation. Crosslinking is in this case not necessarily the goal. A rather extreme case application of thermal treatment occurs at a temperature range higher than 500° C., leading to carbonization and formation of Carbon Molecular Sieve (CMS) membranes. They have been explored by different groups with reported high selectivity for gas separation, including olefin/paraffin. A challenge for the preparation of CMS membranes is due to the fact that the precursors might utterly rearrange and lose most of the functionalities during pyrolysis. The polymer precursor selection—besides the carbonization conditions—is therefore fundamental for preparing high-performance carbon membranes. To date, carbon membranes were mainly prepared from polyimide precursors and cellulose derivatives, but polybenzimidazole as an additive or main starting material has been also reported.

### Experimental

### Materials

N,N′-dimethylformamide (DMF) (99.8%), and all other reagents were obtained from Sigma Aldrich. All the chemicals were used as received. Bare and hydroxyl functionalized polytriazole polymers were synthesized by polycondensation reaction, using methods known in the art.

### Membrane Preparation

The dense membranes were obtained by casting 14-16 wt % polytriazole N, N′-dimethylformamide solutions onto glass plates and drying at 60° C. for over 12 h under vacuum for solvent evaporation. The films were subsequently heated at 100, 125, and 150° C., consecutively (for 3 h at each temperature). Then, the temperature was raised to 175° C. and held for 5 h to eliminate any residual solvent (which was confirmed via TGA analysis). The films were piled-out from the glass by immersing in water and heated, initially to 120° C. to evaporate the adsorbed water, and then to 150° C. for 24 h. The final thickness of the polytriazole films was in the range of 70-100 μm. The obtained films were thermally treated in tubular furnaces under nitrogen atmosphere at 150° C. for 30 min before continuing the treatment to the specific temperatures (375, 400, 425, 450, 475, and 550° C.). The furnace heating rate was set at 5° C. per minute. Samples were held at the maximal set point temperature for 2-9 h. The samples were named ac-cording to the treated temperature. One sample was treated at 200° C. under vacuum for 24 h to investigate the gas separation performance.

### Characterization

The chemical changes during thermal treatment were evaluated by Fourier Transform Infrared (FTIR) spectroscopy using a Nicolet 6700 FT-IR System. The FTIR spectra were recorded by performing 16 scans with a spectral resolution of 4 cm¹.

Solid-State Nuclear Magnetic Resonance Spectroscopy was used to investigate the chemistry of the membrane that occurred during thermal treatment. One-dimensional 1H MAS and 13C CP/MAS solid-state NMR spectra were recorded on Bruker AVANCE III spectrometers operating at 400 and/or 600 MHz resonance frequencies for 1H. The chemical shifts were calibrated using the external references TMS and adamantane. The 2D 1H-13C heteronuclear correlation (HETCOR) solid-state NMR spectroscopy experiments were conducted on a Bruker AVANCE III spectrometer using a 2.5 mm MAS probe. Detailed information regarding the solid-state NMR experiments is available in the literature.

X-ray photoelectron spectroscopy (XPS) analysis was performed on a Kratos Axis Supra DLD spectrometer equipped with a monochromatic Al Kα X-ray source (hv=1486.6 eV) operating at 150 W, under high vacuum (˜10⁻⁹ mbar), using an aperture slot of 300 μm×700 μm. Survey spectra were collected using a pass energy of 160 eV and a step size of 1 eV. High resolution XPS spectra were carried out using a pass energy of 20 eV and a step size of 0.1 eV.

The films thermal stability was investigated by thermogravimetric analyses (TGA) on a TGA Q50 by TA instruments in a nitrogen atmosphere from 25 to 800° C., with a heating rate of between 1 and 10° C. min⁻¹. TGA was also used for preparing the samples treated at 400, 425, 450, 475, and 550° C. in a nitrogen atmosphere for 2 h.

The crystallinity and the d-spacing of the membranes were investigated using a Bruker D8 Advance diffractometer with Cu-Kα radiation source at 40 kV and 40 mV. The diffraction data were measured in the range of 5°-60°. The d-spacing was calculated using Bragg's law.

The bulk morphology of the films was investigated by transmission electron microscopy (TEM). The films were embedded in epoxy resin at 60° C., and then ultrathin sections (70 nm) were cut using an ultramicrotome (Leica EM UC6). The films were imaged without staining on a Titan CT (FEI company) microscope operating at 300 kV.

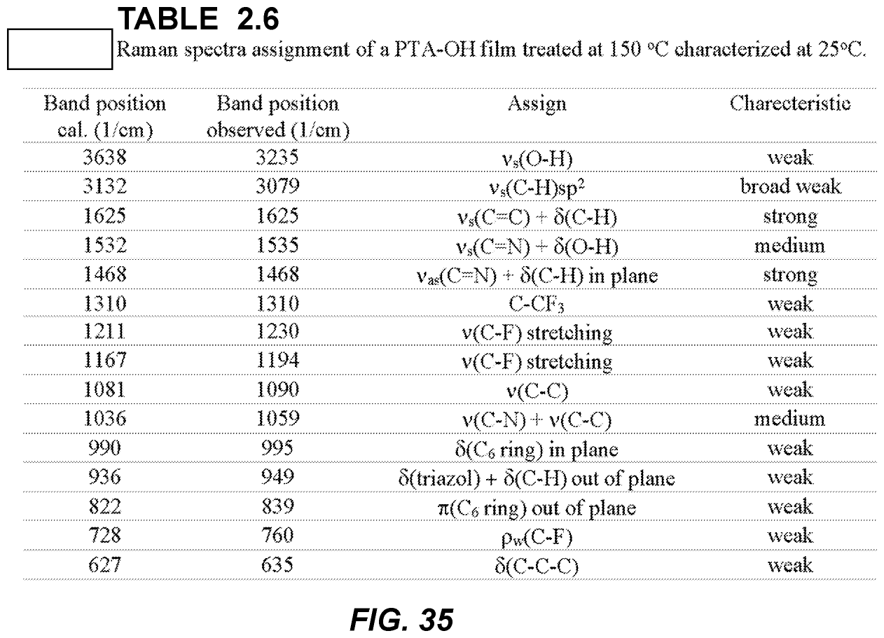

Confocal Raman measurements were performed on a modular Witec Apyron microscopy system, Ulm, Germany. The samples were placed on microscopy coverslips, and for the in-situ temperature increase, Raman sample measurements were obtained by using Linkam temperature controllable stage THMS600 from 25° C. to 550° C. at N₂ dried atmosphere purging. The isotherm before collecting the Raman spectrum at each temperature lasted 10 min. A diode-pumped solid-state laser with an excitation wavelength of 473 nm with 0.35 mW output power was used to collect the Raman signal to avoid samples over-heating and heat-related chemical transformations. The Ultra-High-Throughput-Spectrometer UHTS600 containing gratings with 300 and 1800 grooves/mm was utilized to monitor the Raman signal resolution. 50×NA 0.8 in air objective (Zeiss Epiplan-Neofluar DIC) was used for imaging and recording of spectra of PTA-OH. Due to the strong fluorescence background of PTA-OH of pyrolyzed samples, all collected Raman spectra were treated for the background correction using a “Shape” correction function Project Five software Ulm, Germany. The theoretical Raman bands of PTA-OH were calculated via the Spartan 18 software using the B3LYP method with the 6-31G* basis set (geometry optimized). All Raman spectra assignments are summarized in FIG. 35 (Table 2.6).

### Gas Transport Measurement

The pure gas permeation properties of dense film/membrane were measured using an in-house built permeation system based on the constant-volume variable-pressure method. All measurements were carried out at a constant temperature at 35° C. and 2 bar pressure (unless specified otherwise). Detailed design and description of the set-up and permeation cell have been illustrated elsewhere. Pure gas permeabilities were measured using PTA films (treated at different temperatures), which were degassed for at least 24 h at 35° C., and mounted in a permeation cell. Films thicknesses were measured using a depth gauge (Mitutoyo, ABS 547-301). The film with a diameter of approximately 1-2 cm² was mounted By masking with adhesive tape (3 M® aluminum tape) and sealed with epoxy glue (GC Potting Epoxy 19-824). Permeabilities at a set pressure were calculated using the equation below:

$${P}_{i} = {D}_{i} \$ {S}_{i} = \frac{{V}_{ds} \$ l}{{P}_{up} \$ A \$ R \$ T} \$ \frac{dp}{dt} {\$10}^{10} \qquad ( 1 )$$

where Pi is the permeability of the gas i through the membrane (Barrer) (1 Barrer=10⁻¹⁰ cm³ (STP) cm cm⁻² sec⁻¹ cmHg⁻¹), Di is the diffusion coefficient, Si is the solubility coefficient, V_{ds} is the downstream volume (˜500 cm³), dp/dt is the change in permeate side pressure with respect to time (cmHg/s), 1 is the membrane thickness (cm), Pᵤₚ is the upstream pressure (cmHg), A is the effective exposed area of the film (cm²), R is the gas constant (0.278 cm³ cmHg cm⁻³ (STP) K⁻¹), and T is the operating temperature (K) ($ represents multiplication operator (⋅)).

The ideal gas selectivity (a) of gas i and gas j was calculated using:

$${α}_{i / j} = \frac{{P}_{i}}{{P}_{j}} \qquad ( 2 )$$

where, Pᵢ and Pⱼ are the permeability of gas i and gas j, respectively.

The mixed gas permeation was measured using a modified single gas permeation set-up connected to a gas-chromatograph (Agilent 3000A micro-GC) similar to that reported in previous reports. The feed was binary gas CO₂/CH₄: 50/50 mixtures with a total feed pressure of 4 bar (unless otherwise specified) at 35° C. The stage cut (ratio of permeate to feed flow) of <1% was maintained to avoid concentration polarization on the feed side near to the film surface, while keeping a constant driving force throughout the duration of the measurement. The steady-state downstream gas (>10 times lag duration) was collected for analyzing the permeate gas composition using GC. The mixed gas permeability was evaluated using the equation below:

$${P}_{i} = \frac{{y}_{i} \$ {V}_{ds} \$ l}{{x}_{i} \$ {P}_{up} \$ A \$ R \$ T} \$ \frac{dp}{dt} {\$10}^{10} \qquad ( 3 )$$

where yᵢ represents the mole fraction of gas mixture in the permeate, xᵢ represents the mole fraction of gas mixture in the feed ($ represents multiplication operator (⋅)).

The mixed-gas selectivity of CO₂/CH₄ was determined by:

$${α}_{i / j} = \frac{{y}_{i} / {y}_{j}}{{x}_{i} / {x}_{j}} \qquad ( 4 )$$

### Results and Discussion

### 1. Crosslinking, Cleavage of the Polymer Chain, and Formation of CMS Matrix

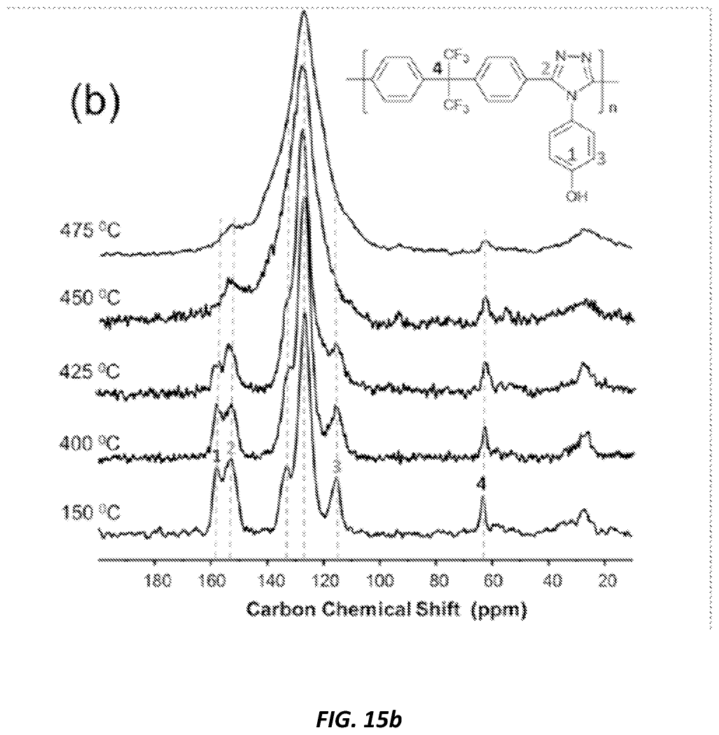

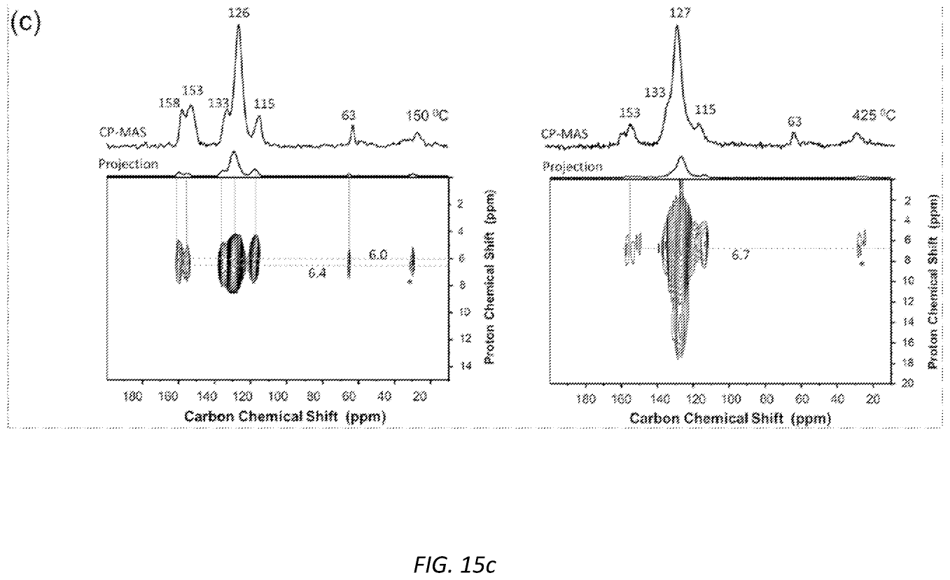

The changes in the chemical structure that occurred during the thermal treatment were initially investigated by FTIR. The FTIR spectra show that the intensity of the characteristic peaks for OH groups (3000-3500 cm⁻¹) of the triazole rings (1518 cm⁻¹) and the C═C linkages of aromatic rings (1496 cm⁻¹) are decreasing or are slightly shifting by increasing the treatment temperature (FIG. 15a). Simultaneously, the characteristic peaks for the hexafluoroisopropylidene unit (1260-1210 m⁻¹) did not change by heating to 400° C., indicating that until this temperature, there is no critical scission of the polymer chains.

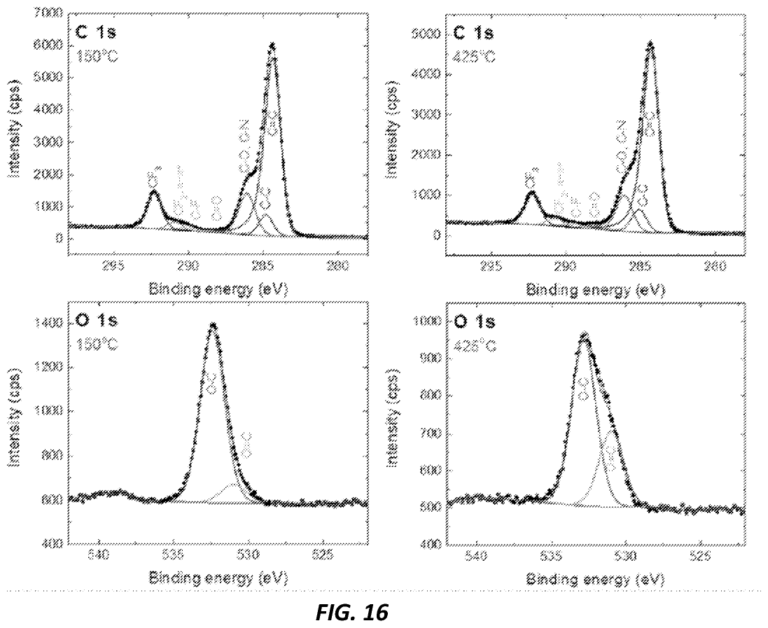

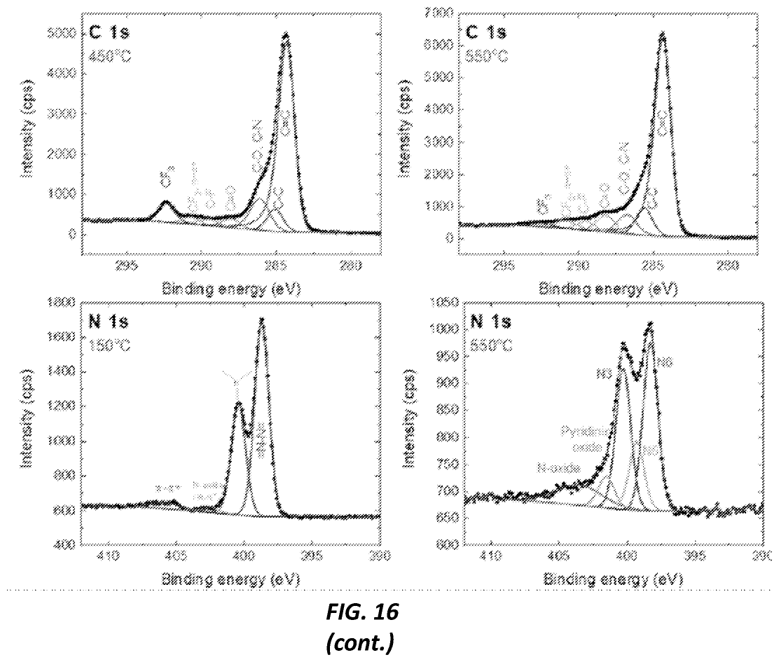

Solid-state nuclear magnetic resonance (SS-NMR) and X-ray photo-electron spectroscopy (XPS) were then used to better understand the steps of chemical transformation taking place during the thermal treatment of polytriazole films (FIGS. 15b and 16). FIG. 15b shows the 13C cross-polarization magic-angle spinning (CP MAS) for the PTA-OH film treated at 150° C. and further at 400, 425, 450, and 475° C., respectively. The peak characteristic of the carbon bonded to the —OH group (C—OH) at 6=158 ppm decreased by increasing the temperature to 400° C. and 425° C. Simultaneously, the signals at 6=115 and 133 ppm characteristics of carbons of the phenyl group attached to the triazole ring merged with the aromatic carbons signals in the backbone, resulting in a broader aromatic chemical shift when increasing the thermal treatment (FIG. 15b). The 2D 1H-13C HETCOR NMR (FIG. 15c) of the membranes treated at 425° C. shows the partial disappearance of the proton at 6.0 ppm attribute to —OH groups. Additionally, the merging of the aromatic protons associated with the aromatic carbons can also be seen at 115 and 133 ppm. Thus, the NMR data suggest that the thermal treatment of PTA-OH until 425° C. induces a strong interaction with the neighbor pendant phenyl rings of the polymer chains, leading to a crosslinked structure.

Increasing the thermal treatment temperature to 450 and 475° C., the signals at δ=63 ppm and δ=153 ppm characteristic of hexafluoroisopropylidene unit and triazole rings, respectively, started to decrease. This could be correlated with the beginning of the cleavage of the polytriazole chain and the formation of hybrid carbon material at these temperatures.

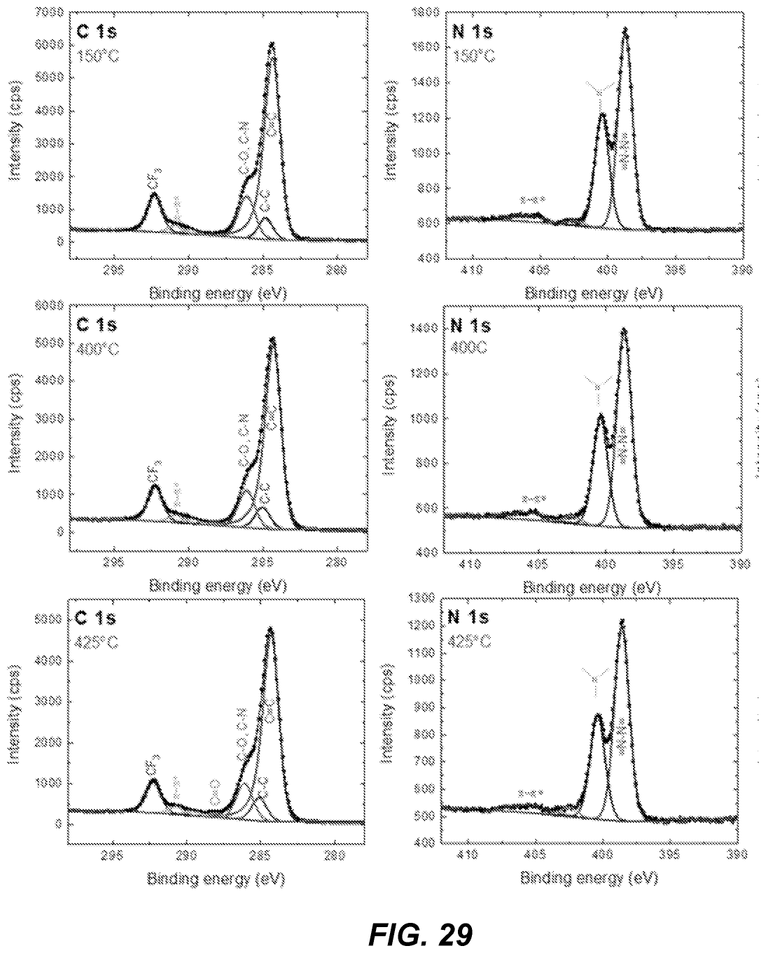

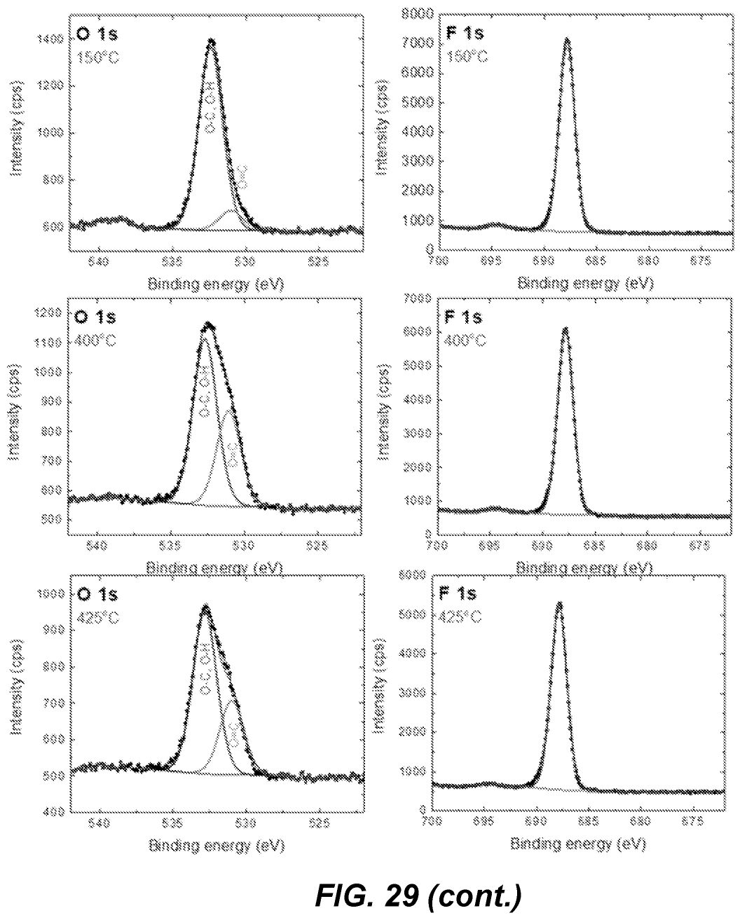

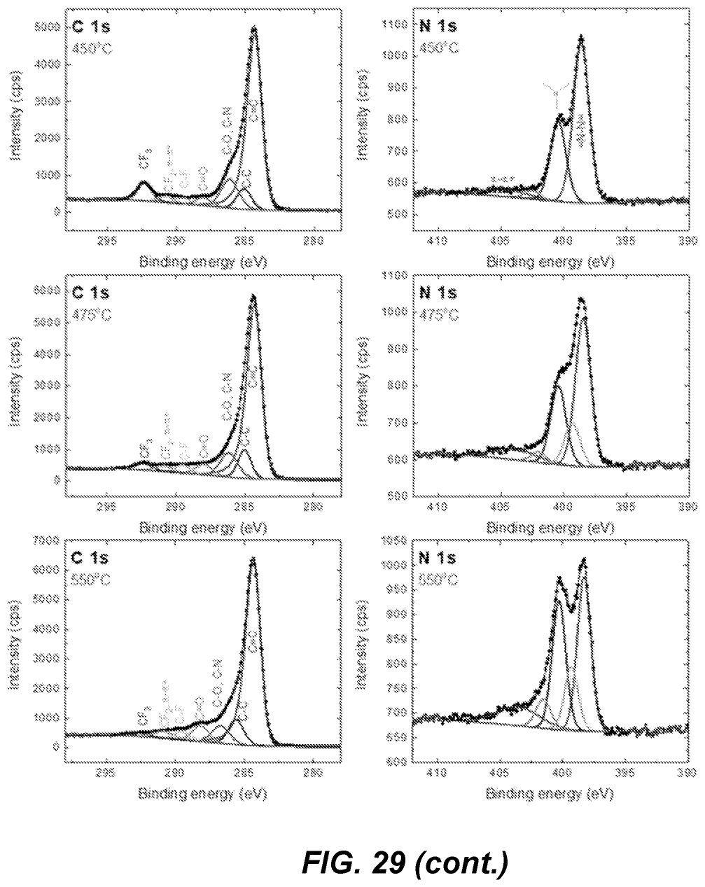

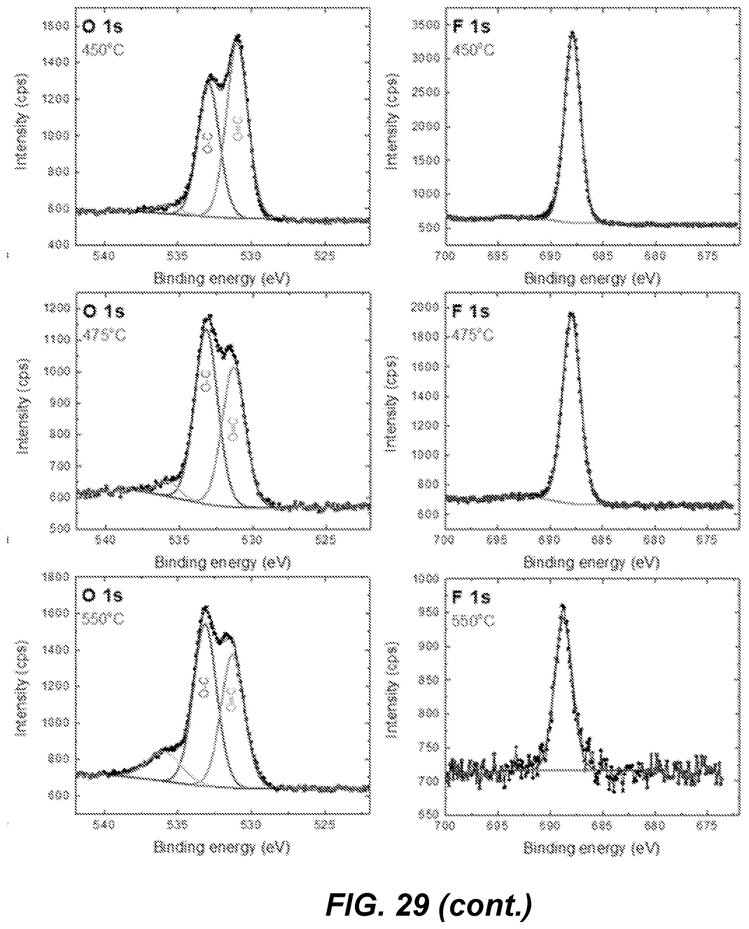

Survey and high-resolution XPS spectra of the C is, O is, and N is core levels gave the following information on the formed structure. The O is core-level spectra were fitted using two components located at 531.1 and 532.4 eV corresponding to C O, C—O bonds, respectively. The C is core-level spectra were fitted using seven components located at 284.4, 284.8, 286.1, 288.4, 290.0, 290.9, and 292.3, attributed to C═C, C—C, C—O/C—N, C═O, C—F, CF₂/π-π* shake-up satellites, CF₃, respectively (FIGS. 16 and 29). The O is XPS spectrum obtained for the films treated at 425° C. (FIG. 16) shows a noticeable increase of C═0 bond intensity, compared to the spectrum obtained for those treated at 150° C. Simultaneously, the C is spectra (FIG. 16) also show a slight increase of C═O intensity at this temperature. This suggests that at 425° C., the carbonyl groups formation was probably initiated by the presence of phenoxy species, which are stabilized by resonance.

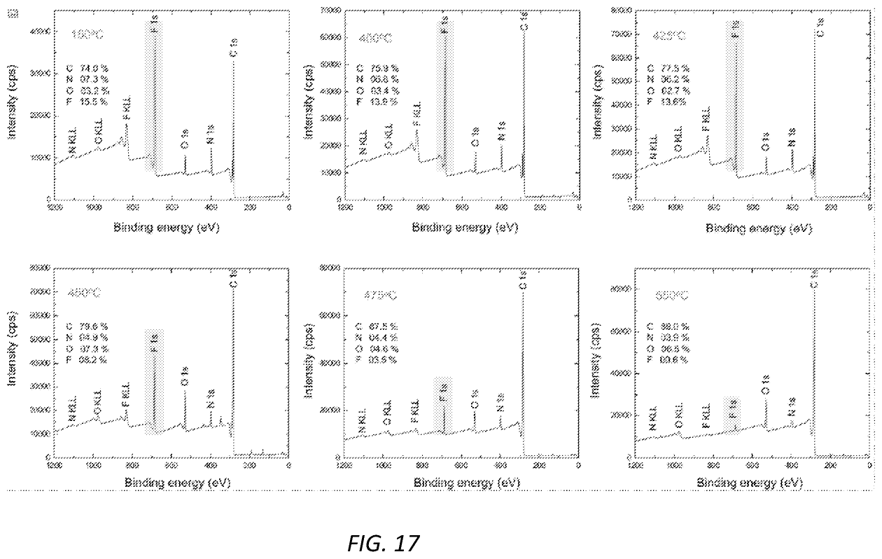

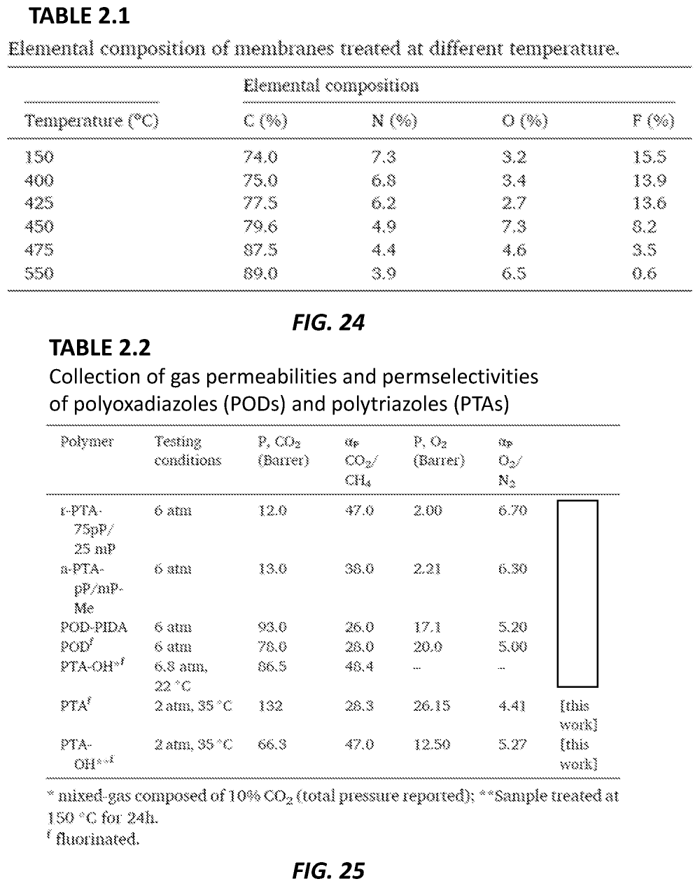

When the films were treated to 450° C., the hexafluoroisopropylidene unit started to decompose, which was confirmed by the decrease of the fluorine content from the survey spectra (FIG. 17) and decrease of the intensity of the CF₃ peak in the C is spectra). Table 2.1 (FIG. 24) shows how the elemental content changes with the treatment temperature, measured by XPS. Hydrogen is not included in the analysis. As the temperature increases, the carbon content increases and the nitrogen content decreases, but still remains 3.9% after treatment at 550° C. The fluorine content decreases from 15.5% at 150° C. to 0.6% at 550° C.

The N is spectrum for the film treated at 150° C. was fitted using four components located at 398.7, 400.4, 402,5, and 405.9 eV attributed to =N—N=, C—N, protonated nitrogen/N-oxide and N-oxide/π-π* shake-up satellites, respectively (FIG. 16). At 475° C., a new peak at 99.3 eV appeared, which might indicate the presence of N atoms in a graphite-like structure (quaternary N) (FIG. 29). Furthermore, the peak at 398.7 assigned to =N—N=is shifted to 398.4, indicating that new nitrogen species are formed and probably correspond to pyridinic nitrogen. The results indicated that at 475° C. a hybrid structure is formed, which contains unmodified triazole rings and nitrogen in different configurations, confirming the NMR findings. At 550° C., the N is spectrum was fitted using five components located at 398.3, 399.3, 400.3, 401.6, and 403.6 eV attributed to pyridinic (N₆), pyrrole-like nitrogen (N₅), graphite-like structure (quaternary N (N₃)), pyridine oxide and N-oxides, respectively (FIG. 16). The N is spectrum at 550° C. is characteristic of nitrogen-doped graphene. This observation is confirmed by the C is spectrum obtained at 550° C., where an asymmetrical shape of C 1s is dominated by the contribution of the sp² hybridized carbon characteristic of the graphene structure.

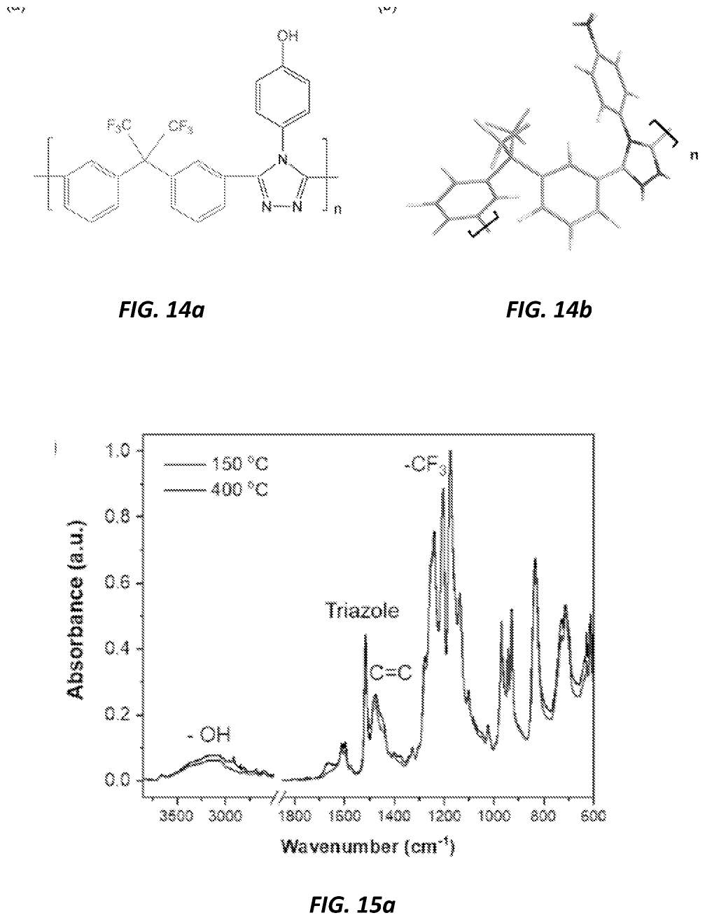

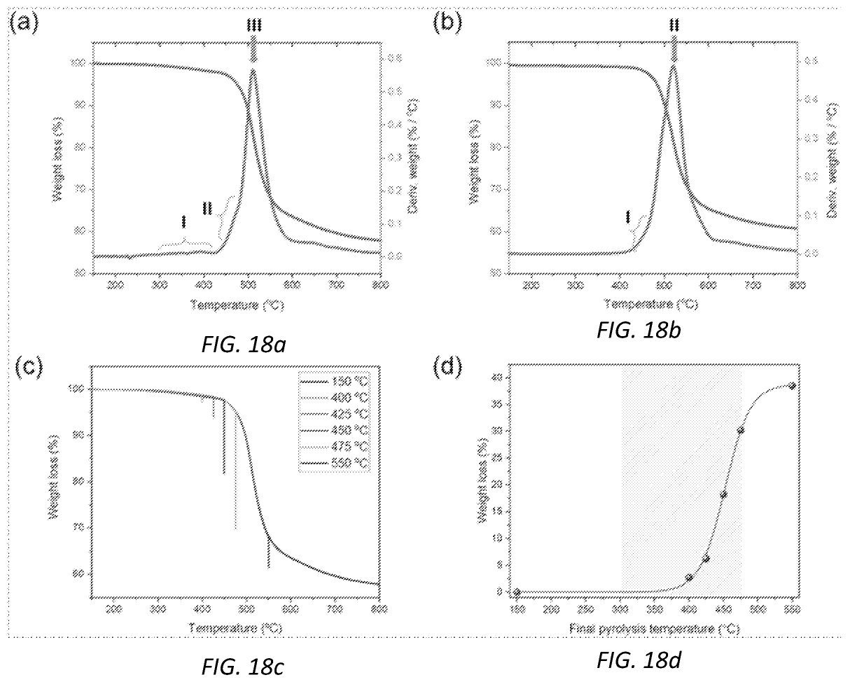

FIG. 18 shows the TGA curves of polytriazole film polymers with (PTA-OH, FIGS. 14a and b) and without the hydroxyl functionalization (PTA, FIG. 1b). The TGA curve PTA-OH (FIG. 18a) presents a slight decrease in weight starting at about 300° C. (see peak (I) in FIG. 5a). This peak is not present for the PTA sample without the —OH functionality, whose thermogram does not present any significant weight loss below 450° C. In correlation with the NMR and XPS results, we deduce that treatment temperatures higher than 300° C. starts to activate the crosslinking of the PTA-OH polymer. We also infer that the presence of the —OH functionality is pivotal for this process.

The furnace thermal treatment of PTA-OH films was simulated via TGA measures. Specifically (FIG. 18c), shows the TGA curves for the sample treated at 150, 400, 425, 450, 475, and 550° C. under N₂ atmosphere at a rate of 5° C. min⁻¹ and with an isothermal phase of 2 h. The weight loss of samples treated at 400 and 425° C. was 2.7% and 6.2%, respectively. When increasing the temperature to 450° C., the weight loss raised to 18.2%. The samples treated at 475 and 550° C. had a weight loss of 30.2% and 38.5%, respectively (no weight loss was observed at 150° C.). By plotting these values in a graph of weight loss vs. final pyrolysis temperature and interpolating with a sigmoidal function (FIG. 18d), a curve slope roughly increasing in the range 300-475° C. was observed (see the highlighted region). After this last temperature, the slope of the graph starts to decrease again, possibly indicating the shift from one to the next process, i.e., the formation of a fully developed CMS structure.

In summary, by thermally treating the PTA-OH membranes at temperatures in the range of ˜300-400° C., a crosslinked polymer network is predominantly formed. Moreover, by treating the films at temperatures higher than 425° C., the cleavage of hexafluoroisopropylidene units and the sequential triazole ring-opening occurred, leading to a relatively high concentration of nitrogen-doped graphene-like structure.

### 2. Microstructure and Morphology Evolution

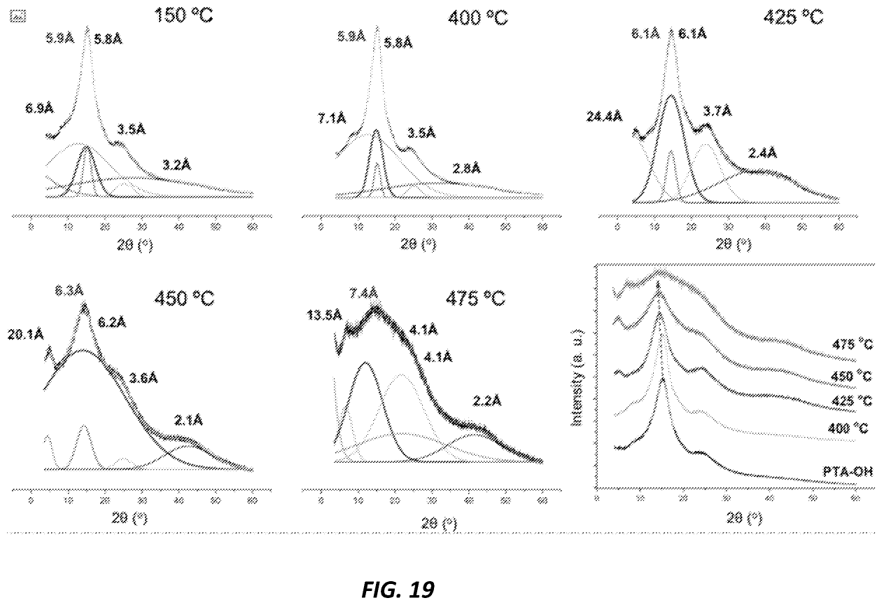

In FIG. 19 displays the wide-angle X-ray scattering patterns of the PTA-OH films treated at 150° C. or at higher temperatures. As expected, all the membranes present an amorphous structure, which is qualitatively maintained after thermal treatments up to a temperature of 450° C. At this temperature, the ultramicroporous structure abruptly rearranges, which reinforces the observation that this temperature is the threshold for the definition of a predominant CMS structure.

In FIG. 19, the deconvoluted halos at around ˜15° 2θ angle are highlighted, which correspond to ˜6 Å spacing. These (and the non-deconvoluted peaks also shown in FIG. 19) shifts towards lower scattering angles (larger spacing). The peaks become broader as the treatment temperature is increased. The position of the peak and corresponding d-spacing value can be correlated with the free volume fraction of the polymer and the average interchain (backbone) distance available for permeation. The width of the peaks is an indication of the homogeneity of the chain packing and interchain distances all over the sample. Sharp peaks are expected for highly ordered, crystalline polymers; broader peaks are an indication of a more amorph system. Without being bound by theory, if during the thermal treatment, part of the functional groups are being released, generating “empty spaces”, this justifies the shifts to smaller scattering angles. The increase of permeability of the thermal-treated PTA-OH films is discussed below. It is worth noting that analogous observations have been reported in the literature for other systems submitted to thermal crosslinking tested for gas separation. Hence, in contrast to physical aging and thermal annealing, thermal crosslinking (and at higher temperatures pyrolysis) can enhance the excess fractional free volume of the polymer matrix as a consequence of functional groups degradation.

Another halo corresponding to 3.5-3.7 Å was identified (also shifting as the treatment temperature increased), which can be correlated with the local inter-chain spacing induced by the bulky hydroxyl-functionalized phenylene pending unit (note that the kinetic diameter of benzene is 0.37 nm) or with the presence of 7-7 stacks typical of aromatic polymers.

For all films analyzed in FIG. 19 and specifically for those treated at 425, 450, and 475° C., an additional broad halo is observed corresponding to 2.4-2.1 Å, which might be linked to the formation of graphitic structures (110). However, in previous reports using other precursors, such structures were observed at temperatures generally much higher than 550° C.

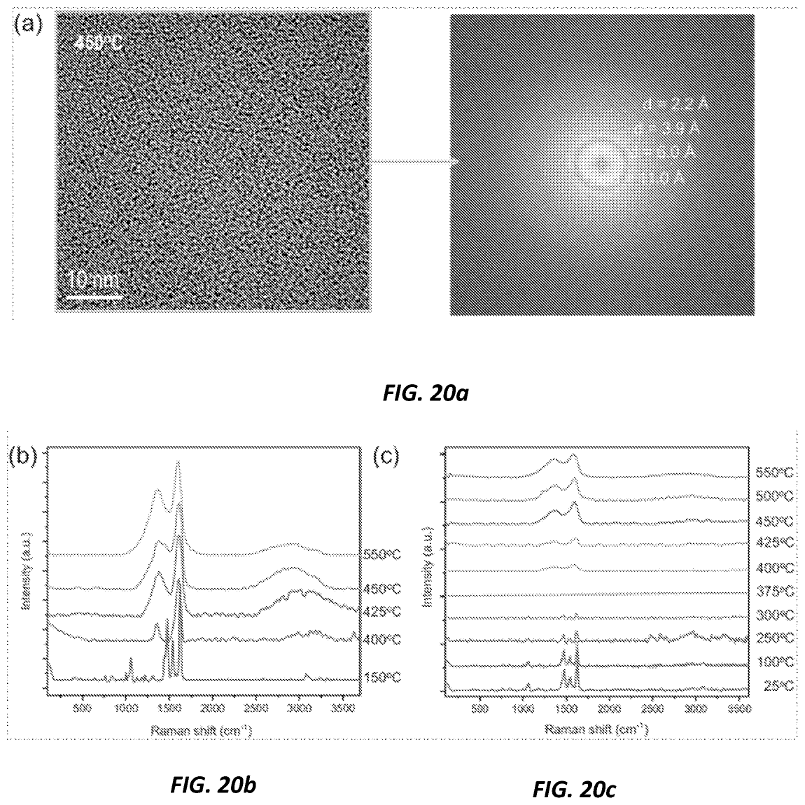

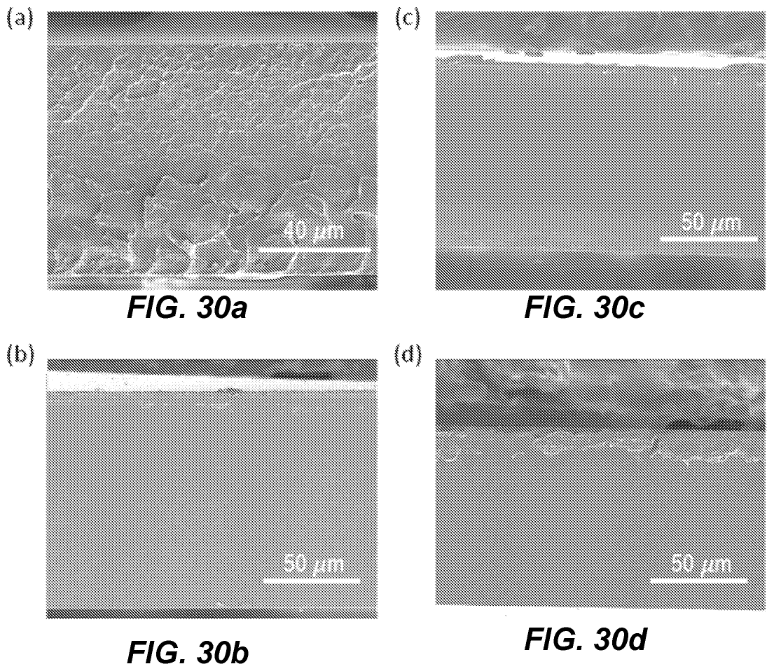

The morphology of all fabricated films was further investigated via scanning electron microscopy (SEM) (FIG. 30) and transmission electron microscopy (TEM). As a dense film, the SEM images do not revel relevant structures other than those typical of polymeric film samples fractured in liquid nitrogen. The high-resolution TEM image of the film treated at 450° C. shows locally ordered areas (FIG. 20a), similar to those reported for other CMS systems in the literature. A Fourier transform of the high-resolution TEM image (FIG. 20a) leads to spacing values similar to the d-spacing calculated from the XRD spectra.

The formation of the nitrogen-doped graphene-like structure was confirmed by Raman spectroscopy. The Raman spectrum collected for a PTA-OH film pretreated at 150° C. shows at 1620 cm⁻¹ strong in-plane deformation vibrations of sp² aromatic protons from C6-rings of PTA-OH (FIGS. 20b, 31, and 35 (Table 2.6). The intensity values in FIG. 20b are normalized by the maximum intensity measured for each curve. The corresponding plots with absolute (non-normalized) values are seen in FIG. 29. Weak symmetrical stretching vibrations of O—H and C—H groups are observed at 3235 cm⁻¹ and 3070 cm⁻¹, respectively. The film treated at 400° C. shows a corresponding phonon G-band at 1580 cm⁻¹ and the defect D-band at 1350 cm⁻¹. These bands become more prominent by treating the films at 425° C. and above, evidencing the formation of a N-graphene-like material (FIG. 20b). A broadband characteristic of 2D structures is also seen in the range of 2800-3100 cm⁻¹.

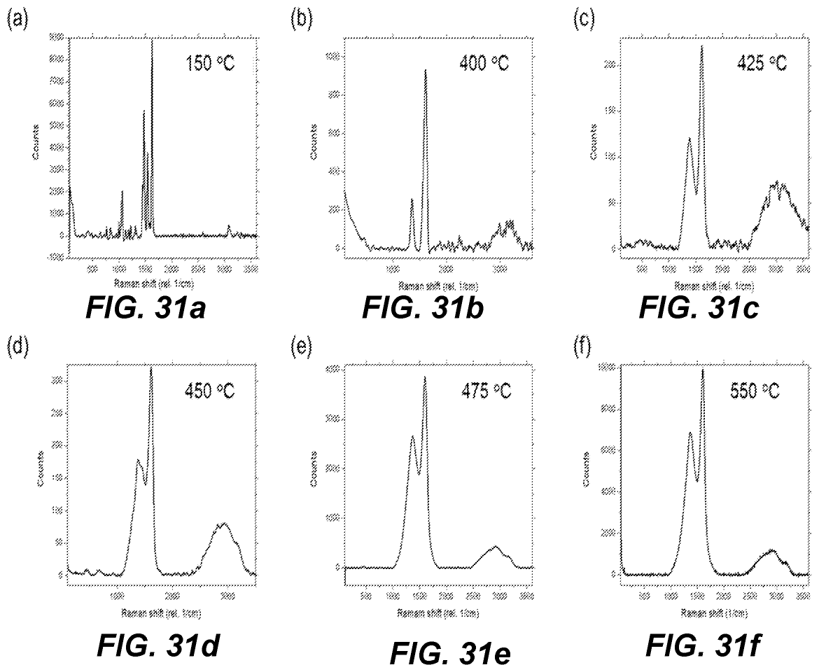

Interestingly, the concentration of defects of the graphene-like compound that is formed at 400° C. is relatively low, with I_{D}/I_{G} (400° C.)=0.25 (FIG. 20b), estimated by the ratio of integrated peaks at 1350 and 1580 cm⁻¹. As the treatment temperatures increase to 425 and 450° C., respectively, the ratios of defects increase to I_{D}/I_{G} (425° C.)=0.78 and I_{D}/I_{G} (450° C.)=0.81. This could be explained by further PTA-OH transformations and rearrangements, which occur in the temperature range of 400-450° C. (FIGS. 20b and 31), also evidenced by NMR, XPS, and TGA data. Above 450° C., the fraction of defects decrease again, with the films evolving to a more organized structure with high carbon and low fluorine contents (FIG. 24 (Table 2.1)). I_{D}/I_{G} values for 475 and 550° C. are practically the same, 0.47 and 0.48, respectively, indicating that no further structural changes take place in this range of temperature. Based on the ratio of I_{D}/I_{G}, the average size (Lₐ) of ordered sp² domains formed as a result of the thermal treatment is estimated, using equation (5):

$${L}_{a} ( nm ) = ( 2.4 \cdot {10}^{- 10} ) {{λ}^{4} ( \frac{{I}_{D}}{{I}_{G}} )}^{- 1} \qquad ( 5 )$$

where Lₐ is the average size of ordered domains, is the laser wave-length in nm, I_{D} and I_{G}—are integrated intensities of the D- and G-band, respectively.

The Lₐ value at 400° C. is 47.5 nm, which is a relatively large size of orders domain of 2D material, while with further heating at 425-450° C., the Lₐ values drop to ˜15.4 nm. A heating treatment above this temperature leads to a slight increase to 25.2 nm.

Raman in situ experiments were performed to simulate and simultaneously detect the chemical changes taking place while the films are being heated. The results show that by heating up to 300° C. the characteristic peaks of the functional groups of PTA-OH are still intact, leading to the conclusion that no significant changes have occurred during the treatment (FIG.). By heating above 375° C., a strong fluorescence background rise intensity in the Raman signal detection.

Crosslinked-enhanced emissions have been reported in the literature for emerging materials such as non-conjugated polymer dots, locally crosslinked systems with heteroatoms, confined domains with restricted vibration and rotation, for instance. Without being bound by theory, this effect might be linked to the start of chain rearrangement and mobility restriction by crosslinking of PTA-OH at this temperature.

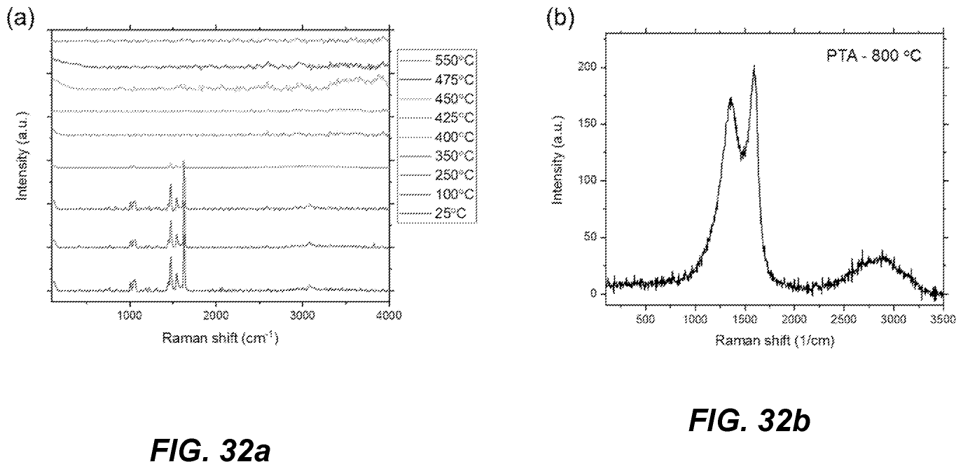

Further heating to 400° C. leads to the appearance of weak phonon G and D bands, characteristic of multi-layered graphene-like structures. By raising the temperature above 400° C., the intensities of the G and D bands increase, and at 3000 cm⁻¹ an additional broadband characteristic of multi-layered graphene-like 2D material emerges (FIG. 20c). In opposite to PTA-OH, the in situ Raman measurements for the poly-triazole without OH groups show no transformations to a 2D carbon-like material when heating in the range of 400-550° C. (FIG. 32a). This indicates that the formation of the crosslinked network, induced by the presence of the OH groups, plays an important role in facilitating the formation of the graphene-like structure starting at temperatures around 425° C. In contrast, the formation of the 2D carbon-like materials for PTA, similar to those observed for PTA-OH in the range of 400-550° C., occurs only at a temperature as high as 800° C. (FIG. 32b).

### 3. Gas Transport Properties

This section describes how the evolution of the PTA-OH structure, first as a crosslinked network and then further into a fully developed CMS, influences its single- and mixed-gas transport.

### Films Treated at 150 and 200° C.

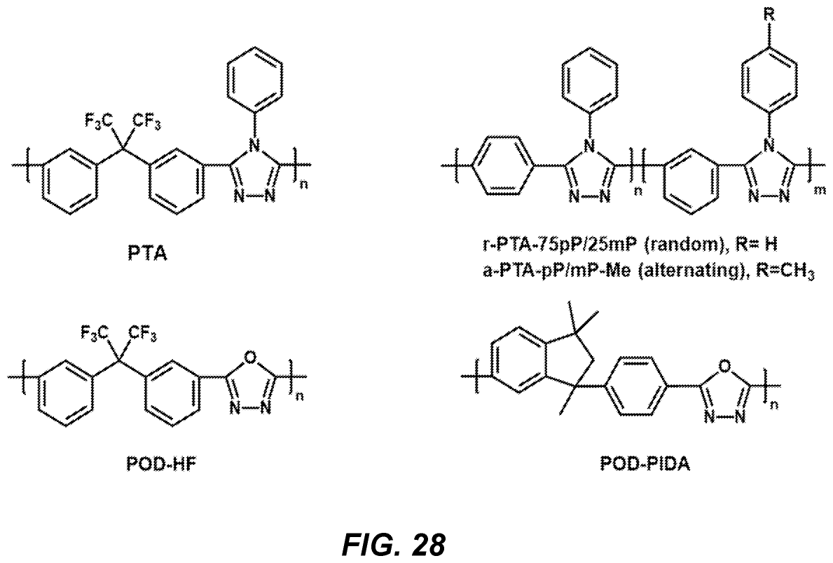

Gas transport properties of polyoxadiazoles (PODs) and their modification into polytriazoles (PTAs) are discussed in the literature, although the first data was reported by in the late 80's. Table 2.2 (FIG. 25) lists a collection of previously reported CO₂/CH₄ gas separation data for PODs and PTAs, together with the values obtained in single-gas experiments for the OH-functionalized and unfunctionalized PTA films described in this example, thermally treated only up to 150 and 200° C., which should not chemically affect the PTA, but eliminate any remaining solvent. The non-fluorinated tight structure of r-PTA-75pP/25 mP and a-PTA-pP/mP-Me (see chemical structures in FIG. 28), has a decent CO₂ value of 12-13 Barrer and moderate CO₂/CH₄ and O₂/N₂ selectivities. Table 2.2 also shows that the transformation of the fluorinated POD structure into polytriazole seems to enhance the gas permeability since the CO₂ permeability of POD increases from 78 to 132 Barrer after conversion to PTA (without OH), however, a more detailed study is needed on the theme. The hydroxyl functionalization of PTA into PTA-OH introduced inter-chain hydrogen bonding, tightening the structure, reducing the gas permeability (e.g., −50% for CO₂), and consequently rising the permselectivity (e.g., 66% for CO₂/CH₄ gas pair).

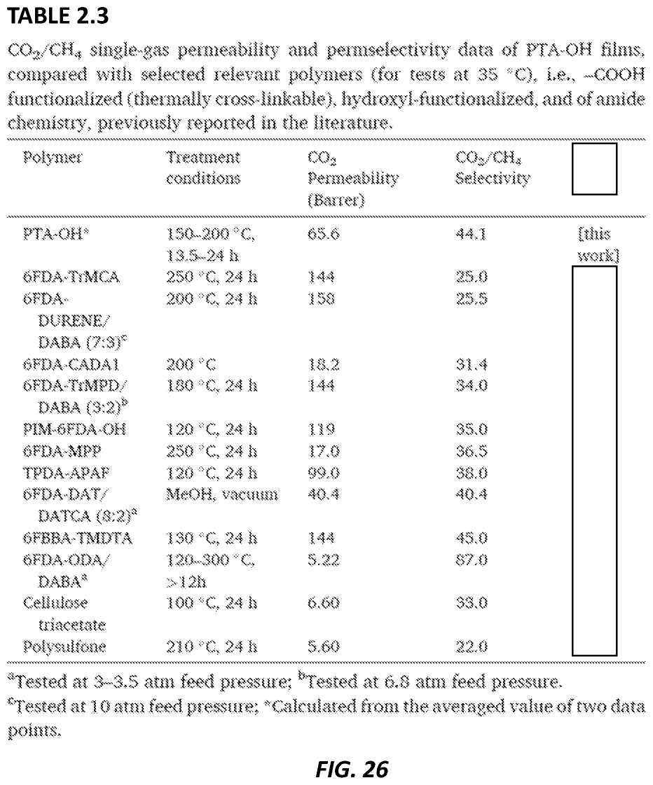

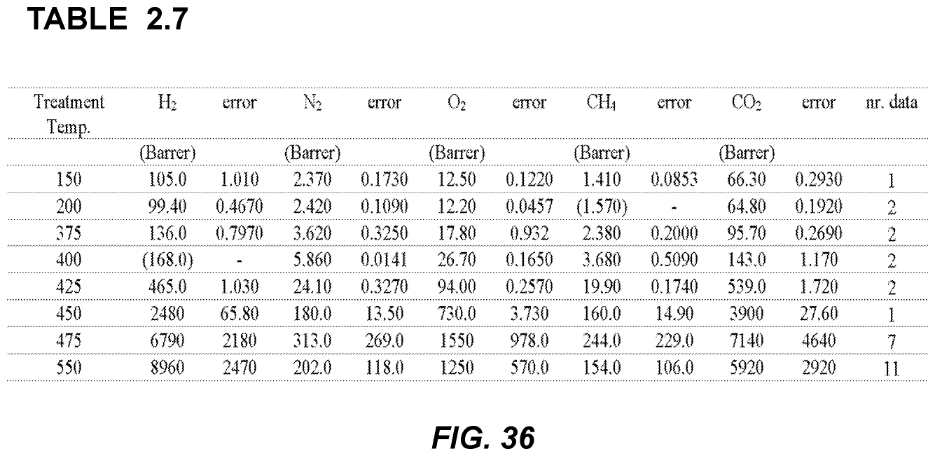

Table 2.3 (FIG. 26) lists the CO₂/CH₄ single-gas permeation data (all entries can be found in detail in FIG. 36 (Table 2.7) obtained for PTA-OH films treated at 150° C. together with selected relevant literature covering fluorinated polyimide and polyamide films. On average, the PTA-OH film ensured a CO₂ permeability of 66 Barrer, combined with a CO₂/CH₄ selectivity in the range of 44. Concerning gas pair selectivities, these values are in line with those of high fractional free volume carboxyl-functionalized (e.g., the 6FDA-TrMCA and 6FDA-TrMPD:DABA) and hydroxyl functionalized (i.e., PIM-6FDA-OH and TPDA-APAF) polyimides, as well as with those of the polyamide of intrinsic microporosity reported elsewhere (i.e., the 6FBBA-TMDTA). Although PTA-OH does not have contortions sites, it presents permeability values not too distant from those ensured by functionalized polyimides of intrinsic microporosity such as, for instance, TPDA-APAF.

Also, compared with the archetypal material for commercial mem-branes for natural gas sweetening, cellulose triacetate (CTA), PTA-OH films treated at 150-200° C. were 10 times more permeable and 1.4 times more selective—confirming the potential of this material for such application.

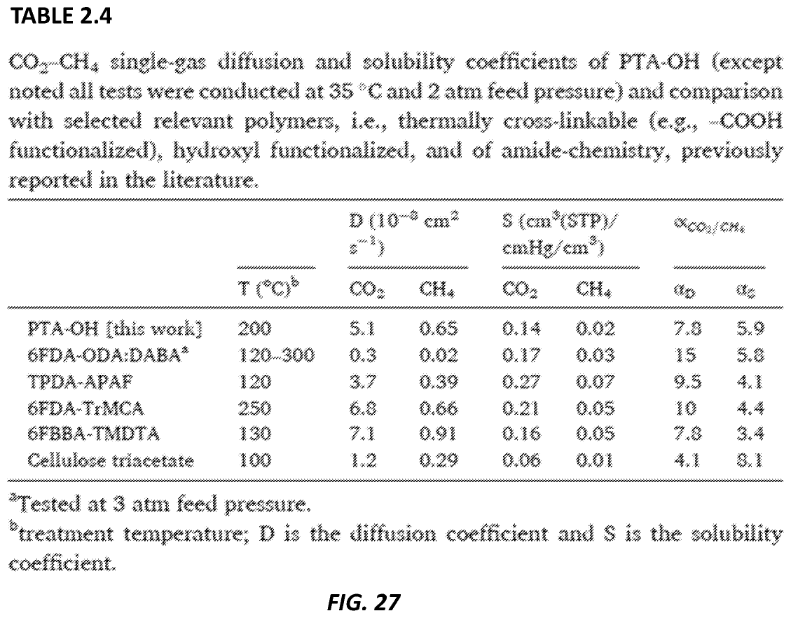

Dissecting the transport properties into solubility and diffusion coefficients (Table 2.4 (FIG. 27)), one notes a distinct high solubility selectivity of PTA-OH (in this paragraph, only the gas pair of CO₂ and CH₄ are discussed). The value of 5.9 is higher than that obtained with carboxyl and hydroxyl functionalized polyimides of intrinsic microporosity (PIM-PIs) and the high fractional free volume polyamide 6FBBA-TMDTA. This value is indeed lower than that of cellulose triacetate, which is well known for its peculiarly high solubility selectivity. Moreover, although presenting CO₂ diffusion coefficients lower than those of the PIM-PIs listed in Table 2.4, PTA-OH suffers from somehow lower CO₂ solubility coefficients, explainable by the limited excess fractional free volume intrinsic of its linear structure.

The CO₂/CH₄ diffusion selectivity of PTA-OH was moderate, in line with that of 6FBBA-TMDTA polyamide, and about twice higher than that of cellulose triacetate.

### 2. Thermal Treatment and Crosslinking

This section describes the gas permeation behavior change of PTA-OH with the treatment temperature, focusing on the range in which crosslinking is initiated and predominant.

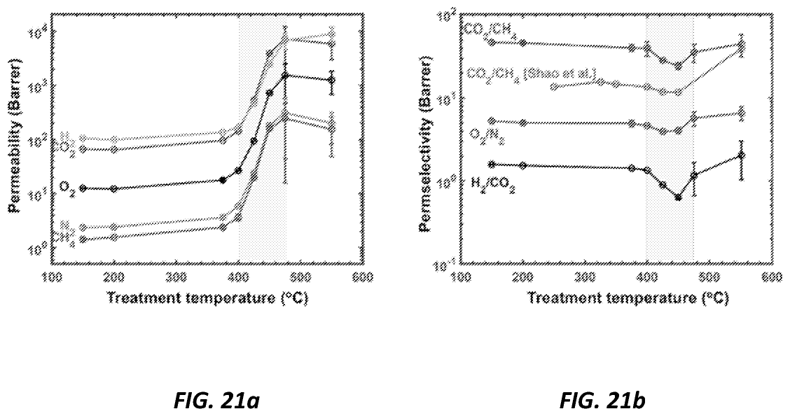

FIG. 21 shows the single-gas permeability and selectivity trends of PTA-OH as the treatment temperature is increased in the range between 15° and 550° C. (under N₂ atmosphere). FIG. 21 also shows how the permeability increases with treatments up to 475° C. Furthermore, the treatment temperature in the range of 400-475° C. (highlighted in FIG. 21) seems to subject the polymer matrix to an intense transformation. This distinct behavior between the two regions, i.e., below 400° C. and be-tween 400 and 475° C. was also observed for other polymer systems following a thermal crosslinking (via functional groups degradation) and pyrolysis (discussed below).

In the region of the graph between 15° and 400° C., all gas pair selectivities are practically constant (FIG. 21b); on the other hand, all gas permeabilities increase (FIG. 21a). This increase is first moderate at the lower temperature range, but after thermal treatments at 375 and 400° C., the CO₂ permeability increases 1.6 and 2.2-fold, respectively, compared with the uncrosslinked samples (i.e., those treated only at 150-200° C.).

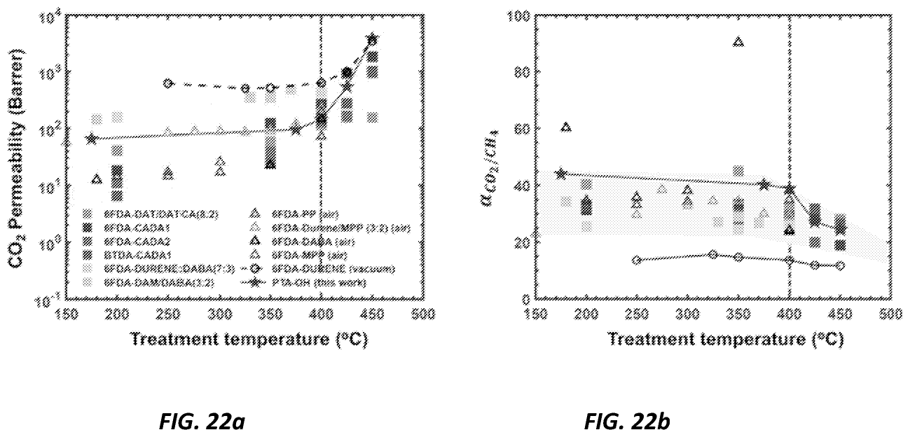

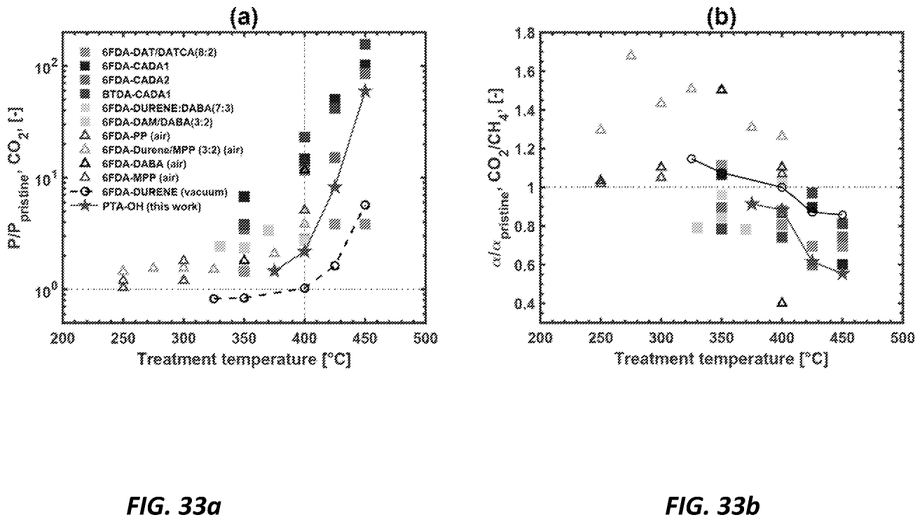

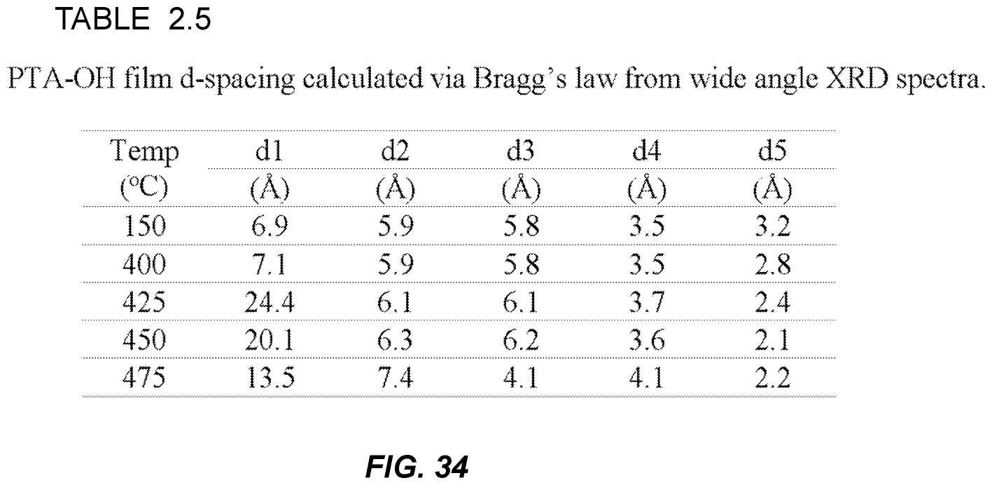

An increase of permeability has been previously reported for other polymer systems too, following different forms of thermal crosslinking and have been in those cases attributed to the release of by-products of the crosslinking reaction. A first example is the thermal crosslinking of bromine-substituted 6FDA-DURENE based on debromination at 360° C. The complete degradation of the Br-functionalities after crosslinking has been observed, resulting in a permeability increase proportional to the increase of the degree of bromination. At the highest bromine substitution, a 3-fold CO₂ permeability enhancement of even higher was observed, associated with a ˜50% CO₂/CH₄ permselectivity reduction. Another example is the crosslinking of sulfonated poly-ketones. Previous reports have noted how the degradation of sulfonic groups and thermal crosslinking of their S-PEK-C polymers induced SO₂ and CO₂ release, correlating with a permeability enhancement (which qualitatively resembles the behavior of the PTA-OH polymer). Additionally, in the case of the decarboxylation crosslinking of —COOH functionalized PIM-1 (i.e., C-PIM-1), a gas permeability increase (for CO₂, on average, a 1.5 fold variation depending on the hydrolysis degree) and a practically invariant gas permselectivity (only small average decrease of 0.94 times for the CO₂/CH₄ gas pair as estimated from the original C-PIM-1 data reported in the art) was observed. This means that in consequence of the crosslinking reaction and by-product gas release (generally CO₂), an excess fractional free volume is generated, thus boosting the transport capability of the polymer film. FIG. 22 analyzes the permeability and permeability-selectivity data for the CO₂/CH₄ gas pair through films treated at different temperatures in the context of data available in the literature for cross-linkable 6FDA-based polyimides (mainly undergoing decarboxylation crosslinking). The same figure is presented in a normalized form (relative to the values of the untreated samples) in the FIG. 33a-b In particular, in FIG. 22, the permeability of most examples increases at a slow rate until 400° C. (permselectivity remains about constant or decreases slightly as shown in FIG. 22b) and then abruptly; thus, recalling the behavior seen for PTA-OH (FIG. 21). It is interesting to compare the plotted crosslinkable polymers, including the PTA-OH data, with those for 6FDA-DURENE with crosslinkable functionalization (see the black dashed curve in FIG. 22a). When treated at temperatures even below 400° C., crosslinkable polymers experience a permeability increase due to some functionality decomposition during the cross-linking reaction, whereas the permeability of non-functionalized 6FDA-DURENE remains constant. Another confirmation of the hypothesis that the release of gas during crosslinking is responsible for the permeability increase with little or no adverse effect on permselectivity can be found in the literature, reporting the self-crosslinking of PIM-1 under vacuum through the formation of triazine rings. This crosslinking reaction does not release by-product gases by design. Indeed, in comparison with the starting polymer sample (uncrosslinked, methanol treated), the CO₂ permeability of the crosslinked PIM-1 (and that of other gases) decreased by about 1.74-3.13-fold (depending on the thermal treatment duration and temperature), and all gas-pair permselectivities increased monotonously with time and treatment temperature (almost doubling for a crosslinking process lasting two days at 300° C.). In this case the high free volume characteristic of PIM-1 is reduced as the crosslinking proceeds.

For treatment temperatures above 400° C., the PTA-OH film under-went a remarkable matrix transformation, which strictly correlates with the destiny of the —CF₃ functional groups. FIG. 17 shows how the fluorine content reduces for treatment temperatures higher than 400° C. Previously reported results showed that during the decarboxylation-based crosslinking of 6FDA-DAPI/DABA (1.9:1) there is a removal of —CF₃ groups at temperatures above 400° C. Without being bound by theory, the decomposition of hexafluoroisopropylidene (6FDA) units is the most probable responsible for the abrupt permeability increase seen in FIG. 22a for practically all-polymer films (except BTDA-CADA-1), having similar fluorinated groups as part of the backbone, including PTA-OH. An abrupt increase is also reported for 6FDA-DURENE. In fact, although this polymer does not undergo crosslinking, as the treatment temperature is higher than 400° C., it is subject to local decomposition and follows the permeability trend of PTA-OH and other 6FDA-based polyimides (FIG. 22a). This intense polymer matrix rearrangement is also reflected by the permselectivity data reported in (FIG. 22b). In the range 400-475° C., an indentation of the permselectivity vs. thermal treatment curve is observed for PTA-OH films—which was also reported for the 6FDA-DURENE—that might be a demonstration of the formation of local diffusion selectivity defects mirroring the —CF₃ sites decomposition.

### 3. Evolution to Carbon Structure and Mixed-Gas Behavior

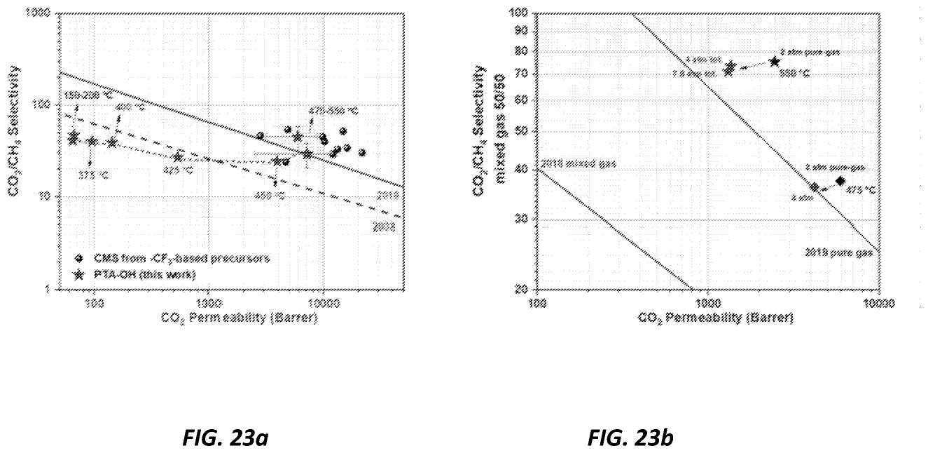

The performance plot of FIG. 23 further illustrates how PTA-OH samples treated at temperatures of 425-450° C. sit in the transitional region between a predominantly crosslinked structure and a fully developed CMS structure at 475-550° C. PTA-OH is mostly transformed into a nitrogen-doped graphene-like structure at these last high treatment temperatures and has lost most of its fluorine content, as confirmed by XPS and Raman (FIGS. 16 and 20b).

FIG. 21 displays a maximum permeability as the treatment temperature reaches 475° C. From this point, an inflection is observed since the effect of the CMS matrix tightening prevails over the gas by-product release.

CMS films fabricated from PTA-OH precursors at 475-550° C. (2 h under nitrogen atmosphere) performed similarly to most of the best carbon molecular sieve dense membranes produced from polyimides at similar temperatures (see FIG. 23a compared to data in the literature). The data reported here, for a treatment temperature of 475-550° C., comprised up to 11 tests on 11 different samples (the variability seen in FIG. 23a is typical for CMS films, as already noted in previous literature). For the treatment temperature of 550° C., a best single-gas CO₂ permeability vs. CO₂/CH₄ selectivity combination of 2470 Barrer and 75.3, respectively, was measured. This best sample further underwent mixed gas (equimolar mixture) analysis, and the results are plotted in FIG. 23b (CO₂/CH₄ selectivity 74 with CO₂ permeability 1360 Barrer). The plot also reports the pure and mixed-gas data obtained from a sample treated at 475° C. for 2 h. Both samples are positioned above or on the CO₂/CH₄ upper bound proposed in 2019 for single gases and far above the CO₂/CH₄ mixed-gas trade-off curve reported in 2018.

### Conclusion

Among other classes of materials for CO₂/CH₄ separation, mixed matrix membranes have attracted interest of different groups. A series of thermally rearranged polymer membranes based on hydroxypolyimide with different fillers have been recently reported in the literature with permeability around 1000 Barrer and CO₂/CH₄ close to 30. In summary, the influences of thermal treatment of OH-functionalized polytriazole on its chemical structure and CO₂/CH₄ separation properties was investigated. A crosslinked polymer network is formed when PTA-OH films are treated in the range of ˜300-400° C. By increasing the temperature above 425° C. a multi-layered nitrogen-graphene-like material arranged in an overall amorphous carbon configuration is obtained and a fully CMS structure could be observed when the limit of ˜475° C. was reached. The formation of the cross-linked network in the early stage of the thermal treatment, due to the presence of OH groups, is a key factor in developing the nitrogen-doped graphene-like material in the range of 400-550° C.

Concerning the gas permeation properties, the PTA-OH films performed as follows:
(1) Crosslinking at ˜300-400° C. resulted in increasing permeabilities with about invariant permselectivities, matching the behavior of the best available polymer chemistries undergoing thermal crosslinking at similar temperatures.
(2) The range 400-475° C. produced a transitional film structure with the deterioration of —CF₃ groups being responsible for a decisive enhancement of permeability and a minor permselectivity depression associated with the appearance of local defects.
(3) A carbon molecular sieve (CMS) structure was formed at and above 475° C. CMS samples obtained from PTA-OH at 475-550° C. on average revealed stationary permeabilities and improved permselectivity.
(4) The best samples positioned far above the most recently reported ideal and multicomponent trade-off performance curves.

### Example 3

This Example describes direct synthesis of ultrathin polytriazole membranes by combining the phase inversion method and thermal crosslinking for complex separation.

### Introduction

Separation processes are essential in the chemical, pharmaceutical, and petrochemical industries and are widely used to purify solvents and chemicals, solvent exchanges, and catalyst recycle and recovery. These industries used conventional separation techniques such as distillation, adsorption, evaporation, and extraction, which have high carbon footprints and are energy-intensive. These separations represent up to 40-70% of both capital and operating costs. Academia and industry have been looking for alternative processes and strategies to streamline the separations.

Membrane technology is considered a sustainable process due to its low carbon footprint, small spatial requirements, and a lack of a phase transition in most cases, and can totally or partially replace the traditional separations. Considering that the chemical, pharmaceutical, and petrochemical industries are mostly organic solvent-based, the organic solvent nanofiltration (OSN) technology could be a feasible alternative to conventional methods.

To significantly impact the industrial OSN applications, membranes should combine easy processability with stability in a wide range of organic solvents and pH. In addition, the membranes have to be mechanically and thermally stable to reduce the physical aging, since many processes in the chemical, pharmaceutical, and petrochemical separations are taking place in the range of 60-90° C. or even higher. There are several different types of membrane materials that can meet the real requirements of the OSN industry, such inorganic materials (ceramics and metals) and porous hybrid materials (metal-organic framework (MOFs), zeolitic imidazolate frameworks (ZIFs)). Still, they have limitations, such as high cost, low mechanical properties, and difficult scale-up. In contrast, the polymeric membranes are inexpensive and relatively easy to prepare into large-scale modules. However, among all the polymeric materials, only a few classes were tested in the industries conditions (polyimide, polybenzimidazole, polyether ether ketone, and polymers with intrinsic microporosity (PIM)). This low number is probably limited due to the swelling effect that generally appeared when are exposed to harsh environments, which affects the separation performance. Recently, a new series of PIM-like polymers was reported that show attractive crude oil separations. There remains a lack of separation materials that can handle the industries conditions and the complex mixture, however. Furthermore, it is still challenging to overcome the permeability and selectivity trade-off, particularly in the industries like crude oil refining. Therefore, more materials that can be manufactured as a thin-film asymmetric or thin-film composite membrane are required to meet the industries demand.

This example investigates the use of thermally-treated PTA-OH membranes for liquid separations, including hydrocarbon separations.

### Experimental

### Materials

N-Methyl-2-pyrrolidone (NMP), N,N′-dimethylformamide (DMF) (99.8%), and all other reagents were procured from Aldrich. The polytriazole was synthesized by polycondensation reaction. All the chemicals were used as received.

### Membrane Preparation

The polytriazole membranes were prepared by phase inversion. The casting solutions were obtained by dissolving the polytriazole in the N-Methyl-2-pyrrolidone or N,N′-dimethylformamide (DMF) to result in 16 wt % of the polymer. The solutions were stirred overnight at room temperature, and then were cast on a glass plate using a doctor blade with 200 μm gap. The polymer membranes were obtained by immersing the glass plate into distillate water. The membranes were washed with distillate water for 72 h to eliminate any remaining solvent and further were dried using a freeze-drying process. The polytriazole membranes were crosslinked by thermal treatment in Lindberg/Blue M™ 1200° C. Split-Hinge Tube Furnaces. The furnace heating rate was set at 5° C. per minute. The obtained integral asymmetric membranes were thermally treated in the furnace under air atmosphere at 120° C. for 30 min before continuing the treatment to 300° C. for 1 h, 2 h and 3 h, and to 325° C. for 1 h and 2 h.

### Characterization

The chemical changes during thermal treatment were evaluated by Fourier Transform Infrared (FTIR) spectroscopy using a Nicolet 6700 FT-IR System. The FTIR spectra were recorded by performing 16 scans with a spectral resolution of 4 cm⁻¹.

Solid-State Nuclear Magnetic Resonance Spectroscopy was used to investigate the chemistry of the membrane that occurred during thermal treatment. One-dimensional ¹H MAS and ¹³C CP/MAS solid-state NMR spectra were recorded on Bruker AVANCE III spectrometers operating at 400 and/or 600 MHz resonance frequencies for ¹H. The chemical shifts were calibrated using the external references TMS and adamantane. The 2D ¹H-¹³C heteronuclear correlation (HETCOR) solid-state NMR spectroscopy experiments were conducted on a Bruker AVANCE III spectrometer using a 2.5 mm MAS probe, as described previously.

The membranes thermal stability was investigated by thermogravimetric analyses (TGA) on a TGA Q50 by TA instruments in a nitrogen atmosphere from 25 to 800° C., with a heating rate of between 1 to 10° C. min⁻¹. TGA was also used for preparing the samples treated at 300° C., 325° C., and 350° C. in a nitrogen atmosphere for a different time.

The pristine and thermally treated membrane morphologies were studied by scanning electron microscopy (SEM) on a Nova Nano microscope, using a 3-5 kV voltage and a working distance of 3-5 mm. The morphology was also studied by Transmission electron microscopy (TEM). Initial, the films were embedded in Epoxy resin at 60° C., and then ultrathin sections (70 nm) were cut using an ultramicrotome (Leica EM UC6). The films were imaging without staining with Titan CT (FEI company) microscope operating at 300 kV.

Mechanical measurements were performed with TA Instruments Q850 Dynamic Mechanical Analyzer in tensile mode. Rectangular samples (15×5 mm) were cut from the membranes with 70-80 μm thickness. The stress-strain behavior was recorded using a force ramp of 0.1 N/m, at 25° C., until break. Five samples were tested for each membrane. The ultimate tensile properties are calculated as the average of stress and strain at break. Strain-recovery analysis was performed by subjecting membranes to a stress of 1 MPa for 20 min, followed by a recovery period of 80 min with removed stress. The applied stress level was chosen to ensure that the creep measurements remained in the linear viscoelastic deformation regime of stress-strain curves and it matches the 5 bar pressure used for flux measurements. A small preload force of 0.01 N was applied to keep the sample right in the recovery regime.

The crystallinity and the d-spacing of the membranes were investigated using a Bruker D8 Advance diffractometer with Cu-Kα radiation source at 40 kV and 40 mV. The diffraction data were measured in the range of 5°-60°.

The membranes performances were consecutively measured at different temperatures (from 30 to 90° C.), in DMF, using a dead-end cell, at a pressures between 2 to 5 bar. Before the measurements, the membranes were immersed in DMF for 30 min and then transfer in water before mounted in the filtration cell. The filtration area of the membranes was 0.95 cm². The solvents was permeated through the membranes between 2 h and 4 h. The membranes performances were reported as an average of 3 different measurements. The long-time stability was performed by direct heating the dead-end cell at 30 or 65° C. The permeances were measured for approximately 48 h or 72 h. The solvent permeance was evaluated using equation 1:

$$J = \frac{Q}{A Δ P} \qquad ( 1 )$$

where Q is the permeation rate (L h⁻¹), A is the active filtration area (m²), and ΔP is the pressure (bar).

The rejection was measured by filtrating methyl orange (MO, Mw=327 g/mol) and acid fuchsin (AF, Mw=585 g/mol) in DMF. The concentration of the dyes in DMF was between 10 to 50 ppm. The rejection experiments were performed between 2 h and 4 h before collecting the samples for analysis. The rejection (R) was evaluated using equation 2:

$$R ( \% ) = ( 1 - \frac{{C}_{p}}{{C}_{f}} ) \times 100 \qquad ( 2 )$$

where Cp is the solute concentration in the permeates, and C_{f} is the solute concentrations in the feed. UV spectrometer (NanoDrop 2000c) was used to evaluate the separation of the dye molecules.

### Results and Discussion

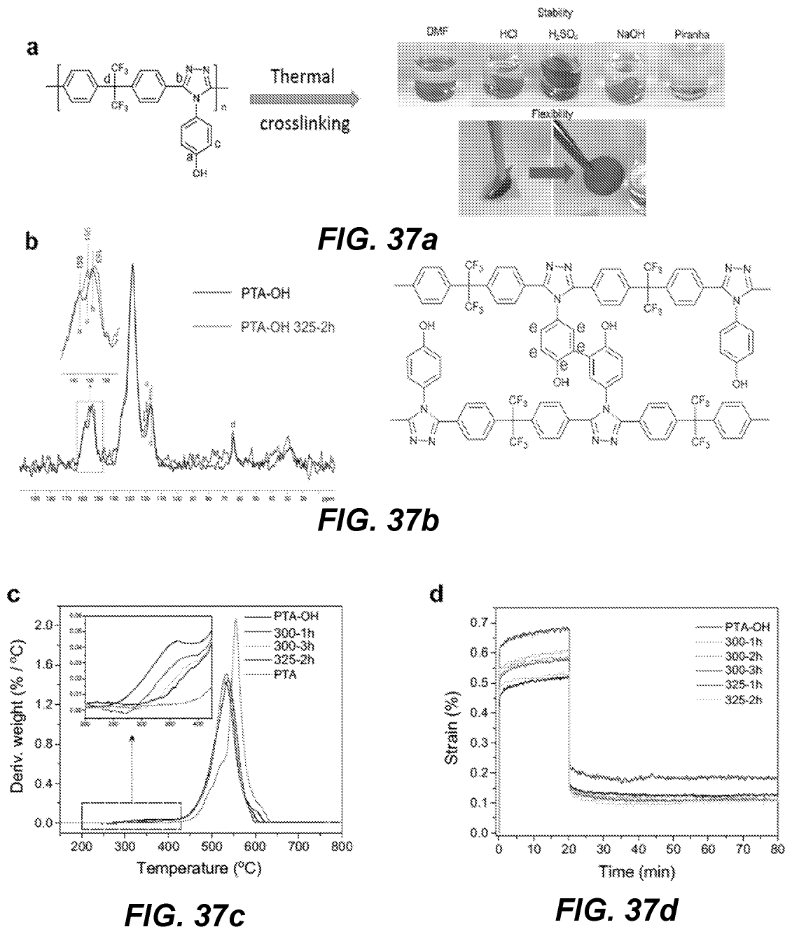

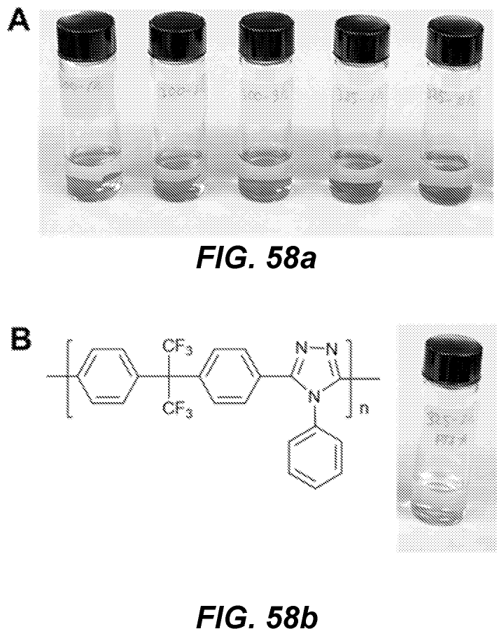

Ultrathin polytriazole asymmetric membranes were fabricated by combining classical phase inversion method and thermal crosslinking. The resulting membranes were exposed to high-boiling polar aprotic solvents like DMF, which are used to extract the aromatic fraction from refinery streams and complex mixture like crude oil. Polytriazole with pendant hydroxyl (OH) groups (FIG. 37) was used because this polymer can easily be synthesized in large amounts and shows good mechanical properties and high thermal and thermal-oxidative stability. Additionally, the pendant OH groups make this polymer versatile in terms of crosslinking or modification. The membrane formation involves first the dissolution of the polytriazole polymer in two solvents (N-Methyl-2-pyrrolidone (NMP) or N,N′-dimethylformamide (DMF)) followed by the phase inversion in water. To induce crosslinking, the polytriazole membranes were treated at 300° C. for 1 h, 2 h and 3 h, and to 325° C. for 1 h and 2 h, respectively, in a furnace under an air environment. The resulting crosslinked membranes are stable in strong solvents, such DMF, in strong acids (hydrochloric acid 37% (HCl) and sulfuric acid 98% (H₂SO₄)), base (sodium hydroxide 2M (NaOH)), and show reasonable stability even in piranha solution (FIGS. 37a and 58). The crosslinking reaction was investigated by using solid-state Nuclear Magnetic Resonance (SS-NMR). FIG. 37b shows the ¹³C cross-polarization magic-angle spinning (CP MAS) for pristine PTA-OH membranes and the membrane treated at 325° C. for 2 h. The crosslinked membrane spectrum presents a broad peak with small spikes in the region (150-160 ppm), where are the characteristic chemical shifts for the C—O bond (6=158 ppm) and for the carbon in the triazole ring.

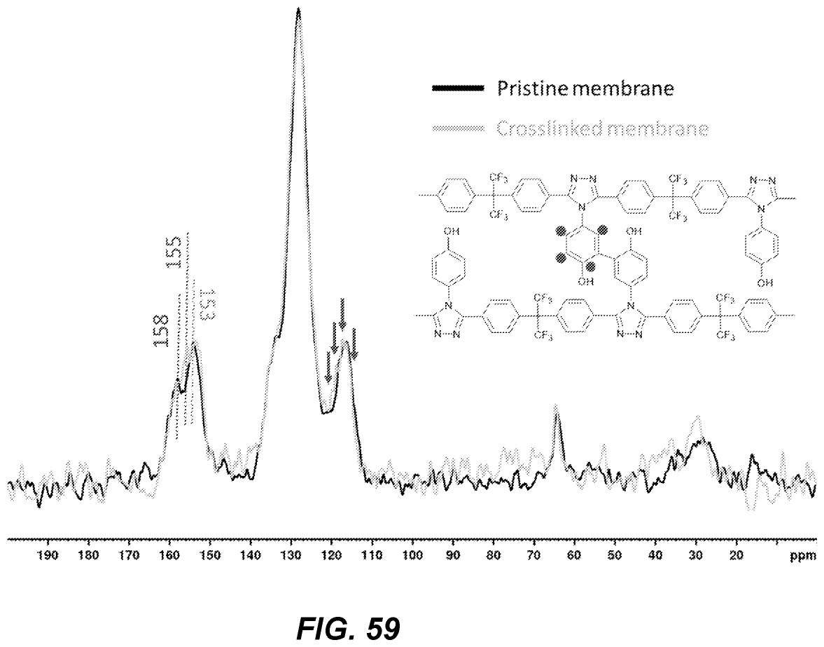

Additionally, a new peak appeared at 155 ppm (highlighted) in this region. Simultaneously, small new spikes become visible in the region (115-120 ppm (highlighted)) where the characteristic chemical shift for the aromatic carbons in the para position of the hydroxyl groups (FIG. 59). Thus, it can be reasonably assumed that the crosslinked network is initiated by forming phenoxy species that can be stabilized by resonance and activated one of the ortho positions. The phenoxy species are generated due to the thermal oxidative environment.

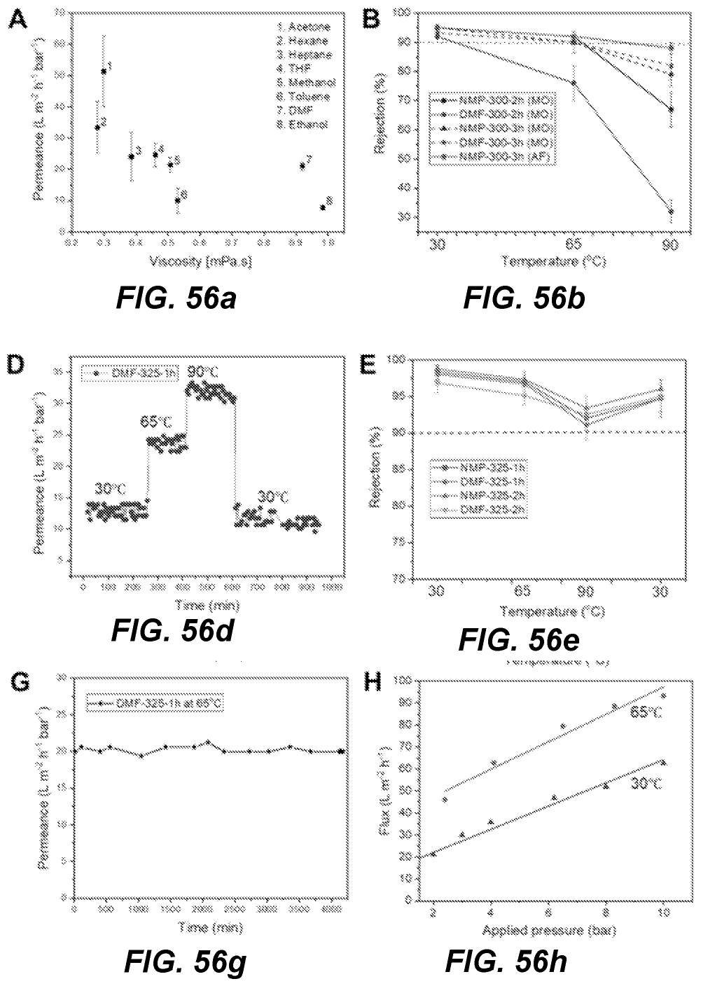

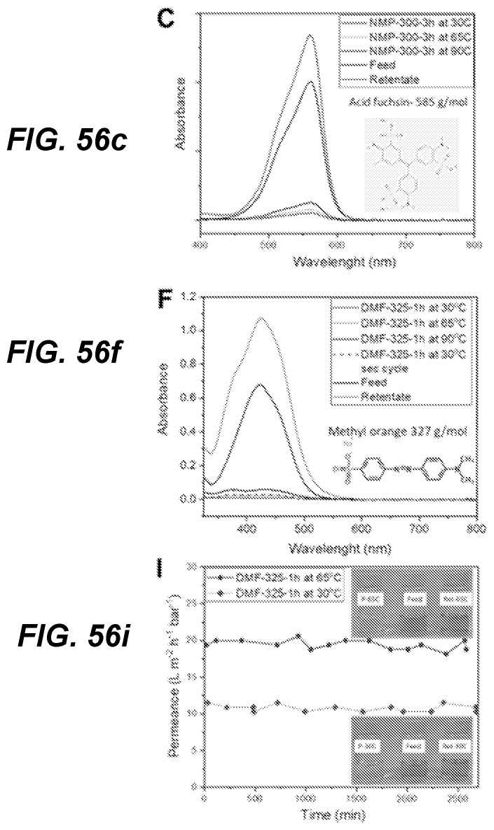

FIGS. 37d and 56a show the thermal stability for the pristine and the thermally treated membranes. The pristine membrane shows a small and constant decrease in weight in the range of 275-400° C., which we correlated with the crosslinked network formation. The weight loss for the pristine membrane in this interval is 4%, while for the crosslinked membranes, this weight loss decrease with increasing the thermal treated time or temperature (FIG. 37d). For the membranes treated at 300° C. for 1 h the weight loss is 2.5%, whereas for the membranes treated at 300° C. for 3 h and at 325° C. for 2 h are 1.7% and 1.5%, respectively, indicating that by treated the polytriazole membranes at these two conditions will obtain an almost similar crosslinking degree. To better insight into the crosslinking reaction, we investigate the thermal stability of a similar polytriazole but without OH groups (FIG. 58). The TGA data for this polytriazole do not present any significant weight loss in the range of 275-400° C., suggesting that the crosslinked network is formed due to the OH groups presence (FIGS. 37d and 58).

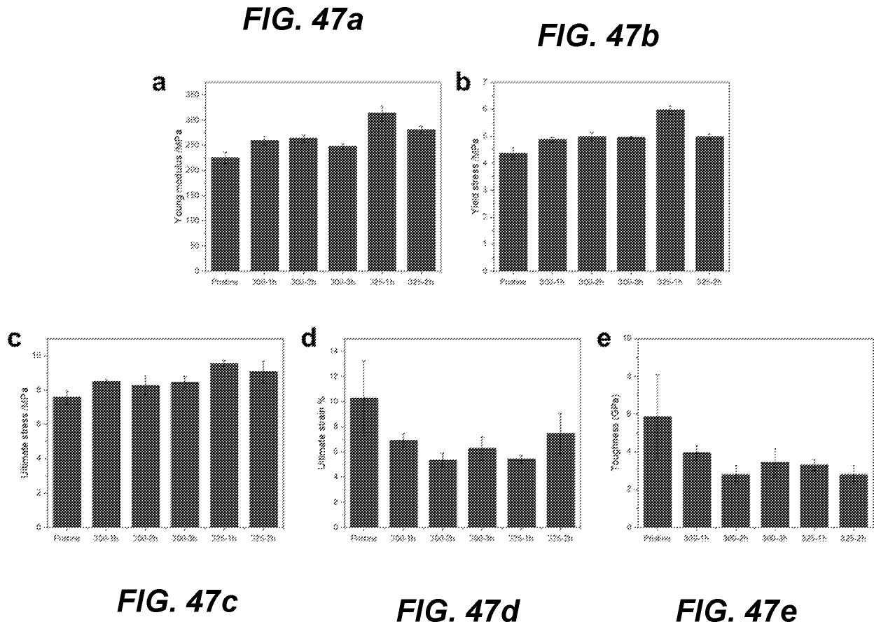

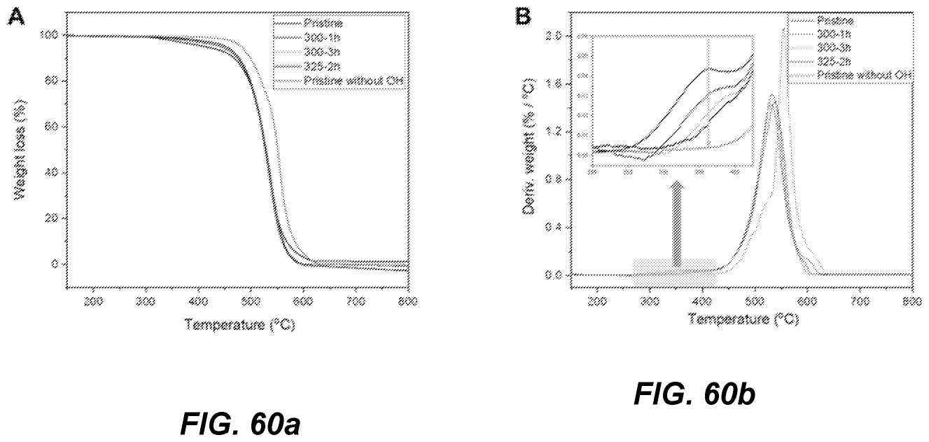

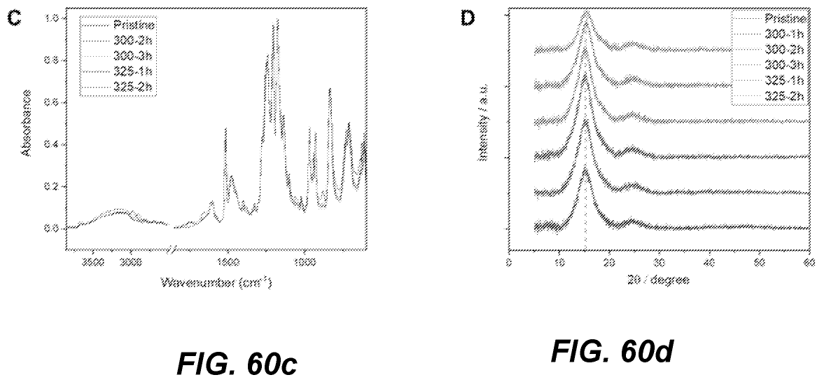

Moreover, to confirm that the crosslinking reaction involves only the presence of OH groups, we thermally treated the polytriazole without OH groups at 325° C. for 2 h and the sample was immersed in the tetrahydrofuran, which is the good solvent for this polymer. The membrane dissolved, indicating that it is not forming a crosslinked network (FIG. 58). The FTIR data are consistent with the NMR and TGA, showing that the treated membranes spectra are almost overlapping with the pristine membrane, without any additional characteristics band (FIG. 60). After thermally crosslinking, the membranes maintain the flexibility and have the capability to recover, the initial shape even after was immersing in DMF (FIG. 37c). This is an essential aspect for pressure-driven membrane applications to assure that the plastic deformation would be minimal at high-applied pressure and the membrane performance would maintain for a long time. To quantify the mechanical properties we used Dynamic mechanical analysis. Tensile strength and Young's modulus were determined from stress-strain experiments. All the membranes exhibit similar stress-strain behavior, with higher values of stress and Young modulus for the crosslinked membranes compared with the pristine one (FIG. 47). The creep recovery measurement was used to evaluate the membranes physical aging, which correlates with the compaction and their viscoelastic and mechanical properties (FIG. 37e). The crosslinked membranes have less pronounced creep, which implies that the network formation restricts the polymer chains molecular mobility and improves membranes deformation resistance. Therefore, the crosslinked polytriazole membranes will have a low plasticization or deformability in harsh conditions, such as temperature or organic solvents.

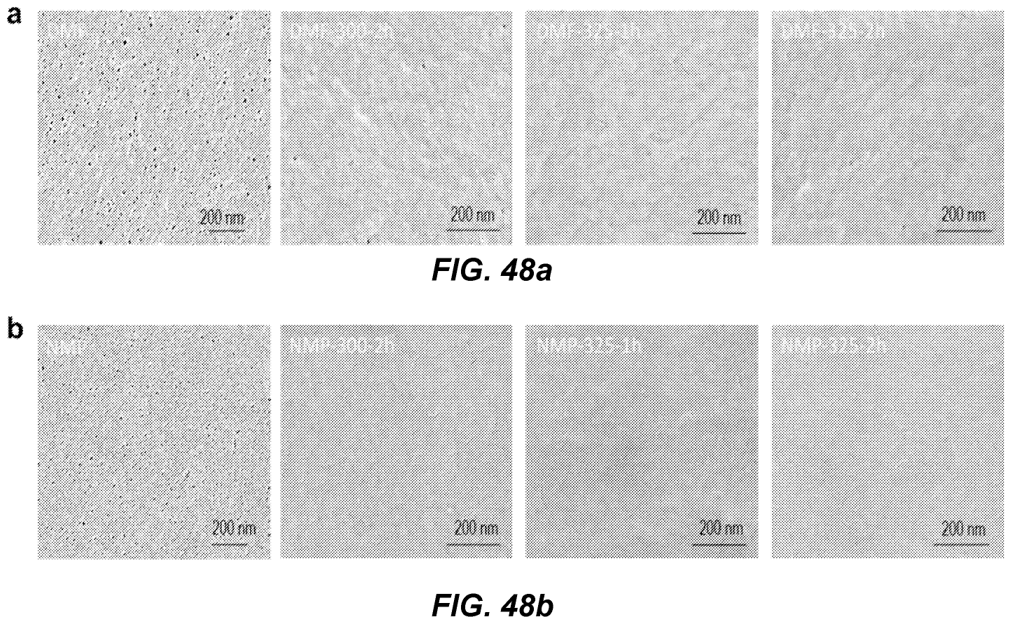

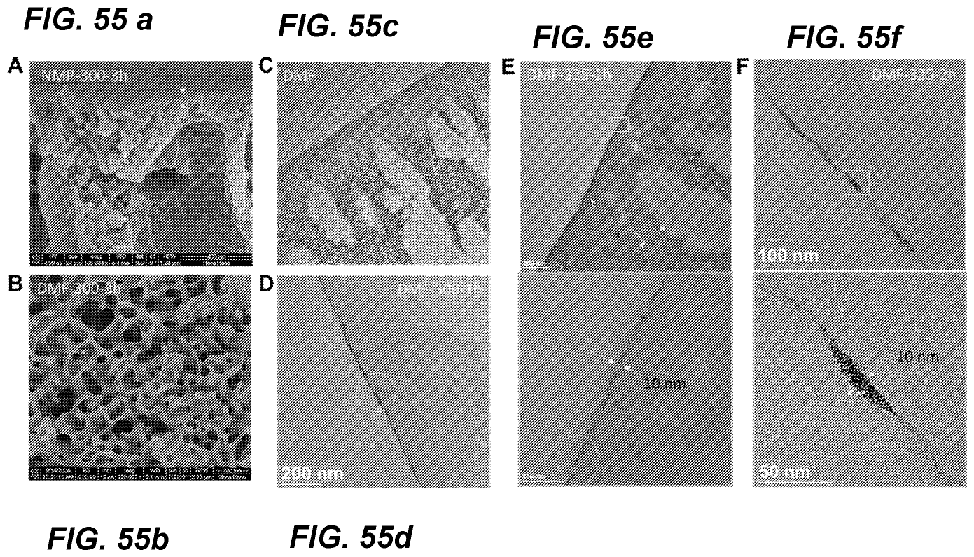

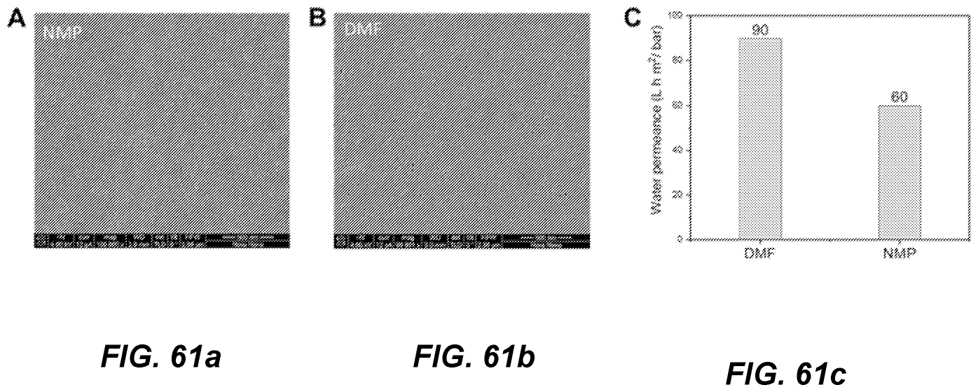

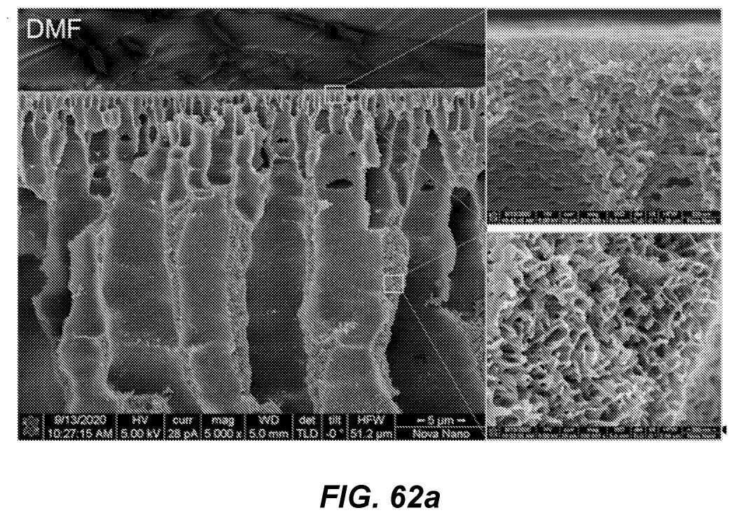

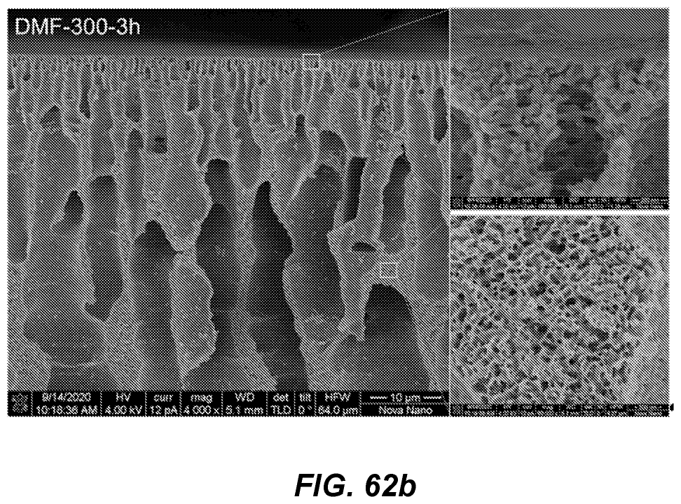

Scanning Electron Microscopy (SEM) was used to investigate the morphology of the pristine and the crosslinked membranes (e.g., FIG. 62). The surface of the pristine membranes is smooth with high pore density and better-distributed pores for both solvents, but in the case of using NMP, the pores size is smaller and more homogenous size than for the membranes obtain using DMF (FIG. 61a-b). This observation is confirmed by the water permeance values, which are higher for the membranes prepare by DMF (90 L h m² bar⁻¹) compared with the membranes prepare by NMP (60 L h m² bar⁻¹) (FIG. 61c). SEM reveal that after thermal treatment, the surface pores were merged and leads to a dense layer formation (FIG. 55a-b). Small defects were observed for the membrane prepared from DMF and treated at 300 for 2 h (DMF-300-2 h) (FIG. 48). The cross-section images confirm the formation of the dense layer. Moreover, it observed that right below the dense layer, the porous structure was retained: below the surface are formed short “wormlike nanochannels” (FIG. 55a), while in the finger-like wall, a hierarchical morphology is induced (FIG. 55b).

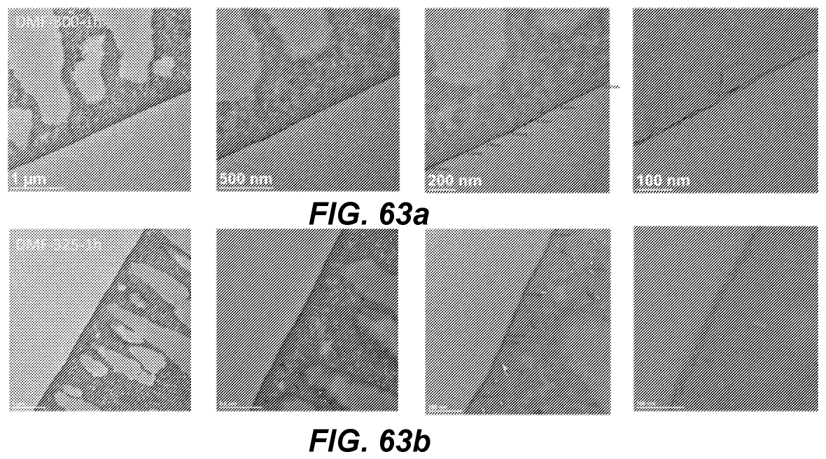

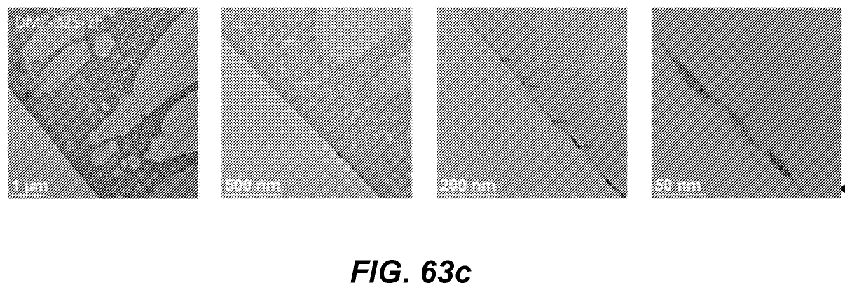

Transmission electron microscopy (TEM) was used to gain insight into the formation of the ultrathin layer (e.g., FIG. 63). The merging of the pores into the denser structure is proved by the thin and darker area at the surface, which is associated with the preferential staining of Ruthenium on a tighter morphology, compared with the pristine membranes (FIG. 55c,e).

FIG. 55d indicates that by heating to 300° C. for 1 h the thickness of the layer varieties from 2.6 to 12 nm and the pores are in the process of merging into the denser structure. When crosslinking reaction was performed at 325° C. for 1 h the layer has a homogenous thickness of 10 nm, with the tendency of forming undulatory morphology connected with twisting nods (FIG. 55e). Interestingly, by increasing the crosslinking time to 2 h the undulatory morphology is transformed to a fusiform structure with a maximum width of 10 nm, connecting each other through 5 nm string. In addition, TEM confirmed that under the ultrathin layer, an interconnected network of short “wormlike nanochannels” is obtained (FIG. 55e) Therefore, it is assumed that the formation of this structure and the resistance to collapse under the thermal treatment are correlated with the preexisted 7-7 orientation of the polytriazole (FIG. 60) and the intrinsic mechanical properties and the rearrangement of the polymer chains during the crosslinking.

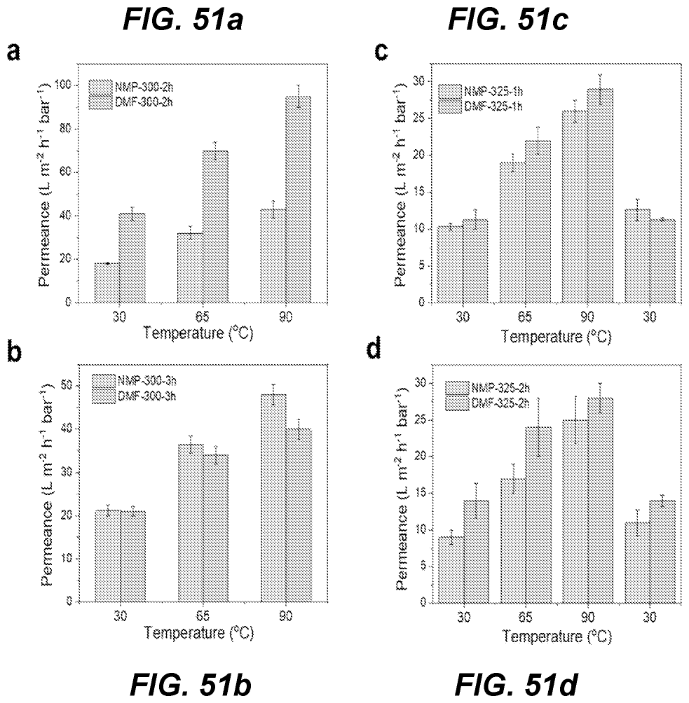

The membrane performances in various polar and non-polar organic solvents was evaluated. FIG. 56a shows the permeance values vs. viscosity of different solvents for the membrane DMF-300-3 h. The solvents with the lowest viscosity (acetone and hexane) have the highest permeance. In contrast, solvents such as heptane, methanol, tetrahydrofuran, and DMF have similar permeances, although they have different viscosity and polarity. Therefore, we investigated the influence of the thermally treated conditions on the performance of the membranes by testing the separation of methyl orange (MO, Mw=327 g/mol) and acid fuchsin (AF, Mw=585 g/mol) in a strong polar solvent (DMF), from room temperature to high temperature. FIG. 51 shows the DMF permeance tested from 30° C. to 90° C. for the polytriazole membranes treated at 300° C. for 2 h (NMP-300-2 h and DMF-300-2 h) and 3 h (NMP-300-3 h and DMF-300-3 h), during the MO separation. The DMF permeance increases with increasing the filtration temperature, showing almost 2 times higher values by filtrating at 65° C. than at 30° C., while from 65° C. to 90° C. the increase is 1.3 times. This behavior can be correlated with the decrease of DMF viscosity by increasing the filtration temperature and the molecular mobility of the polymer backbone, which can enhance the solvent molecule transport, as reported elsewhere. The molecular weight cut-off (MWCO) of the NMP-300-2 h and DMF-300-2 h membranes at 30° C. are higher than 90%, whereas at 65° C., only the NMP-300-2 h membrane maintained a MO rejection higher than 90% (FIG. 56b). The difference in rejection can be correlated with the small defects observed on the surface morphology of the DMF-300-2 h (FIG. 48) The DMF permeances of the membranes treated at 300° C. for 3 h (NMP-300-3 h and DMF-300-3 h) are similar at 30° C. (20 L m⁻² h⁻¹ bar¹), while by increasing the filtration temperature, slightly higher values were observed for the NMP-300-3 h reaching 48 L m⁻² h⁻¹ bar¹ at 90° C. filtration. This suggests that by using this thermal treatment condition, the casting solvent is no longer one of the main parameters that may affect the performance of the membrane, and the heating conditions play a more critical role. The DMF permeances obtained for the membranes treated at 300° C. for 3 h are at least 20 times higher than the values reported for state of the art integrally asymmetric membranes at high temperature. The results show solvents permeances and the rejection are comparable or even higher than the state of the art thin-film composite membranes. The MO rejection of the membranes treated at 300° C. for 3 h was considerably improved, showing higher than 90% when filtrating at 30° C. and 65° C., indicating that most of the pores at these crosslinked conditions merged and for a denser thin layer (FIG. 56b). A slightly lower MO rejection was obtained at 90° C. However, by replacing the MO with AF as a solute molecule, the membranes can maintain the MWCO close to 90% at 90° C. (FIGS. 56b,c). Thus, thermal treatment of the polytriazole membranes to 300° C. for 3 h resulted in an MWCO of 585 g/mol for all the filtration temperature range.

To achieve an MWCO higher than 90% also for MO for all range of temperatures, the membranes were treated at 325° C. for 1 h and 2 h (FIG. 56e). The DMF permeances for these membranes are lower than for the membrane treated at 300° C., but still almost 10 times higher than the previously reported integrally asymmetric membranes (FIG. 51). These membranes did not show any significant physical aging and compaction when we permeated pure DMF at 65° C. for 72 h, which demonstrates a good correlation with the creep-recovery measurements (FIG. 56g). The robustness of the polytriazole membranes was confirmed by measuring the DMF flux at 65° C. and 30° C. by varying pressure from 2 to 10 bar (FIG. 56h). The good linearity obtained for both temperatures indicates that the polytriazole membranes have a constant permeable area, which does not collapse under increasing pressure. In addition, to show that this system is also maintained the separation performances, the membranes were subjected to a filtration cycle. FIGS. 56d,f F show that after a full cycle, the permeance and rejection at 30° C. are in the same range. Moreover, the MO rejection was evaluated by first measuring at 65° C. and then at 30° C. for 48 h. The separation was preserved, and the permeance was constant during the experiment (FIG. 56i).

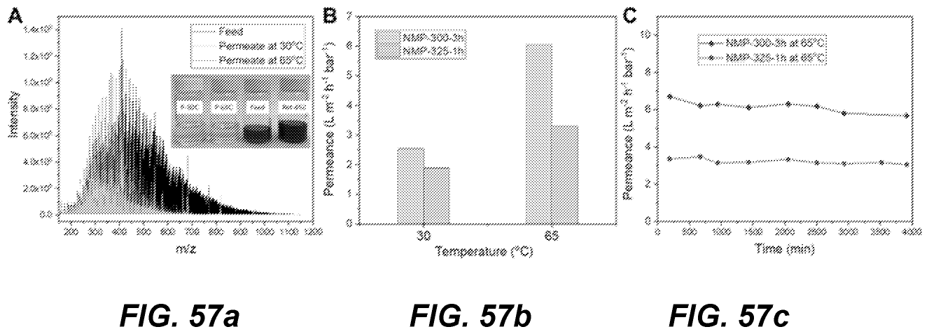

Considering that, the polytriazole membranes show good performance in the presence of solvents with different viscosities and polarities, these membranes were also challenged with a complex hydrocarbon mixture, such as Arabian light crude oil. Electrospray ionization Fourier transform ion cyclotron resonance mass spectrometry (ESI FT-ICR MS) was used to elucidate the separation. FIG. 57a shows the FT-ICR MS distribution of the different mass compounds in the feed and permeates at 30° C. and 65° C. obtained using NMP-300-3 h membrane.

The membrane can selectively separate compounds with molecular weight lower than 500 g mol⁻¹, although we are filtrating at 30° C. and 65° C. Simultaneously, on the permeates side, the smaller molecular weight molecules concentration increased, demonstrating that this membrane can discriminate among the crude oil multiple components. The inset image shows the crude oil, the colorless permeates at 30° C. and 65° C., and the retentate intense dark color, proving the polytriazole membrane capability to remove high molecular weight components. The permeances during crude oil separation of the membranes are in the range of 1.9-2.5 L m⁻² h⁻¹ bar⁻¹ at 30° C., whereas at 65° C., the permeances are in the range of 3.3-6 L m⁻² h⁻¹ bar⁻¹ (FIG. 57b). The values are between 10 to 300 times higher than the recently reported series of PIM-like polymers, which have been reported to show enrichment in the permeate of molecules with a molecular weight around 170 g mol⁻¹. In addition, when we permeate the crude oil mixture for 72 h through the membrane, no significant decrease in permeance was observed (FIG. 57c).

### Conclusion

Therefore, the results reported here show that it is possible to obtain a promising membrane for one of the most chemical-separation challenges: fractionation of crude oil by the rational selection of polymer structure and combination with the classical phase inversion method and thermal crosslinking. The tunable selectivity and permeances of the ultrathin polytriazole layer make these membranes suitable to be integrated into a cascade system for a specific range of hydrocarbons separation. The stability of the crosslinked polytriazole membranes in a wide range of solvents, concentrated acids, and base paves the way for new chemical separations using membranes.

### Example 4

This Example describes a versatile strategy to fabricate polytriazole membranes with 10 nm thin selective layers containing subnanometer channels for the separation of hydrocarbons. The process involves the use of the classical non-solvent induced phase separation (NIPS) method and thermal crosslinking. The fabrication process and the thermal stability of the membranes allow us to tune the selectivity of the layer at the lower end of the typical nanofiltration range (200 to 1000 g mol⁻¹). The polytriazole membrane can enrich up to 80-95% of the hydrocarbons content with carbon numbers below C₁₀ (140 g mol⁻¹). In addition, these membranes preferentially separate paraffin over olefin components, making them suitable for integration in hybrid distillation systems for crude oil fractionation.

### Introduction

Separation processes are essential in the chemical, pharmaceutical, and petrochemical industries and are widely used to purify solvents and chemicals, solvent exchanges, catalyst recycle and recovery. Conventional separation techniques such as distillation, adsorption, evaporation, and extraction are normally used, which have high carbon footprints and are energy-intensive. These separations represent up to 40-70% of both capital and operating costs. Alternative processes and strategies to streamline the separations are needed.

Membrane technology is considered sustainable due to its low carbon footprint, small spatial requirements, and a lack of phase transition in most cases. Organic solvent nanofiltration (OSN) could more broadly replace traditional separation processes if better membranes address the requirements of chemical, pharmaceutical, and petrochemical processes. For that, the membranes should combine easy processability with stability in a wide range of organic solvents and pH. They should be mechanically and thermally stable to reduce the physical aging since many processes in the chemical, pharmaceutical, and petrochemical separations take place at 60-90° C. or even higher temperature ranges. Although inorganic materials might have higher thermal and solvent stability, they have limitations, such as high cost, low mechanical properties, and difficult scale-up.

Polymeric membranes are less expensive than most inorganic ones, easy to process and integrate in large-scale modules. However, only a few classes of polymeric materials, such as poly(dimethylsiloxane) and polyimide, are being used industrially for nanofiltration of non-aqueous solutions. Polybenzimidazole, poly(ether ketone), and polymers with intrinsic microporosity (PIM)) are under evaluation by different groups. Swelling effects, when exposed to harsh environments, affect the separation performance in many cases. Recently, a new series of PIM-like polymers was reported that show attractive crude oil separations—a challenging separation. More materials are needed to handle the industrial conditions and successfully separate complex mixtures. Overcoming the permeability and selectivity trade-off, particularly in industries like crude oil refining without considerable membrane aging is a difficult task.

### Experimental

### Materials

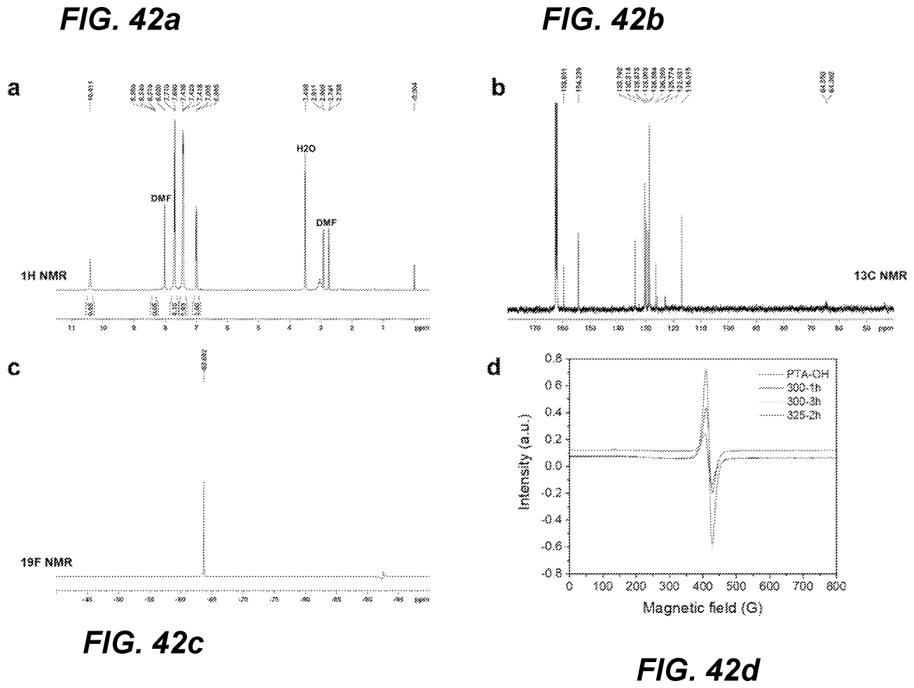

N-Methyl-2-pyrrolidone (NMP), N,N′-dimethylformamide (DMF) (99.8%), and all other reagents were procured from Aldrich. The polytriazoles with hydroxyl groups (PTA-OH) and without hydroxyl groups (PTA) were synthesized by polycondensation reaction. The successful synthesize of the polytriazoles was confirmed by NMR (FIGS. 42a-d and 44a-d). All chemicals were used as received.

### Membrane Preparation

The polytriazole membranes were prepared by non-solvent-induced phase separation (NIPS). 16 wt % polytriazole solutions in N-methyl-2-pyrrolidone (NMP) or N,N′-dimethylformamide (DMF) were cast on a glass plate using a doctor blade with 200 μm gap. The polymer membranes were obtained by immersing the glass plate into a distillate water bath. The membranes were washed with distillate water for 72 h to eliminate any remaining solvent and freeze-dried. To crosslink the polytriazole membranes by thermal treatment, we used a Lindberg/Blue M™ 1200° C. Split-Hinge Tube Furnaces. The furnace heating rate was set at 5° C. per minute. The obtained integrally-skinned asymmetric membranes were thermally treated in the furnace under an air atmosphere at 120° C. for 30 min before continuing the treatment to 300° C. for 1 h, 2 h and 3 h, and to 325° C. for 1 h and 2 h.

### Characterization

The chemical changes during thermal treatment were evaluated by Fourier Transform Infrared (FTIR) spectroscopy using a Nicolet 6700 FT-IR System. The FTIR spectra were recorded by performing 16 scans with a spectral resolution of 4 cm⁻¹.

Solid-State Nuclear Magnetic Resonance Spectroscopy was used to investigate the chemistry of the membrane that occurred during thermal treatment. One-dimensional ¹H MAS and ¹³C CP/MAS solid-state NMR spectra were recorded on Bruker AVANCE III spectrometers operating at 400 and/or 600 MHz resonance frequencies for ¹H. The chemical shifts were calibrated using the external references TMS and adamantane. The 2D ¹H-¹³C heteronuclear correlation (HETCOR) solid-state NMR spectroscopy experiments were conducted on a Bruker AVANCE III spectrometer using a 2.5 mm MAS probe. Detailed information regarding the solid-state NMR experiments is available in previous reports.

The membranes thermal stability was investigated by thermogravimetric analysis (TGA) on a TGA Q50 by TA instrument in a nitrogen atmosphere from 25 to 800° C., with a heating rate of between 1 to 10° C. min⁻¹. TGA was also used for preparing the samples treated at 300° C., 325° C., and 350° C. in a nitrogen atmosphere for a different time.

The glass transition temperature (Tg) of the polytriazole with OH was investigated by differential scanning calorimetry (DSC) on TA DSC250 instrument, with a heating rate of 10° C. min⁻¹.

The pristine and thermally treated membrane morphologies were studied by Scanning Electron Microscopy (SEM) on a Nova Nano microscope, using a 3-5 kV voltage and a working distance of 3-5 mm. The morphology was also studied by Transmission Electron Microscopy (TEM). Initially, the films were embedded in Epoxy resin at 60° C., and then ultrathin sections (70 nm) were cut using an ultramicrotome (Leica EM UC6). The membranes were imaged on a Titan CT (FEI company) microscope operating at 300 kV after they were stained with Ruthenium.

Mechanical measurements were performed on a TA Instruments Q850 Dynamic Mechanical Analyzer in tensile mode. Rectangular samples (15×5 mm) were cut from the membranes with 70-80 μm thickness. The stress-strain behavior was recorded using a force ramp of 0.1 N/m, at 25° C., until break. Five samples were tested for each membrane. The ultimate tensile properties are calculated as the average of stress and strain at break. Strain-recovery analysis was performed by subjecting membranes to a stress of 1 MPa for 20 min, followed by a recovery period of 80 min with removed stress. The applied stress level was chosen to ensure that the creep measurements remained in the linear viscoelastic deformation regime of stress-strain curves and it matches the 5 bar pressure used for flux measurements.

A small preload force of 0.01 N was applied to keep the sample right in the recovery regime.

The crystallinity and the d-spacing of the membranes were investigated using a Bruker D8 Advance diffractometer with Cu-Kα radiation source at 40 kV and 40 mV. The diffraction data were measured in the range of 5°-60°.

The membranes' performances were investigating in a dead-end cell, using a membrane area of 0.95 cm² and at pressures between 2 to 5 bar. The water permeance measurements of the membranes prepared in DMF and NMP were performed at room temperature. The solvent permeance was evaluated using equation 1:

$$J = \frac{Q}{A Δ P} \qquad ( 1 )$$

where Q is the permeation rate (L h⁻¹), A is the active filtration area (m²), and ΔP is the pressure (bar).

The molecular weight cutoff of these membranes was studied using a mixture of poly(ethylene glycol) (400, 1500, 10000, and 35000 g mol⁻¹) in water. The experiments were carried out at a pressure of 5 bar.

The performances in various polar and non-polar organic solvents were evaluated at room temperature using 3 different membranes. The solvents were tested consecutively following the sequence: methanol, ethanol, acetone, hexane, heptane, toluene, and tetrahydrofuran.

The thermal-treated membranes' performances in DMF were consecutively measured at different temperatures, from 30 to 90° C. Before the measurements, the membranes were immersed in DMF for 30 minutes and then transferred in water before being mounted in the filtration cell. The membranes' performances were reported as an average of 3 different measurements. The long-time stability in DMF was performed by direct heating the dead-end cell at 65° C. The permeances were measured for approximately 67 h. The DMF flux at 30 and 65° C. as a function of pressure was measured by consecutively increase the pressure from 2 to 10 bar. For each pressure, the flux was measured for at least 2 h.

The rejection in DMF was investigated by filtrating methyl orange (MO, Mw=327 g mol⁻¹) and acid fuchsin (AF, Mw=585 g mol⁻¹). The concentration of the dyes in DMF was between 10 to 50 ppm. The rejection experiments were performed between 2 h and 4 h before collecting the samples for analysis. The rejection (R) was evaluated using equation 2:

$$R ( \% ) = ( 1 - \frac{{C}_{p}}{{C}_{f}} ) \times 100 \qquad ( 2 )$$

where Cp is the solute concentration in the permeates, and C_{f} is the solute concentrations in the feed. UV spectrometer (NanoDrop 2000c) was used to evaluate the separation of the dye molecules.

The hydrocarbon rejection using binary mixture was investigated by dissolving hexaphenylbenzene (Mw=534.7 g mol⁻¹) in toluene at a concentration of 100 ppm. UV spectrometer (NanoDrop 2000c) and equation 2 were used to evaluate the separation. For measuring multi-components rejection, methylnaphthalene, 1,3-diisopropylbenzene, and pristane were dissolved in toluene in a ratio of 1/99 mol % of hydrocarbons/toluene. Gas chromatography was used to test the separation performance. The binary and multicomponent mixture experiments were carried out at 30° C. The fractionation of dilute crude oil was investigated by consecutively heating at 30 and 65° C. The Arabian extra light crude oil was diluted in toluene in a volume ratio of 1:40. To measure the permeance during the experiments, we collected samples at different intervals (4 h to 10 h). The feed and the permeances were studied using FT-ICR MS. The filtration experiments with pure Arabian super light crude oil were performed at 90° C. and at 15 bar. Different fractions were collected every two days. For the experiments with crude oil, vials with rubber septum were connected to the permeate side tube to diminish the evaporation of the lighter components from the permeance. The building pressure within the vials was equalized by the aid of a needle. The permeances obtained from pure Arabian super light crude oil were investigated using the GC. To identify the components in the permeates a standardized C₇-C₄₀ saturated alkanes solution in hexane was used. The enrichment of the hydrocarbons in the permeance was calculated by integrating the GS peaks below C₁₀, in the range of C₁₀-C₁₅ and C₁₅-C₂₀, and higher than C₂₀.

### Results and Discussion

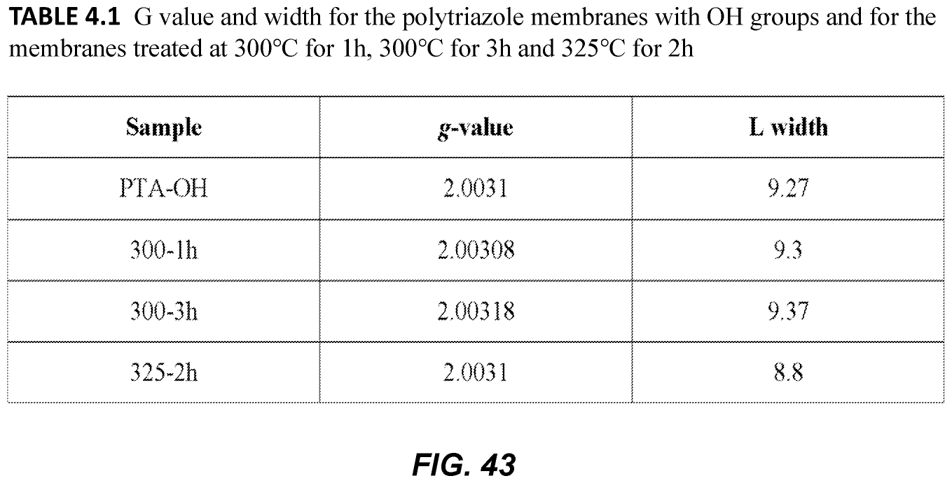

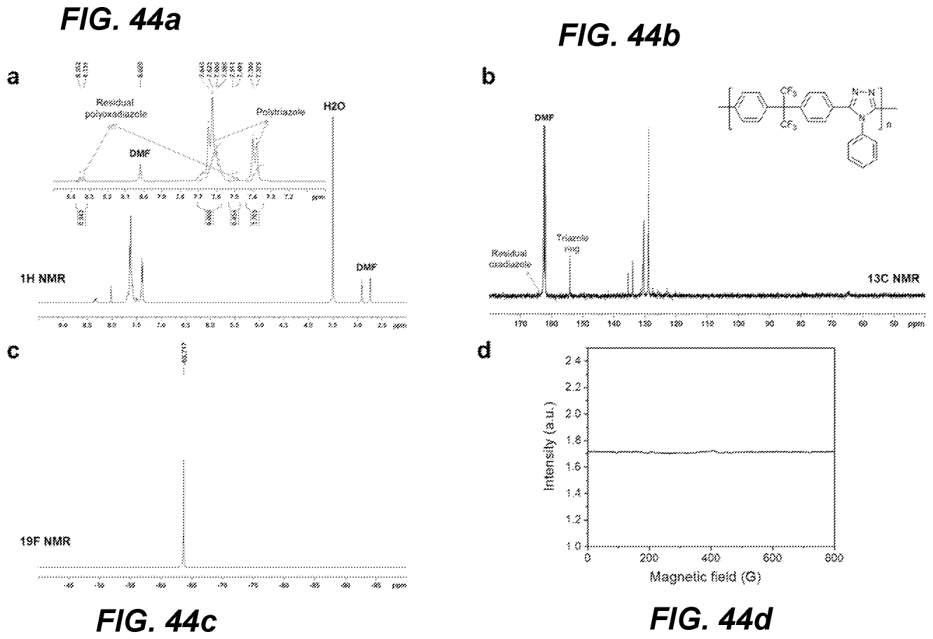

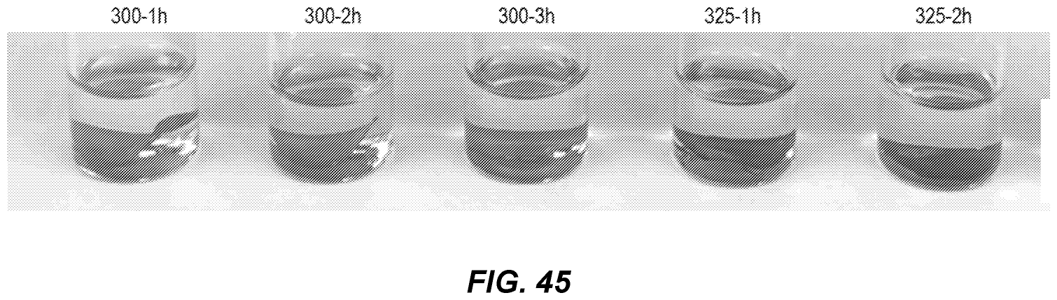

Here, a simple strategy to fabricate polytriazole asymmetric membranes with ultrathin selective layers by combining the classical non-solvent induced phase separation (NIPS) method and thermal crosslinking is demonstrated. The resulting membranes were exposed to high-boiling polar aprotic solvents like DMF, which are used to extract aromatic fractions from refinery streams and separate complex mixtures like those present in crude oil. Polytriazole with pendant hydroxyl (OH) groups (FIGS. 37 and 42) was used because it can easily be synthesized in large amounts with good mechanical properties and has a high thermal and thermal-oxidative stability. Additionally, the pendant OH groups make this polymer versatile in terms of crosslinking or modification. The membrane formation first involves the dissolution of the polytriazole polymer in two solvents (N-methyl-2-pyrrolidone (NMP) or N,N′-dimethylformamide (DMF)), followed by solution casting and immersion in water. To induce the crosslinked reaction, we simply treated the polytriazole membranes at 300° C. for 1 h, 2 h and 3 h, and to 325° C. for 1 h and 2 h, respectively, in a furnace under an air environment. The resulting crosslinked membranes are stable in strong solvents, such DMF, in strong acids (hydrochloric acid 37% (HCl) and sulfuric acid 98% (H₂SO₄)), base (sodium hydroxide 2M (NaOH)), and are reasonably stable even in piranha solution (FIGS. 37a and 45). The crosslinking reaction was investigated by solid-state Nuclear Magnetic Resonance (SS-NMR). FIG. 37b shows the ¹³C cross-polarization magic-angle spinning (CP MAS) for a pristine PTA-OH membrane and the membrane treated at 325° C. for 2 h. The crosslinked membrane spectrum has a broad peak with small spikes in the region (150-160 ppm), corresponding to chemical shifts for the C—O bond (6=158 ppm) and the carbon in the triazole ring. Additionally, a new peak appeared at 155 ppm (highlighted with a purple arrow). Simultaneously, small new spikes (also highlighted in purple) become visible in the 115-120 ppm region, which is characteristic of aromatic carbons in the para position to the hydroxyl groups. To better understand the crosslinking reaction mechanism, electron paramagnetic resonance (EPR) spectroscopy was used. The pristine PTA-OH shows the presence of the unpaired electron, exhibiting Lorentzian EPR line centering at g=2.0031 (FIGS. 42b and 43 (Table 4.1)). For comparison, a similar polytriazole without OH groups did not present the unpaired electrons (FIG. 44a-d). In addition, for thermally treated PTA-OH membranes, the g values are in the same range, while the line width for the membranes treated at 325° C. is slightly lower compared to pristine PTA-OH and membranes treated at 300° C. for 1 h and 3 h (FIG. 43).

It can be assumed that the crosslinked network is connected with the presence of delocalized unpaired electrons on the pristine PTA-OH, which probably by heating in the oxidative environment will lead to the formation of phenoxy species. FIG. 37b shows a possible crosslinked structure. However, since the crosslinking reaction occurred in the oxidative atmosphere at temperatures higher than 300° C., other interactions might be possible.

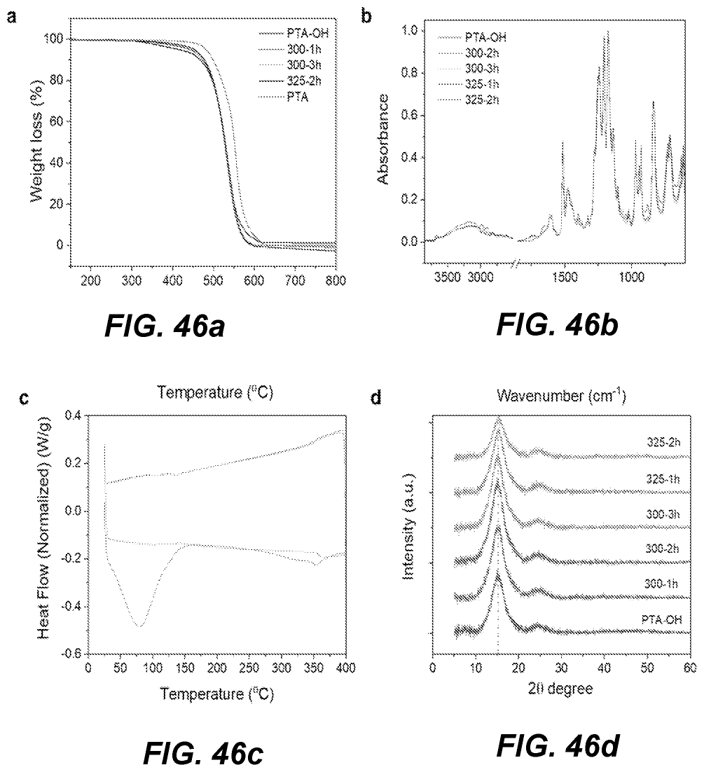

FIGS. 37c and 46a indicate the thermal stability for the pristine and the thermally treated membranes. The thermogram of the pristine membrane shows a slight and constant decrease of weight in the range of 275-400° C., which we correlated with the crosslinked network formation. The weight loss of the pristine membrane in this interval was 4%, while in the case of the crosslinked membranes, this weight loss decreased as the thermal treatment time and temperature increased (FIG. 37c). For the membranes treated at 300° C. for 1 h, the weight loss was 2.5%. In contrast, for the membranes treated at 300° C. for 3 h and at 325° C. for 2 h, the losses were 1.7% and 1.5%, respectively, indicating that by treating the polytriazole membranes at these two conditions, similar crosslinking degrees are obtained. The thermograms of the polytriazole without OH groups did not show any significant weight loss in the range of 275-400° C., indicating that any reaction in this temperature range could be related to the OH groups (FIGS. 37c and 46a). To confirm that the crosslinking reaction occurs through the OH groups, a film of polytriazole without OH was thermally treated at 325° C. for 2 h, followed by immersion in tetrahydrofuran, which is a good solvent for this polymer. The membrane dissolved, indicating that no crosslinked network is formed.

The FTIR data of thermally treated hydroxyl-polytriazole was almost coincident with the pristine one. No additional peaks appeared; a slight decrease in the intensity of the broad peak characteristic to OH groups was observed (FIG. 46b). After thermally crosslinking, the membranes maintain flexibility and are stable in DMF (FIG. 37a). This is essential for pressure-driven membrane applications to ensure that the plastic deformation would be minimal at high-applied pressure, and the membrane performance would be maintained for a long time. The mechanical properties were quantitatively evaluated by dynamic mechanical analysis. The tensile strength and Young's modulus were measured from stress-strain experiments. All membranes exhibited similar stress-strain behavior, but the crosslinked ones have higher values of stress and Young modulus (FIG. 47). The creep recovery measurement was used to evaluate the membranes susceptibility to physical aging, which correlates with their compaction, viscoelastic and mechanical properties (FIG. 37d).

The crosslinked membranes have less pronounced creep, which implies that the network formation restricts the polymer chains molecular mobility and enhances the resistance of the membrane to deformation. Although this characterization was performed at dried conditions, we also expect a lower deformation of the crosslinked polytriazole membranes when immersed in an organic solvent.

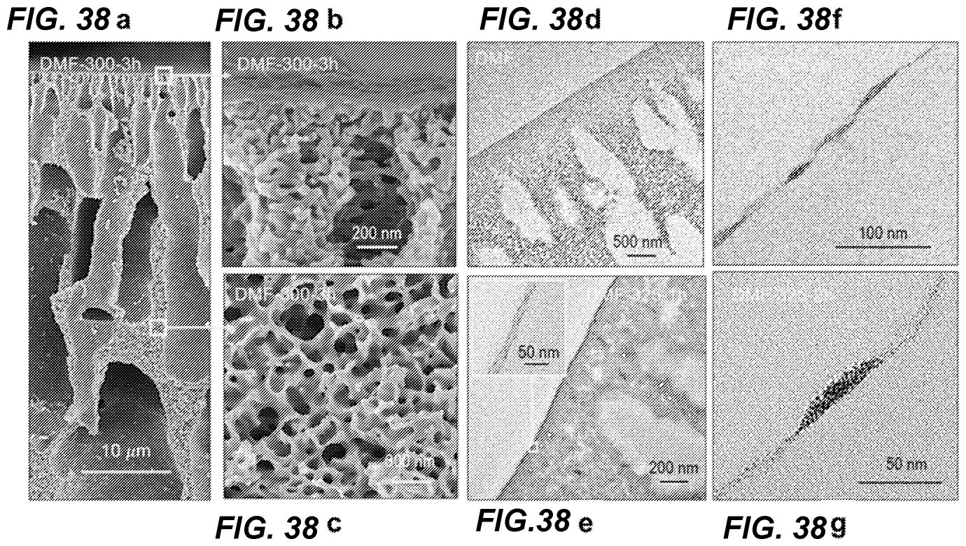

Scanning Electron Microscopy (SEM) was used to investigate the morphology of the pristine and the crosslinked membranes. Pristine membranes prepared by the NIPS process from casting solutions in NMP and DMF were compared. In both cases, the membranes have high pore density, but those prepared with NMP had slightly smaller pores (FIG. 48a-b). As a consequence, the water permeance is higher for the membranes prepared with DMF (90 L h m² bar⁻¹) compared with those using NMP (60 L h m² bar¹), while the molecular weight cutoff is 25 kg mol⁻¹ and 10 kg mol⁻¹, respectively. The SEM images reveal that after the thermal treatment, the pores merge, and a dense layer is formed (FIG. 38a-b). Small defects were observed only for the membrane prepared from DMF, treated at 300 for 2 h (DMF-300-2 h) (FIG. 48a). When treated at 325° C., the membranes were defect-free. The low magnification crosssection images reveal a typical morphology of asymmetric membranes prepared by the NIPS method, with a pore size gradient and finger-like cavities. At higher magnification, the images confirm that an ultrathin denser layer is formed at the surface (FIG. 38b). Right below this dense layer, the porous structure is retained with wormlike nanochannels. Open interconnected pores are also observed between finger-like cavities (FIG. 38c), providing low resistance to permeant transport. We assume that the resistance to collapse of the sublayer under the thermal treatment is correlated with the high glass transition (Tg) of the pristine polytriazole (Tg=>350° C., FIG. 46c), preexisted π-π orientation of the polytriazole (FIG. 46d), and the intrinsic mechanical properties and the rearrangement of the polymer chains during the crosslinking.

The thickness and details of the ultrathin dense layer could be better visualized by transmission electron microscopy (TEM). After slicing the membranes in an ultramicrotome, they were exposed to ruthenium oxide, which effectively stains aromatic moieties. FIG. 38d shows that the pristine membrane has a homogeneous electron density near the surface. As the membrane is thermally treated, a thin denser layer is clearly seen (FIG. 38e-g). When the thermal treatment was performed at 325° C. for 1 h, it obtained a 12 nm thick homogenous layer (FIG. 38e). Interestingly, by increasing the crosslinking time to 2 h, an undulatory morphology prevails with alternating blocks of maximum thickness of 14 nm, connected by 5 nm-thick ones. A nodular internal structure can then be seen and reflect the nanoporosity of the denser layer, with the brighter areas revealing channels or pores of 1 nm diameter.

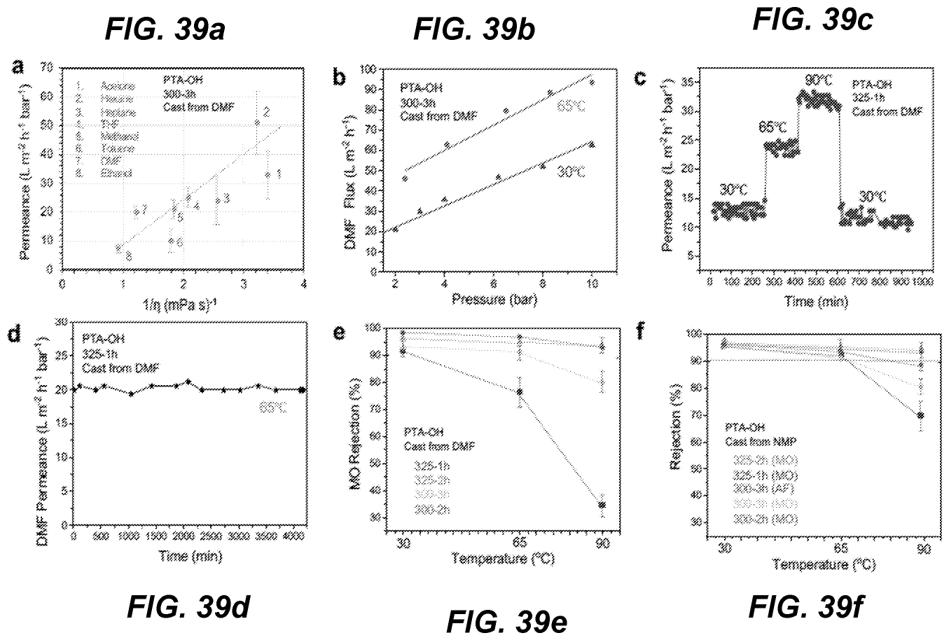

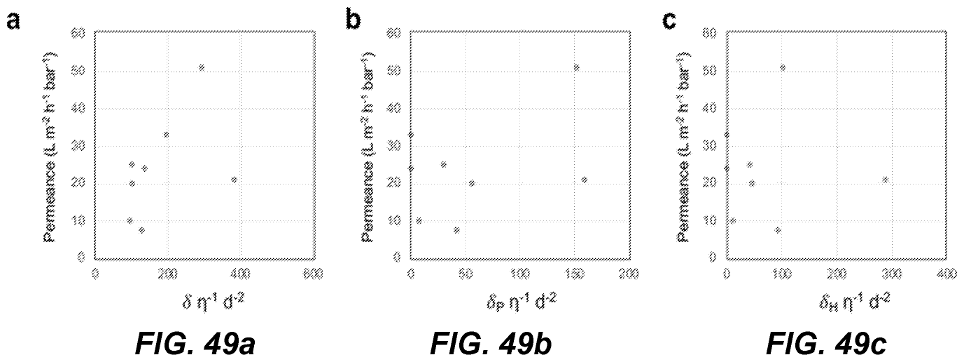

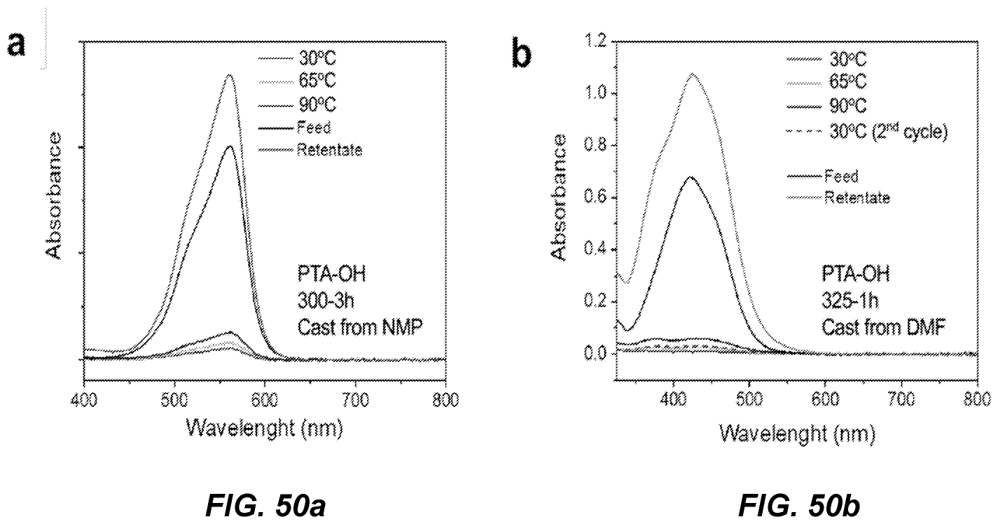

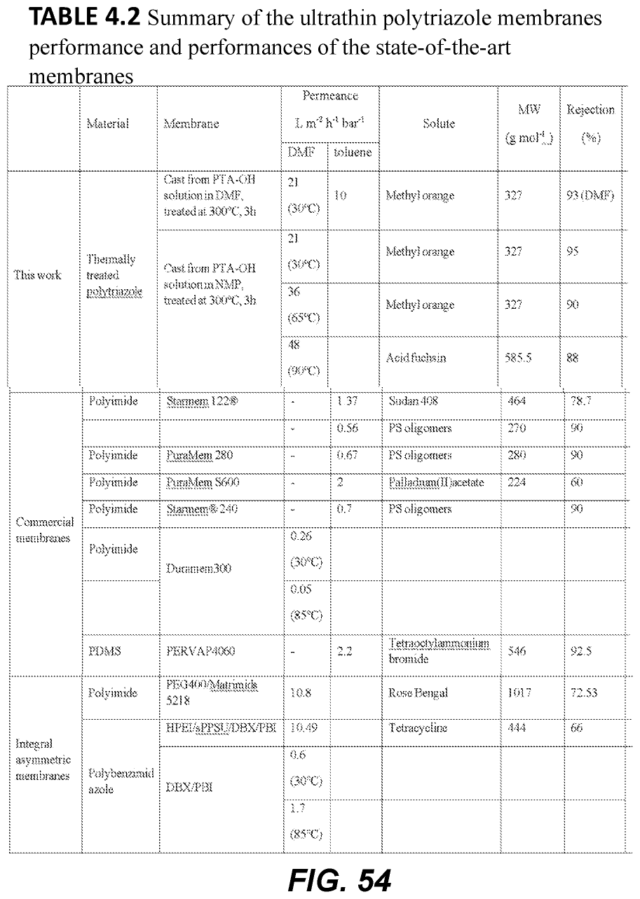

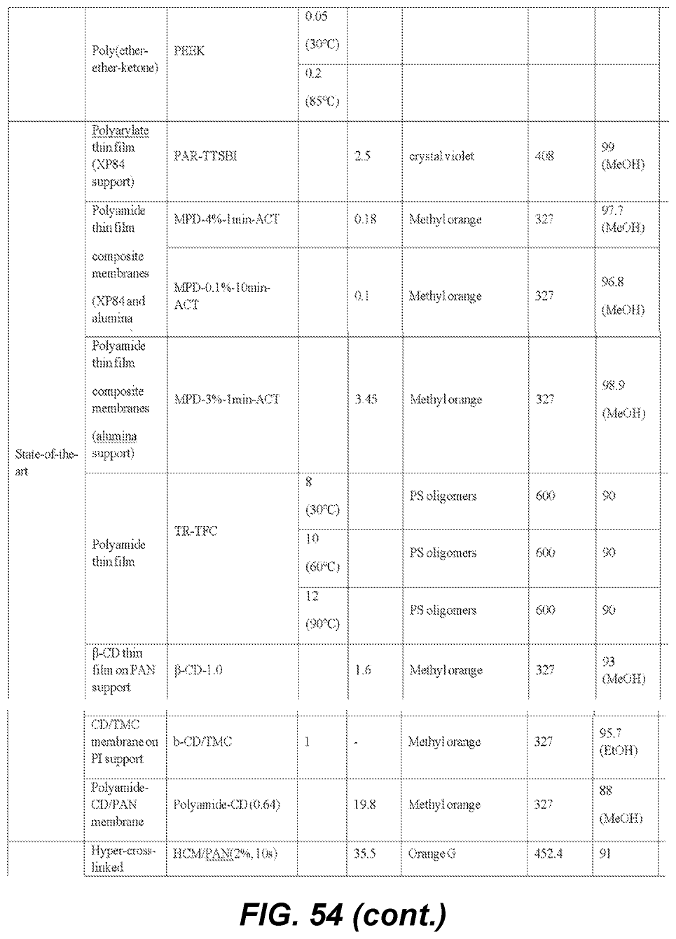

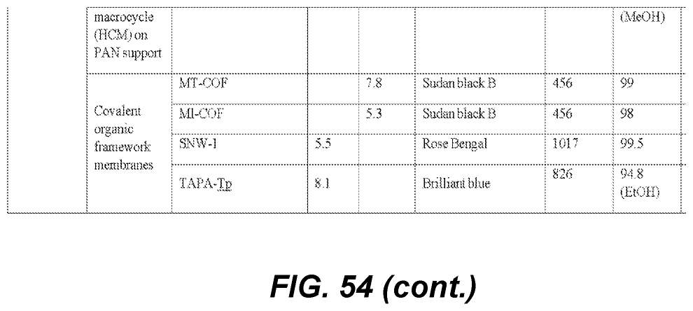

The membrane performances were evaluated in various polar and non-polar organic solvents. FIG. 39a shows the permeance values vs. inverse of viscosity of permeant solvents for membranes prepared from solutions in DMF and treated at 300° C. for 3 h, revealing a linear trend. Plots considering Hansen solubility parameters and molecular diameters (FIG. 49), which have fitted well other nanofiltration systems in the literature, led to a poor correlation. The better correlation in FIG. 39a indicates that the solvent transport follows Hagen-Poiseuille, and it is practically not driven by a solution-diffusion mechanism. The separation mechanism is therefore size-selective. The TEM image in FIG. 38g indicates the presence of fine pores. We investigated the influence of the thermally treated conditions on the permeance and selectivity of the membranes first by testing the separation of methyl orange (MO, Mw=327 g mol⁻¹) and acid fuchsin (AF, Mw=585 g mol⁻¹) in a highly polar solvent (DMF) (FIGS. 39e, 39f and 50). FIG. 39b shows linear plots of DMF flux as a function of pressure tested at 30 and 65° C. for a membrane cast from solutions in DMF and treated for 1 h at 325° C., demonstrating that no compaction takes place. Permeance tests at 30° C., 65° C., 90° C., and back to 30° C. are shown in FIG. 39c as an evidence that the membrane practically recovers the same performance and is not altered by the exposure to DMF at 90° C. Permeance measurements using MO solutions in DMF as feed are shown in FIG. 51. The DMF permeance increases with increasing the filtration temperature. The DMF viscosity is reported in the literature to decrease from 0.766 mPa s at 30° C. to 0.559, 0.510 and 0.470 mPa s, respectively at 60, 70 and 80° C. The permeance increase was almost 2-fold from 30 to 65° C., and even higher when performed at 90° C. The increase is, therefore, only in part due to the decrease of DMF viscosity. Without being bound by theory, an increase in the molecular mobility of the polymer backbone might enhance the solvent molecule transport, as recently reported for non-thermally treated membranes. A similar trend was observed for poly(ether-ether-ketone) and polybenzimidazole membranes when the temperature was increased from 30° C. to 85° C. The MO rejections of membranes cast from solution in NMP and DMF, treated at 300° C. for 2 h, and tested at 30° C. were higher than 90%, whereas when tested at 65° C., only the membrane prepared from NMP casting solutions, treated at 300° C. for 2 h maintained a MO rejection higher than 90% (FIG. 39f). The difference in rejection can be due to the small pin-holes imaged for the membrane cast from DMF solutions and treated at 300° C. for 2 h (FIG. 48). The DMF permeances of the membranes treated at the same temperature, but during 3 h does not depend anymore on the casting solvent, being 20 L m⁻² h⁻¹ bar⁻¹ at 30° C. When increasing the filtration temperature, slightly higher values were observed for those cast from NMP, reaching 48 L m⁻² h⁻¹ bar⁻¹ at 90° C. filtration. This suggests that by using this thermal treatment condition, the casting solvent is no longer one of the main parameters that may affect the performance of the membrane, and the heating conditions play a more critical role. The DMF permeances obtained for the membranes treated at 300° C. for 3 h are at least 20 times higher than the values reported for state-of-the-art integrally asymmetric membranes at high temperature. Besides, the solvents permeances and the rejections are comparable or even higher than those of the state-of-the-art thin-film composite membranes (FIG. 54 (Table 4.2)). The MO rejection of the membranes treated at 300° C. for 3 h was considerably improved, being higher than 90% when the filtration was at 30° C. and 65° C. (FIG. 39e,f). A slightly lower MO rejection was obtained at 90° C. However, by replacing the MO with AF as testing solute, the membranes could maintain rejections around 90% at 90° C. (FIG. 39e,f). Thus, polytriazole membranes thermally treated at 300° C. for 3 h have a MWCO of 585 g mol⁻¹ for the whole filtration temperature range, independently if cast from solutions in DMF or NMP.

To achieve an even higher selectivity for the whole temperature range, we treated the membranes at 325° C. for 1 h and 2 h (FIG. 39e,f). The DMF permeances for these membranes are lower than for the membrane treated at 300° C. but still almost 10 times higher than the previously reported integrally asymmetric membranes (FIG. 51). These membranes did not show any significant physical aging and compaction when we permeated pure DMF at 65° C. for 72 h, confirming the expectations after the creep-recovery measurements (FIGS. 39d and 37d).

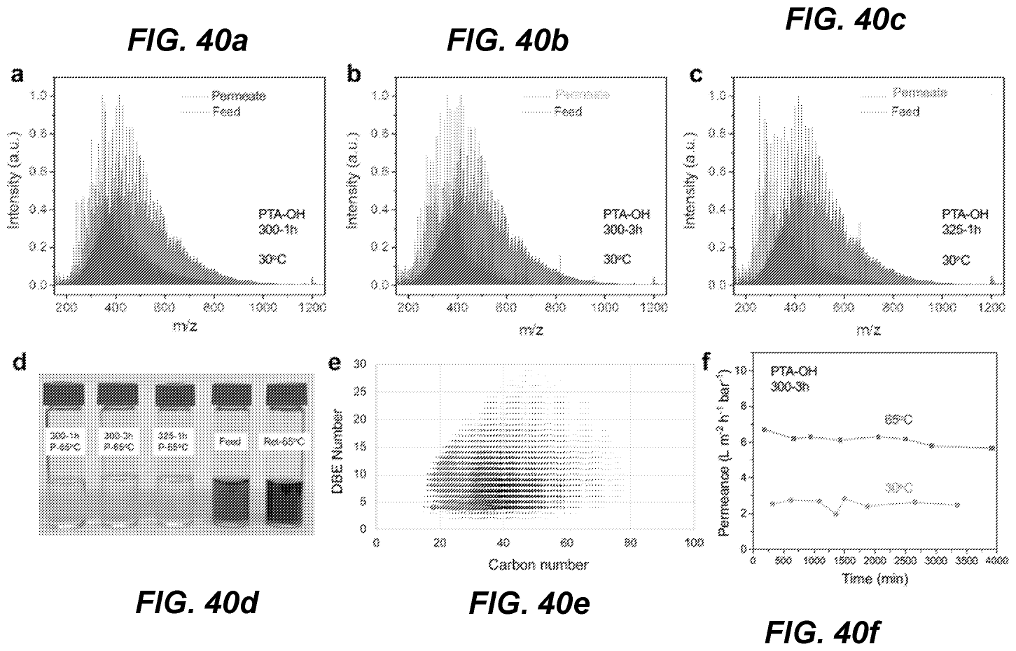

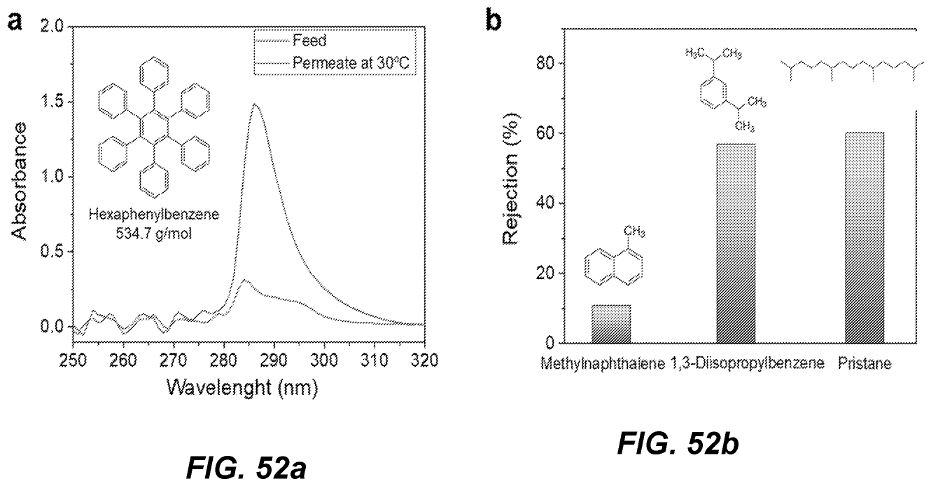

In view of the encouraging performance in solvents with different viscosities and polarities, the potential of these membranes was explored for hydrocarbons separation. Hexaphenylbenzene (Mw=534.7 g mol⁻¹) in toluene was used to investigate the performance of the membrane treated at 300° C. for 3 h. The rejection of this hydrocarbon (85%) is slightly lower than for AF (Mw=585 g mol⁻¹) in DMF, which can be correlated with the different interaction between the solvents and the membrane, and also with the absence of the Donnan effect (FIG. 52a). A mixture of the methylnaphthalene, 1,3-diisopropylbenzene, and pristane was then used as feed to evaluate the separation of the membrane treated at 325° C. for 1 h. Similar rejection (60%) was obtained for the linear saturated hydrocarbon (268 g mol⁻¹) and the 1,3-diisopropylbenzene (162 g mol⁻¹), while the methylnaphthalene (142.2 g mol⁻¹) was concentrated in the permeate side (FIG. 52b). The data achieved using the simple binary mixture and the multicomponent mixture of hydrocarbons show the potential of the polytriazole membranes to discriminate among different classes and sizes. We then evaluated the performance of the membranes to fractionate dilute crude oil, a feed closer to industrial feedstock. Membranes cast from PTA-OH solutions in NMP, which had a higher rejection of dyes than those membranes cast from solutions in DMF. Membranes treated at 300° C. for 1 and 3 h and at 325° C. for 1 h were tested using a 1:40 volume ratio of Arabian extra light crude oil (39>API>30 (American Petroleum Institute gravity)) in toluene. Electrospray Ionization Fourier Transform Ion Cyclotron Resonance Mass Spectrometry (ESI FT-ICR MS) was used as characterization method to evaluate the feed and permeate compositions. FIG. 40 shows the FT-ICR MS distribution of the different mass compounds in the feed and permeates obtained by filtrating at 30° C.

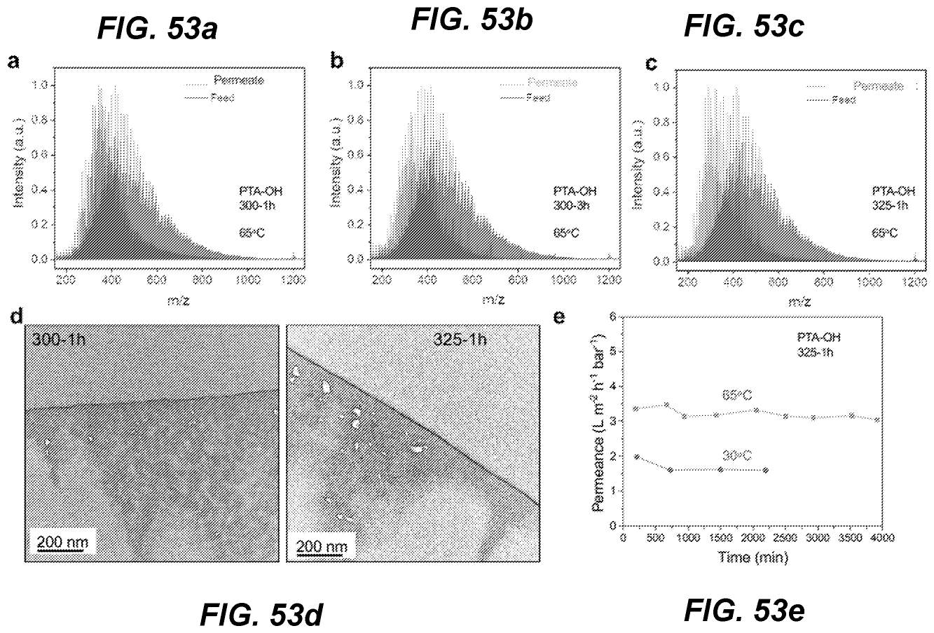

The FT-ICR MS spectra indicate that using the membrane treated at 300° C. for 1 h, a broad molecular weight distribution will be obtained in the permeate side, with molecules of size lower than 400 g mol⁻¹ (FIG. 40a). The membranes treated for 3 h have a narrower molecular weight distribution with enhancing the ratio of molecules with size below 350 g mol⁻¹ (FIG. 40b). By increasing the treatment temperature to 325° C., we observed an enrichment of molecules smaller than 300 g mol⁻¹ (FIG. 40c). FIG. 40e indicates that when using a membrane treated at 325° C. for 1 h, the permeate will have a higher ratio of components with a carbon number between 18 to 25, associated with kerosene fuel. Besides that, we have investigated the performance of the membrane at 65° C. using dilute crude oil. The separation using membranes treated at 300° C. for 3 h and at 325° C. for 1 h enriches the permeate with lighter components of size below 350 g mol⁻¹ and 300 g mol⁻¹, respectively, in experiments at 65° C., while by using a membrane treated at 300° C. for 1 h higher molecular weight components (closer to 400 g mol⁻¹) are preferentially permeated at this filtration temperature (FIG. 53). The permeates obtained with membranes treated at 300° C. for 3 h, and at 325° C. for 1 h were colorless, in opposite to those of membranes treated at 300° C. for 1 h. The retentate had an intense dark color, proving the tunable character of polytriazole membrane to selectively remove high molecular weight components from dilute crude oil (FIG. 4d). The tunability of these membranes is due to the selective layer structure resulted from the treatment in different conditions (FIG. 53d). Additionally, the permeances during crude oil separation are in the range of 1.9-2.5 L m⁻² h⁻¹ bar⁻¹ at 30° C., whereas at 65° C., the permeances increase almost 2 fold to 3.3 and 6 L m⁻² h⁻¹ bar⁻¹ (FIGS. 40f and 53e). The values are 10 to 300-fold higher than recently reported systems, which show enrichment in the permeate of molecules with a molecular weight around 170 g mol⁻¹. In addition, when the crude oil mixture was permeated for 72 h through the membrane, no significant decrease in permeance was observed (FIGS. 40f and 53e).

The potential of the polytriazole membranes treated at 300° C. for 1 h as an alternative for crude oil fractionation of pure Arabian superlight crude oil (50>API>39) without previous dilution was evaluated as a further challenge. The filtration experiments were carried out at 90° C. to keep the heavy components flowing and avoid pore blocking. GC-MS was used to evaluate the components in the permeates, and to identify them in terms of carbon number, a standardized C₇-C₄₀ saturated alkanes solution was utilized.

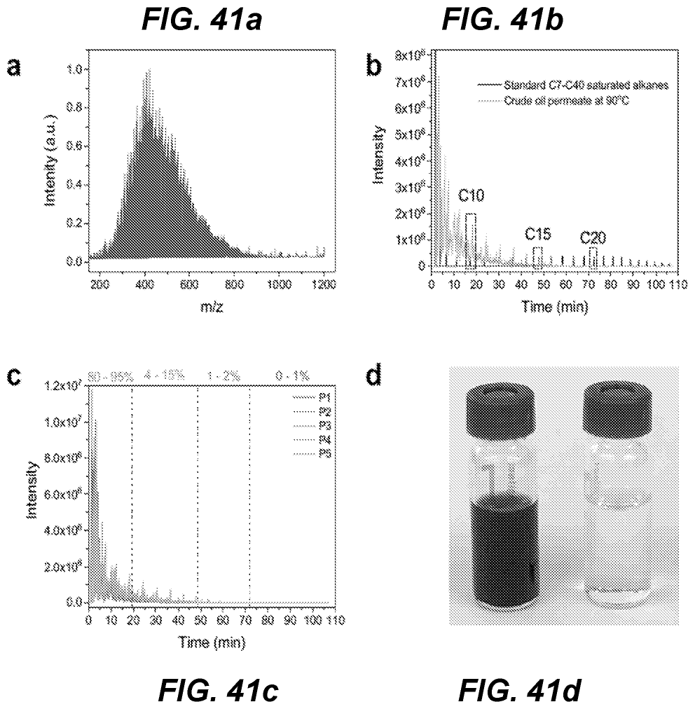

FIG. 41a shows the broad molecular weight distribution of the crude oil used as a feed. that this membrane can reject components with size even below C15, corresponding to molecular weight around 180 g mol⁻¹. FIG. 41b shows the GC/MS chromatograms of a simulated mixture of hydrocarbons with different number of carbons. The filtration of the crude oil using the membranes reported here provided fractionated permeant samples (FIG. 41c). Depending on the fraction collected during the separation experiment (FIG. 41c), we can enrich up to 80-95% of the hydrocarbons content with carbon numbers below C₁₀ in the permeate side, whereas the hydrocarbons between C₁₀-C₁₅ are in the range of 4-15%. Besides that, the molecules with carbon numbers in the range of C₁₅-C₂₀ and higher than C₂₀ are only 2% and less than 1%, respectively. Moreover, the colorless permeant suggests that the polytriazole membranes can discriminate not only between the carbon number or size of the crude oil components but also can selectively separate paraffin/olefins with carbon numbers lower than C₁₅. The good separation performance of membranes cast from PTA-OH solutions in NMP treated at 300° C. for 1 h can be correlated with the cluster formation between different components in the crude oil, which facilitates only the permeation of small molecules and molecules that are not generating aggregates, like linear hydrocarbons. The results obtained for hydrocarbons separation show that moving from binary mixture to dilute complex mixture, which has thousands of different components, the molecular weight cutoff of the polytriazole membranes is in the same range, demonstrating the robustness of these membranes.

### Conclusion

In summary, the results reported here show that by rationally selecting the polymer structure and combining the classical NIPS method with thermally crosslinking, it is possible to obtain promising membranes for a highly challenging chemical separation: the fractionation of crude oil. The versatility of the polytriazole in terms of processability and crosslinking allows obtaining polymeric membranes with a tailored selective layer using a method that is easy to scale up. The tunable selectivity and permeances of the ultrathin polytriazole layer make these membranes suitable to be integrated into a cascade system for a specific range of hydrocarbons separation. High thermal stability permits testing a wide feed mixture in different conditions, suggesting that the polytriazole membranes can be integrated into hybrid membrane configurations for energy-efficient crude oil fractionation. In addition, the stability of the crosslinked polytriazole membranes in a wide range of solvents, concentrated acids, and bases could pave the way for new chemical separations using membranes.

### Aspects of the Disclosure

In a first aspect, the present disclosure includes a thermally-crosslinked membrane comprising a poly(1,2,4-triazole)-polymer that includes recurring hydroxyl-functionalized triazole units, of formula I:

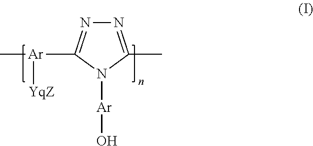

wherein Ar describes an aromatic or heteroaromatic group, particularly with substituents and/or a multi ring system, optionally with —O—, —CO—, —C(CH₃)—, —C(CF₃)—, and/or —SO₂— as compounds between the aromatic rings;
X describes a group of the formula OR², wherein R² is a hydrogen atom or a group with 1 to up to 20 carbon atoms;
Y describes a bond or a group with 1 to up to 20 carbon atoms,
Z describes a group of the common formula —SO₃R¹ or —PO(OR¹)₂, wherein R¹ is a hydrogen atom or an alkali metal, and
q is a whole number between 0 and 4, optionally 1.
wherein n is a natural number 10, preferably 100.

In a second aspect, the thermally-crosslinked membrane of the first aspect includes a homopolymer or copolymer that includes recurring hydroxyl-functionalized triazole units of Formula II:

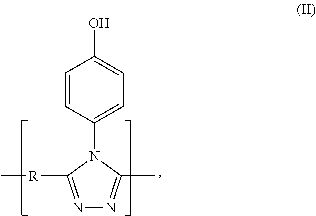

wherein R is

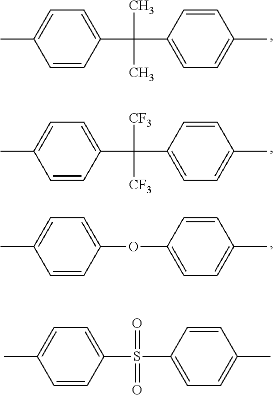

or a mixture thereof.

In a third aspect, the thermally-crosslinked membrane of the second or third aspect includes a polymer in the form of a homopolymer, copolymer, block copolymer (diblock or triblock), statistical copolymer, periodic copolymer, and/or alternating copolymer.

In a fourth aspect, the thermally-crosslinked membrane of the first-third aspects is a dense film, porous membrane, asymmetric membrane, or integrally-skinned asymmetric membrane.

In a fifth aspect, the dense film of the fourth aspect has a thickness the range of 50 to 200 μm.

In a sixth aspect, the asymmetric membrane of the fourth aspect has an integral selective layer, optionally a nanometer thick selective layer, such as a 10 nm selective layer, and/or a selective layer with subnanometer channels.

In a seventh aspect, the selective layer of the sixth aspect is a defect-free dense layer or a dense layer characterized by small defects.

In an eighth aspect, the thermally cross-linked membrane of the first-seventh aspects includes 2D carbon-like material and/or is substantially amorphous.

In a ninth aspect, the thermally cross-linked membrane exhibits low plasticization and/or deformability in harsh conditions, such as high temperature or organic solvents.

In a tenth aspect, the present disclosure includes a method of preparing a thermally cross-linked membrane of the first-ninth aspects, comprising thermally-treating a PTA-OH membrane to a temperature sufficient to form at least one cross-link between the hydroxyl-functionalized aromatic moieties on the same polymer chain or a different polymer.

In an eleventh aspect, the method of the tenth aspect can include preparing the membrane, optionally casting, evaporation, phase inversion, spin coating, dip coating a polymer solution containing dissolved chains of PTA-OH.

In a twelfth aspect, the method of the eleventh aspect includes dissolving the PTA-OH in a suitable solvent at a suitable temperature, and optionally agitating the mixture, optionally the polymer solution includes a solvent selected from the group consisting of dimethyl sulfoxide (DMSO), N-Methyl-2-pyrrolidone (NMP), dimethylformamide (DMF), dimethylacetamide (DMA or DMAc), acetonitrile (MeCN) and mixtures thereof.

In a thirteenth aspect, the method of the eleventh aspect includes non-solvent induced phase separation (NIPS).

In a fourteenth aspect, the method of the tenth-thirteenth aspects includes adjusting the temperature, O₂ concentration, and exposure time based on the intended separation application, optionally the temperature ranges from about 200-550° C., or about 350 to 500° C., or from about 375° C. to 475° C., or about 475° C., or about 200° C. to 350° C., or about 300 to about 325° C.; and/or the O₂ concentration is within ranges of from about 0-100 vol %, about 0 to about 500 ppm, about 20 to about 200 ppm, or about 50-100 ppm; and/or the duration of thermal treatment is within the range of about 1 to 24 hours, about 30 mins to about 3 hours, or about 1 or 2 hours, or about 2 to 12 hours.

In a fifthteenth aspect, the present disclosure describes methods of using the thermally crosslinked membranes of any of the first-ninth aspects, or a membrane made according to any of the tenth-fourteenth aspects comprising contacting the thermally cross-membrane with a fluid feed stream.

In a sixteenth aspect, the method of the fifthteenth aspect includes recovery and recycling of homogenous catalysts from organic solvents; oil refining; solvent and oil exchange, recovery, and purification; solute (including pharma API) purification and enrichment; impurity removal; membrane-assisted crystallization and evaporation; carbon dioxide separation from natural gas, natural gas separation, liquid hydrocarbon separation olefin/paraffin separation such as propylene/propane, carbon dioxide separation from flue gas; organic solvent nanofiltration, ultrafiltration and microfiltration under harsh conditions, water and wastewater treatment; air separation for nitrogen enrichment, hydrogen recovery (H₂/N₂, H₂/CH₄ and H₂/CO₂), and acid gas (CO₂/H₂S) removal and hydrocarbon recovery from natural gas streams.

In a seventeenth aspect, the method of the fifteenth or sixteenth aspect includes a fluid feed stream comprising a liquid with first solute and a first solvent and method is performed to separate at least one chemical species from the fluid composition.

In an eighteenth aspect, the method of the fifthteenth-seventeenth aspects includes fluid feed stream that is an aqueous liquid, an organic liquid, or a combination thereof, optionally a complex mixture of hydrocarbons, C₇-C₄₀ saturated alkanes, sugars, salts, amino acids, flavors, genotoxins, colorants, dyes, pigments, catalysts, peptides, antibiotics, proteins, enzymes, and active pharmaceutical ingredients.

In a nineteenth aspect, the method of any of the fifteenth-eighteenth aspects includes concentrating the first solute, recovering the first solvent or a combination thereof, optionally the fluid feed stream includes at least two solvents and the method includes solvent exchange and/or the fluid feed stream includes at least two solutes, and the method further includes purifying the first solute of the at least two solutes; and/or the fluid feed stream includes a first solvent selected from the group consisting of alcohols, methanol, ethanol, isopropanol, butanol, acetone, alkanes, pentane, n-hexane, n-heptane, cyclohexane, alkyl acetates, butyl acetate, ethyl acetate, ethers, methyl ethyl ketone, diethyl ether dichloroethane, chloroform, trichloroethane, methyl isobutyl ketone, formaldehyde, ethylene glycol, propylene oxide, methylene chloride, nitrobenzene, tetrahydrofuran, toluene, diethyl ether, acetonitrile, carbon tetrachloride, xylene, dioxane, dimethyl sulfoxide, dimethylformamide, N-methyl pyrrolidone, and dimethylacetamide.

In a twentieth aspect, the method of any of the fifthteenth-nineteenth aspects includes the fluid in a gas phase, optionally including true gases, a gas mixture, such as a mixture of hydrogen, helium, oxygen, nitrogen, carbon monoxide, carbon dioxide, hydrogen sulfide, ammonia, water vapor, a nitrogen oxide, a sulfur oxide, a C₁-C₈ hydrocarbon, natural gas, an organic vapor, a fluorocarbon, or a refrigerant gas, air, flue gas, digester gas, fermentation gas, sewage gas, natural gas, coal gas, synthesis gas, or combinations thereof; and optionally the method includes separating at least one chemical species from the gas phase fluid composition.

What is claimed is:

1. A thermally-crosslinked membrane comprising a poly(1,2,4-triazole)-polymer that includes recurring hydroxyl-functionalized triazole units, of formula I: 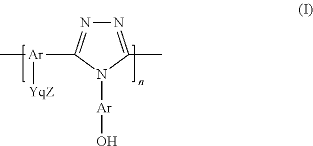
wherein Ar describes an aromatic or heteroaromatic group, particularly with substituents and/or a multi ring system, optionally with —O—, —CO—, —C(CH₃)—, —C(CF₃)—, and/or —SO₂— as compounds between the aromatic rings;
X describes a group of the formula OR², wherein R² is a hydrogen atom or a group with 1 to up to 20 carbon atoms;
Y describes a bond or a group with 1 to up to 20 carbon atoms,
Z describes a group of the common formula —SO₃R¹ or —PO(OR¹)₂, wherein R¹ is a hydrogen atom or an alkali metal, and
q is a whole number between 0 and 4,
wherein n is a natural number ≥10;
wherein at least one crosslink is present between two of the hydroxyl-functionalized Ar moieties of the polymer.

2. The membrane of claim 1, including a recurring hydroxyl-functionalized triazole units of Formula II: 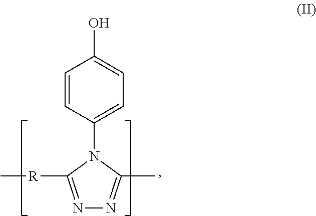
wherein R is 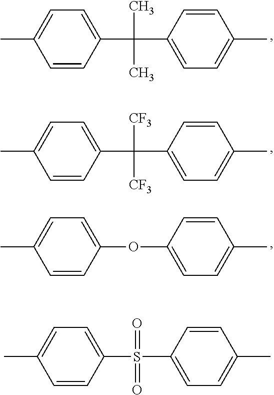
a mixture thereof.

3. The membrane of claim 1, wherein the membrane is a dense film, porous membrane, asymmetric membrane, or integrally-skinned asymmetric membrane.

4. The membrane of claim 1, wherein the membrane is an asymmetric membrane having an integral selective layer, a nanometer thick selective layer, or a 10 nm thick selective layer.

5. The membrane of claim 1, wherein the thermally cross-linked membrane exhibits low plasticization and/or deformability in harsh conditions.

6. A method of preparing a thermally cross-linked membrane according to claim 1, the method comprising thermally-treating a membrane comprising the poly(1,2,4-triazole)-polymer of formula I to a temperature sufficient to form at least one cross-link between the two hydroxyl-functionalized aromatic moieties of the polymer.

7. The method of claim 6, wherein thermally-treating includes exposing the membrane to a temperature within the range of about 200-550° C., about 350 to 500° C., about 375° C. to 475° C., about 475° C., about 200° C. to 350° C., or about 300 to about 325° C.

8. The method of claim 6, wherein the O₂ concentration is within a range of from about 0-100 vol %, about 0 to about 500 ppm, about 20 to about 200 ppm, or about 50-100 ppm.

9. The method of claim 6, wherein the thermally-treating includes exposing the membrane to the temperature for about 1 to 24 hours, about 30 mins to about 3 hours, or about 1 or 2 hours, or about 2 to 12 hours.

10. The method of claim 6, further comprising preparing the membrane.

11. The method of claim 10, wherein preparing includes casting, evaporation, phase inversion, spin coating, or dip coating a polymer solution containing dissolved chains of the poly(1,2,4-triazole)-polymer of formula I.

12. The method of claim 11, further comprising dissolving the poly(1,2,4-triazole)-polymer of formula I in a solvent selected from the group consisting of dimethyl sulfoxide (DMSO), N-Methyl-2-pyrrolidone (NMP), dimethylformamide (DMF), dimethylacetamide (DMA or DMAc), acetonitrile (MeCN) and mixtures thereof.

13. The method of claim 10, wherein preparing the membrane includes non-solvent induced phase separation (NIPS).

14. A method of separating chemical species in a mixture, comprising contacting a thermally-crosslinked membrane according to claim 1 with a fluid feed stream comprising at least two chemical species.

15. The method of claim 14, wherein separating includes recovery and recycling of homogenous catalysts from organic solvents; oil refining; solvent and oil exchange, recovery, and purification; solute purification and enrichment; impurity removal; membrane-assisted crystallization and evaporation; carbon dioxide separation from natural gas, natural gas separation, liquid hydrocarbon separation olefin/paraffin separation, carbon dioxide separation from flue gas; organic solvent nanofiltration, ultrafiltration and microfiltration under harsh conditions, water and wastewater treatment; air separation for nitrogen enrichment, hydrogen recovery (H₂/N₂, H₂/CH₄ and H₂/CO₂), or acid gas (CO₂/H₂S) removal and hydrocarbon recovery from natural gas streams.
